(19) United States
(12) Patent Application Publication
(10) Pub. No.: US 2007/0106627 A1
(43) Pub. Date: May 10, 2007

(54) Social discovery systems and methods

(76) Inventors: Mohit Srivastava, Seattle, WA (US); Sumit Sen, Seattle, WA (US); Derek R. Slager, Issaquah, WA (US); Christopher M. Hahn, Bellevue, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/543,759

(22) Filed: Oct. 4, 2006

Related U.S. Application Data
(60) Provisional application No. 60/723,982, filed on Oct. 5, 2005.
(60) Provisional application No. 60/734,370, filed on Nov. 7, 2005.
(60) Provisional application No. 60/775,973, filed on Nov. 29, 2005.
(60) Provisional application No. 60/776,010, filed on Nov. 29, 2005.

(51) Int. Cl. G06N 3/02

(52) U.S. Cl. 706/20

(57) ABSTRACT

Enhanced methods, systems, and techniques for social discovery are provided. Example embodiments provide a Social Discovery System (“SDS”), which enables users to contribute, share, manipulate, and otherwise engage in the creation and management of social knowledge and information. In one example embodiment, the SDS comprises a dot creation API, a dot system component, a dot user component, a permissions engine, a dot retrieval API, and a display engine. These components/modules cooperate to allow users, communities of users, and applications to create, manage, search, share and take collaborative action on social knowledge and the relationships that influence such knowledge and provide APIs to access SDS capabilities, a social search language, display capabilities, etc. This abstract is provided to comply with rules requiring an abstract, and it is submitted with the intention that it will not be used to interpret or limit the scope or meaning of the claims.

### TECHNICAL FIELD

The present disclosure relates to methods and systems for sharing information and, in particular, to methods and systems for generating, discovering, and/or sharing social information.

### BACKGROUND

Users of the Internet discover a wealth of useful and/or interesting information in the course of typical interactions (e.g., browsing, searching, etc.) with the Internet. At present, much of this information is lost, as most users do not have an adequate mechanism for retaining this information in a manner that is efficiently captured, efficiently organized, easy to use, private, and secure. In addition, even if this information can be retained, it cannot be easily shared with, provided to, and leveraged by a user's community of family, friends, and colleagues. At present, many users engage in various work-around solutions that all have at least some disadvantages related to efficiency, usability, security, expressiveness, etc.

For example, one technique involves the use of “bookmarks” or “favorites” that may be created with, and stored by, a web browser. While such techniques are relatively easy to use (e.g., by pressing a button on the browser, or selecting from a menu), they do not scale well. That is, large collections of bookmarks quickly become unwieldy, as applications typically do not provide search capabilities or associate meta-information (aside from perhaps a title) with a particular bookmark. Organizing bookmarks may be time consuming and cumbersome, as a special-purpose user interface may need to be utilized to organize the bookmarks into folders or other groups.

Another technique is to use an electronic document (e.g., a text file) to record locations, such as Uniform Resource Locators (“URLs”) discovered or visited during the course of a search or browsing session, along with some extra information pertinent to those locations (e.g., a description of the location). However, such a technique may be difficult to organize, inefficient to search, resistant to scale, and hard to share with friends and colleagues.

In addition, users with sufficient technical knowledge can make use of a browser history mechanism to track locations of interest. A knowledgeable user may open the browser history file and examine the raw and uninformed collection of information, which ultimately may contain a large number of sites of little to no value. Upon inspection of the contained information, the user then must choose which items from the list he or she wishes to remember, and record them using one of the previously listed techniques. This process may be time consuming and/or error prone.

Finally, networked applications have been developed that allow users to record and share information that they find appealing or otherwise interesting. Such applications typically suffer from additional drawbacks. First, they may not be well integrated with available Internet client applications. For example, they may exist as Web sites that are distinct from the actual web pages that may interest a given user. As such, they may not provide efficient, expressive, and/or intelligent authoring tools, that allow users to efficiently provide large amounts of detailed meta-information about web pages of interest. Such meta-information may be of considerable value to various users, because it may be utilized for purposes of organization, search, presentation, etc. Second, such applications typically do not provide mechanisms for sharing content in a fine-grained or selective manner. In particular, all information provided by a user may be accessible by all other users. Third, such applications typically cannot exploit or otherwise utilize information about relationships between various users in order to tailor information based upon those relationships.

### BRIEF DESCRIPTION OF THE DRAWINGS

FIG. 1 is an example display screen of a displayed representation of an item of social knowledge created by an example embodiment of a Social Discovery System.

FIG. 2 is an example screen display of the source data for the dot shown in FIG. 1.

FIG. 3 is an example screen display of a website for social discovery.

FIGS. 4A-4D show various example screen displays of example websites for social discovery.

FIG. 5 is an example flow diagram of an example process of inviting a user to join a Social Discovery System community.

FIG. 6 is an example screen diagram of an example email invitation.

FIG. 7 is an example flow diagram of an example overall process for inviting and receiving a new user into an example Social Discovery System.

FIG. 8 is an example screen display of a registration page and interface for creating a new user in an example Social Discovery System.

FIG. 9 is an example screen display of informative descriptions of how a user might use an example Social Discovery System.

FIG. 10 is an example screen display of an install interface for installing a dot creation Bookmarklet.

FIG. 11 is an example screen display of an alternative installation process for inserting dot creation links into other portions of a client application.

FIGS. 12-13 are example display screens of a page that describes an example dot creation process.

FIG. 14 is an example overview flow diagram describing the experience of a new user in an example Social Discovery System.

FIG. 15 is an example flow diagram of logic invoked when a user navigates to an example Social Discovery System homepage.

FIG. 16 is an example login display screen for authenticating a user of an example Social Discovery System.

FIG. 17 is an example screen display showing logic associated with an example installed Social Discovery System homepage link.

FIG. 18 is an example screen display of an interface presented to manage a user's account.

FIG. 19 is an example screen display of a web page for changing a user's profile information.

FIG. 20 is an example flow diagram for example pages displayed to manage buddies and groups in the Social Discovery System.

FIG. 21 is an example screen display of an interface for adding other users to a user's community.

FIG. 22 is an example screen display for managing a user's community once the user has defined a group.

FIG. 23 is an example screen display of an interface for modifying the members of a sub-community.

FIG. 24 is an example flow diagram of a process for discovering and adding new buddies.

FIG. 25 is an example screen display of a dot presentation filtered according to a particular buddy.

FIG. 26 is an example screen display of a dot presentation filtered according to a category.

FIG. 27 is an example screen display of a dot presentation filtered by a search string.

FIG. 28 is an example screen display of a dot presentation filtered by selecting a tag.

FIG. 29 is an example screen display of a tooltip presented in response to hovering over a music widget.

FIG. 30 is an example screen display of a permissions tip.

FIG. 31 is an example overview flow diagram of an example process of dot creation.

FIG. 32 is an example screen display of an authoring dialog where minimal information has been automatically filled by the system.

FIG. 33 is an example screen display showing a target web page to use as source content for dot creation.

FIG. 34 is an example screen display of an example dot authoring dialog.

FIG. 35 is an example screen display showing the result of authoring a dot.

FIG. 36A is an example screen display of an authoring dialog that may be utilized by an anonymous user.

FIG. 36B is an example screen display of an authoring confirmation message that may be provided to an anonymous user.

FIG. 36C is an example screen display of a dot presentation that may be provided to an anonymous user.

FIG. 37A is an example screen display showing a user in the process of editing the publisher comment regarding a dot.

FIG. 37B is an example screen display of an example pre-filled author dialog displayed when a user attempts to dot an already existing dot.

FIG. 38A is an example screen display of a dot presentation modified to cluster related dots.

FIG. 38B is an example screen display of dot clustering.

FIG. 38C is an example screen display of the cluster information collapsed.

FIG. 39A is an example screen display showing user interface controls that provide functionality for adding a comment to an existing dot.

FIG. 39B is an example screen display showing user interface controls for displaying comments that have been added to dots that have been authored by a current user.

FIG. 39C is another example screen display showing user interface controls for displaying comments.

FIG. 40A is an example screen display showing user interface controls for creating and sending new messages.

FIG. 40B is an example screen display showing user interface controls for obtaining information about received messages.

FIG. 40C is an example screen display showing user interface controls for obtaining detailed information about a received message.

FIG. 41A is an example screen display of syndicated dot information displayed in a user's blog.

FIG. 41B is an example screen display that provides a user with mechanisms for configuring a dot syndication widget, as well as instructions for installing or otherwise operating that widget within another application or system.

FIG. 41C is an example screen display of syndicated dot information displayed on a web page hosted by a website.

FIG. 41D is an example screen display that provides controls for configuring an mechanism for importing information into an example Social Discovery System.

FIG. 41E is an example screen display showing an example email sent by an example Social Discovery System to notify of a user of recent events and/or occurrences within the Social Discovery System.

FIG. 41F is an example screen display of an example application that utilizes such a Social Discovery System API.

FIG. 42 is an example block diagram of example components of an example Social Discovery System.

FIG. 43 is an example block diagram of a general purpose computer system for practicing embodiments of a Social Discovery System.

FIG. 44 is an example block diagram of an overview of functions of an a Social Discovery System.

FIG. 45 is an example flow diagram of an example Social Discovery System server routine provided by an example embodiment of a Social Discovery System.

FIG. 46 is an example flow diagram of an example user and group manager routine provided by an example embodiment of a Social Discovery System.

FIG. 47 is an example flow diagram of an example dot generator routine provided by an example embodiment of a Social Discovery System.

FIG. 48 is an example flow diagram of an example permission manager routine provided by an example embodiment of a Social Discovery System.

FIG. 49 is an example flow diagram of an example dot enhancer routine provided by an example embodiment of a Social Discovery System.

FIG. 50 is an example block diagram illustrating components and data flow within an example dot enhancer component provided by an example embodiment of a Social Discovery System.

FIG. 51A is an example flow diagram of an image selector routine provided by a dot enhancement engine configured to automatically select an appropriate image to associate with a dot for display purposes.

FIG. 51B is an example flow diagram of a rating determiner routine provided by a dot enhancement engine configured to automatically determine a dot rating.

FIG. 51C is an example flow diagram of a keyword selector routine provided by a dot enhancement engine configured to automatically select appropriate keywords for a given dot.

FIG. 52 is an example flow diagram of an example dot provider routine provided by an example embodiment of a Social Discovery System.

FIG. 53 is an example data structure utilized by an example embodiment of a Social Discovery System for representing one or more dots.

### DETAILED DESCRIPTION

Embodiments described herein provide enhanced computer- and network-based methods and systems for social discovery. Example embodiments provide a Social Discovery System (“SDS”), which enables users to contribute, share, manipulate, and otherwise engage in the creation and management of social knowledge and information. The Social Discovery System is a set of components and technologies that support communities of users engaging in social discovery. An example embodiment, referred to as the BlueDot Social Discovery System (or “BDSDS”) is described in the figures and text that follow.

Social knowledge is data that is contributed by a user (i.e., contributed knowledge) along with some type of encoding of a relationship of that contributed data to one or more communities of users. A community can be a single user or multiple users. The encoding of the relationship can be in it simplest form an association with a community designation that implies a certain set of attributes. For example, a relationship encoding with a particular person may directly or inherently designate relevance attributes, such as that the contributed knowledge is relevant to people who reside in the same location where the particular person lives. Or, the encoding of the relationship can be more complex. For example, the encoding may designate information regarding particular characteristics of the different relationships between the various member users within the community. Each community member's relationships with other members may even be distinct. For example, some statistical measure of the relevance of the contributed data may be the same for every member of the community while other relevance measures may yield individual results.

Contributed data may include data from a variety of sources including, for example, underlying data from an external source such as a website, and additional information that a publishing user contributes to the underlying data. Examples of such additional information include, comments, descriptors, rankings, tags (e.g., keywords), images, classifications, etc. The publishing user (publisher) may manually provide the additional information or the system, such as the BDSDS, may automatically provide the additional information possibly based upon intelligence gathered over time regarding the publishing user. Such intelligence may reflect, for example, the publisher's relationships to other users within the publisher's communities and/or information or relationships between the publisher and other social knowledge.

Social knowledge as created, encoded, and managed by the SDS may be enhanced by other community members over time and by the system itself as patterns and statistical measures of various social knowledge are incorporated by the system.

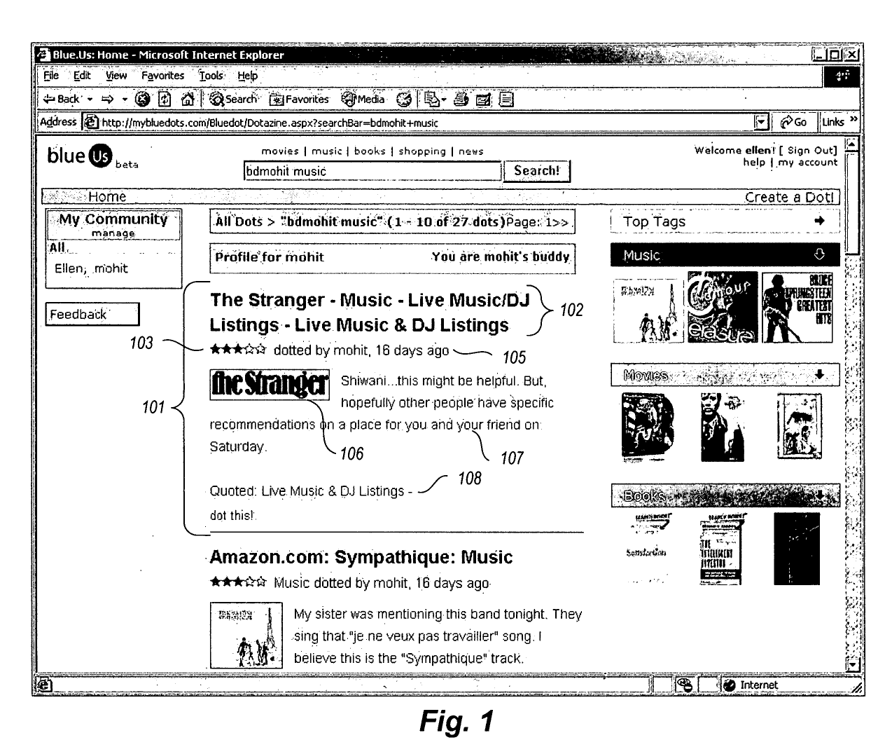

FIG. 1 is an example display screen of a displayed representation of an item of social knowledge created by an example embodiment of a Social Discovery System. An item of social knowledge is also referred to as a “dot”. In FIG. 1, the displayed dot 101 has an associated subject 102, a ranking 103, information about the author (publisher) of the dot 105, a representative image 106, a comment made by the author 107, and a description 108 supplied by the SDS. Other fields and information could be presented, and in different orders, etc.

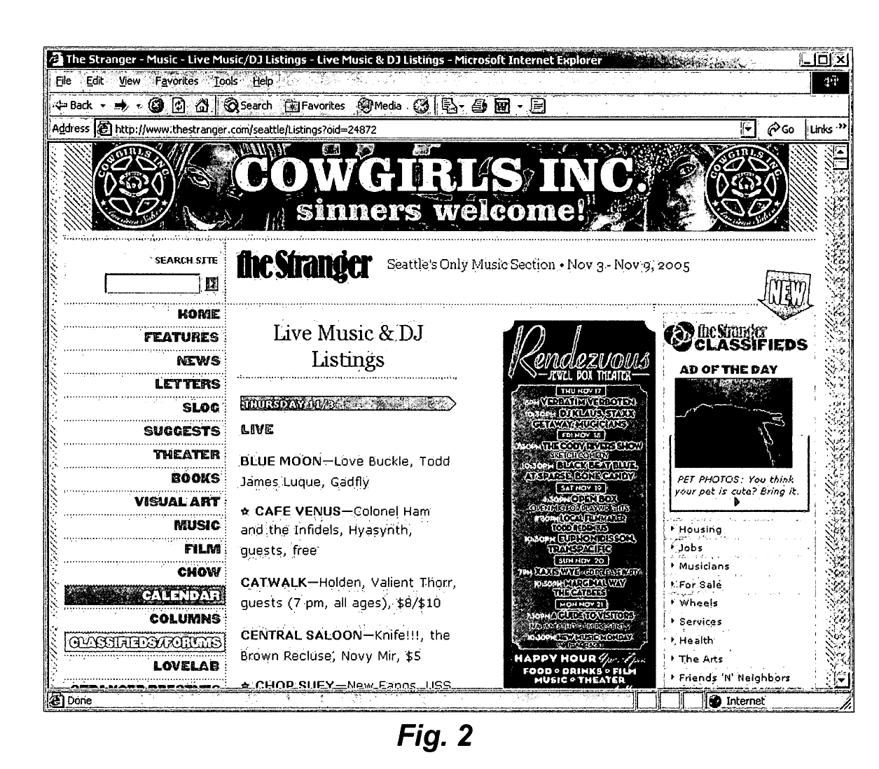

Each dot has an associated reference to its source data (underlying data), for example, a URL (“Uniform Resource Locator”) that points to a web page. FIG. 2 is an example screen display of the source data for the dot shown in FIG. 1. Source data can come from a variety of sources including, for example, Web pages, files located on a user's computer, files on a local area network or other network of computers (e.g., the Internet), or other digital and/or analog information and/or media (e.g., newspaper articles, magazine stories, books, films, maps, etc.).

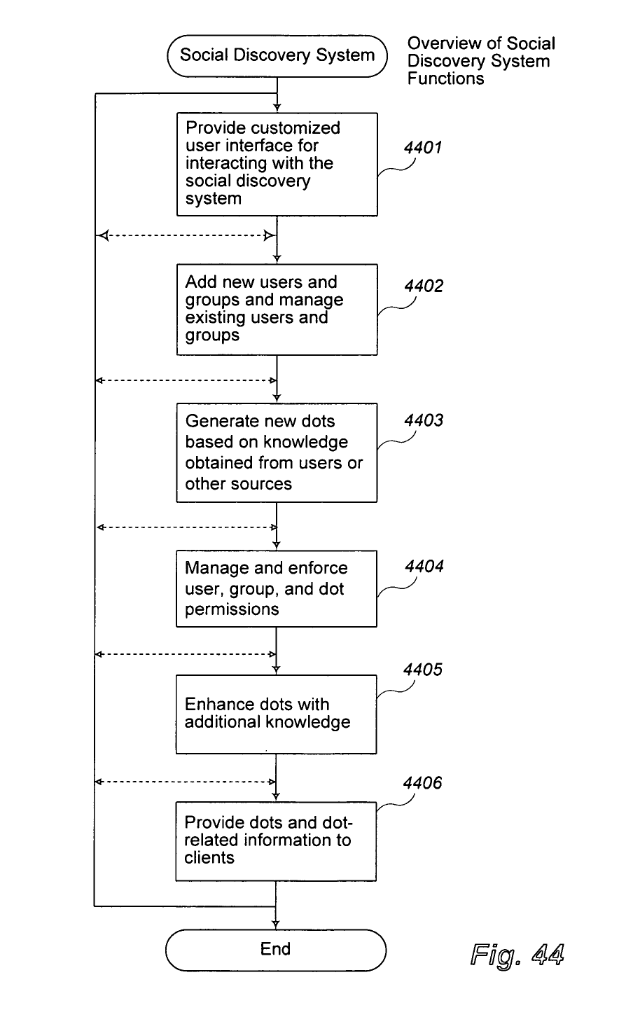

FIG. 44 is an example block diagram of an overview of example functions of a Social Discovery System. Although these functions are described in FIG. 44 as separate steps, one will recognize that the functions may be performed in any order and from one function the flow might progress to any other function dependent typically upon the desires of a user operating the system. In step 4401, the SDS provides a customized interface for interacting with the SDS. The interface may be customized based on various factors, such as identity of a user (e.g., different interfaces for anonymous users and authenticated users), preferences that are explicitly specified by the user and/or automatically determined by the SDS (e.g., based on display capabilities of a client device used by the user), information related to a dot or dots being created, updated, searched, or viewed by the user (e.g., customized user interface widgets for particular types of content), information related to the user's community, etc. In step 4402, the SDS adds new users and/or groups, and manages existing users and/or groups. By providing user and group management capabilities to users, users can specify community relationships that may be leveraged by the SDS to improve the user experience and/or provide additional functionality, such as permission management. In step 4403, the SDS generates new dots based on knowledge provided by users and/or other sources (e.g., data feeds, blogs, syndicated content, etc.). In step 4404, the SDS manages and enforces user, group, and dot permissions. In step 4405, the SDS enhances dots with additional knowledge. By enhancing dots, the SDS automatically improves or augments the meta-information content of dots, such as keywords, ratings, images, summaries, subjects, categories, etc. The additional information determined by dot enhancement can further be utilized to improve or otherwise enhance other functionality of the SDS, such as providing customized user interfaces as in step 4401 based on, for example, an automatically determined category of a dot. Using such enhancement techniques and heuristics, the SDS can appear to a user as an “intelligent” social network system. In step 4406, the SDS provides dots and dot-related information to clients, such as web browsers, search engines, blogs, etc. Note that, after each of these steps, the SDS may return to any of the other prior steps to perform any of the functions described with reference to steps 4401-4406.

In one example embodiment, the SDS comprises one or more functional components/modules that work together to allow users and communities of users to create, manage, search, share and take collaborative action on social knowledge and the relationships that influence such knowledge. For example, an SDS may comprise multiple components working together to allow the creation and management of dots, and the creation and management of relationships between users (e.g., users identified as buddies or friends, and communities or groups of users), such as an interface such as an applications programming interface (an “API”) for dot creation, an interface for relationship creation and management, a dot retrieval interface that, for example, supports a social search language, a display engine, etc. These components can be implemented in a variety of forms and many different user interfaces for interacting with social knowledge can be realized.

FIGS. 1-41F describe example embodiments of user interfaces for a Social Discovery System. These interfaces corresponds to the BDSDS, which provides a general purpose environment for community-based social discovery. Note that community-based social discovery includes explicit communities that may be defined by users, such as “All My Buddies” lists that comprise a user's community, and includes implicit communities (or groups) that may be defined by some characteristic designation (such as all users that are over age 30) or that may be dynamically created such as by the system itself while performing statistical correlations. Note as well that a single user comprises a legitimate community of one.

The environment comprises a client side and a server side as described, but could be implemented using different architectures and technologies other than those described here. In summary, an SDS such as the BDSDS supports a website for social discovery (e.g., www.blue.us), and/or a server system which can, for example, be accessed via a website, LAN, telecommunications device, broadcast media such as televisions, set-top boxes, local computing systems, PDAs, etc. Once a user has become a member of the BDSDS community, the user is presented with social knowledge (dots) as they relate to that user and the various buddy groups with which the user is associated. The user can create, edit and manage dots, define and manage relationships with other sub-communities (buddy groups), search for particular information using the SDS, can explore relevant social knowledge, or can collaborate or engage in conversations and dialogue regarding the same. Users can also submit questions to particular communities, “experts” on a particular topic, or to any target user, and can hold dialogue and conversations on various topics of interest. In addition, the SDS can provide users with a social discovery portal that allows them to quickly view recent information, interests, events, news, shopping items, etc. that are of particular interest to the users' immediate communities, as well as other communities (e.g., geographic regions, at-large, etc.).

Because the SDS maintains a considerable amount of information regarding the relationships between members of a community and contributed knowledge, the SDS also can intelligently provide assistance to its users based upon tracked information, statistical correlations, machine learning techniques, etc. For example, the SDS can note which topics and keywords (e.g., tags) are of recent interest to a specific user, which are of interest to the user's community, which buddies' dots the user explores most often, etc., and can utilize pattern and statistical analyses to better filter, present, and prioritize the social knowledge available to the user. Generally, the SDS maintains a measure of the social relevance of each item of social knowledge relative to each user on the system and so can use this information to create an adaptive knowledge base.

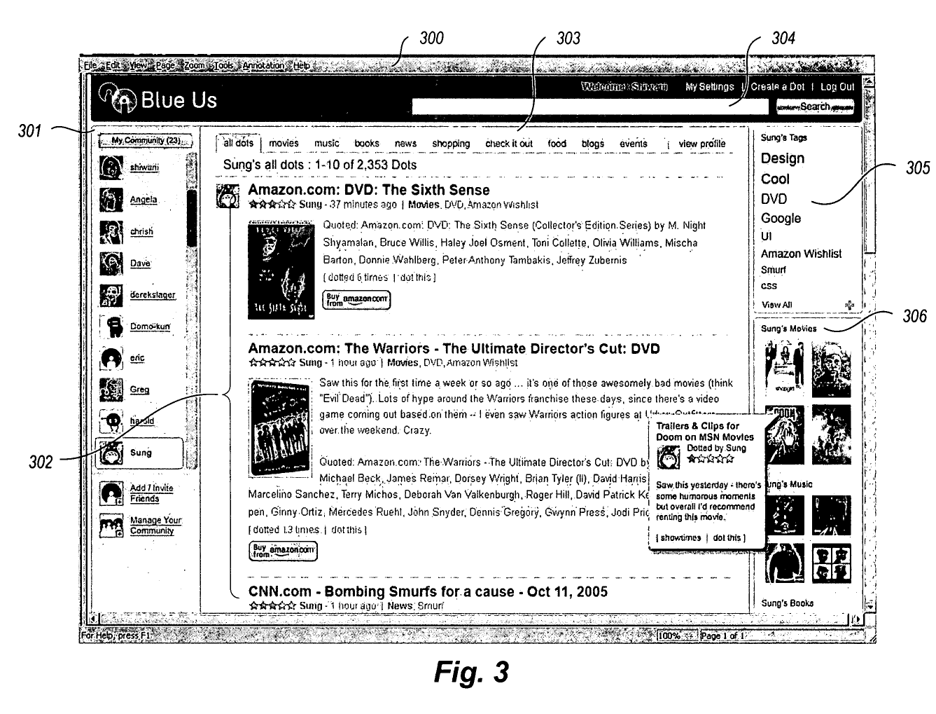

FIG. 3 is an example screen display of a website for social discovery, shown here as “Blue.us.” Many other presentations, layouts, widgets, user interface components, are of course possible using the techniques and aspects described. In the displayed environment, web page 300 shows a representation of the user's community 301, dot presentations 302 of a portion of the dots that match the current search or filtering criteria, categories of social knowledge 303 (that can provide filtered dot presentations based upon the categories), a search interface 304, a tag presentation area 305, and a presentation of bookshelf widgets 306. In one embodiment, the tag presentation area 305 relates to the dot representations currently displayed in area 302 and, in other embodiments, is settable. These tags may be presented based upon an ordering (such as most recent, or most used) and ranked, subsets may be displayed, etc. Typically these tags are those that relate to the community subset whose dots are being viewed. That is, instead of seeing all the tags that anyone has created anywhere in the SDS environment, only the ones relevant to the current user are displayed. The bookshelf widgets 306 are shown as comprising a movies widget, a music widget, and a books widget, although other categories of data could be similarly treated and displayed. In one embodiment, these widgets display dots that meet a certain qualifying criteria such as the three most recent dots that relate to whatever community the user has chosen to view.

The user may expand the dots viewed to include other groups such as friends of friends' dots and dots based upon users with common interests that aren't part of the user's direct community (subject to the permissions system). This relevance may be defined based upon an association with other members in the user's community. Similarly, the dot presentation can be “filtered” based upon some dimension of the social information (such as tags, keywords, subjects, images, etc.) or based upon some aspect or correlation of the user's relationship to the data—through the user directly or by virtue of the fact that the user belongs to communities of other users (e.g. groups of buddies).

Note that the display of all of the dot information, widgets, etc. is subject to permissions (access rights) that are associated with social knowledge and maintained by an extensive permissions system tied to groups of users. As described elsewhere, a dot publisher can designate what groups a dot can be viewed by and these permissions are automatically enforced by the SDS. In addition, at a future time (e.g., subsequent to dot creation), users can be added to groups and automatically inherit access to dots associated with appropriate permissions.

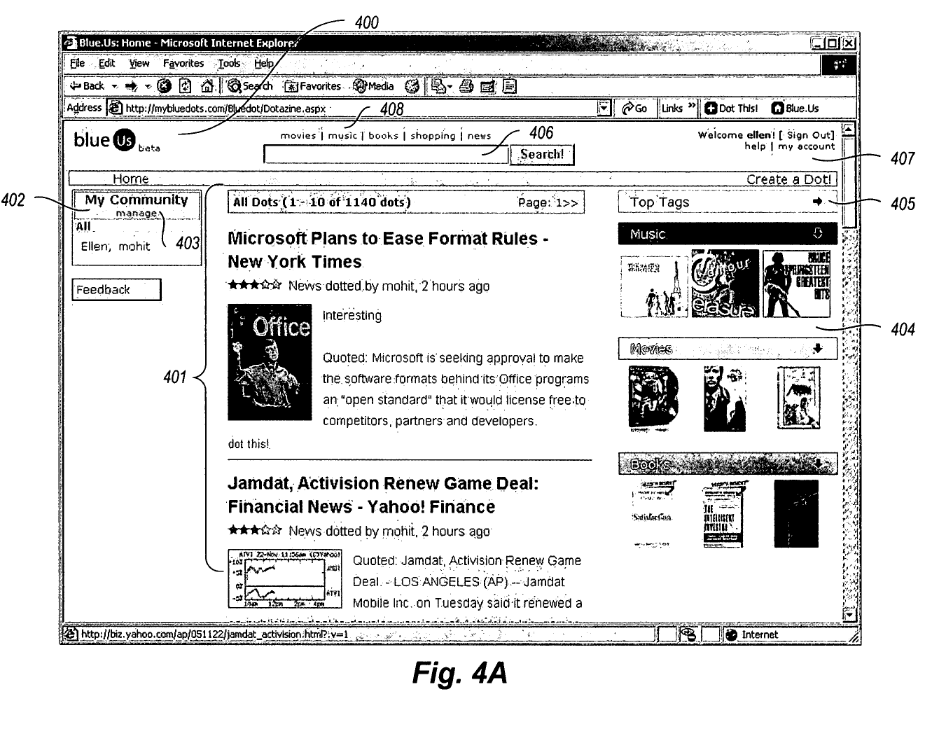

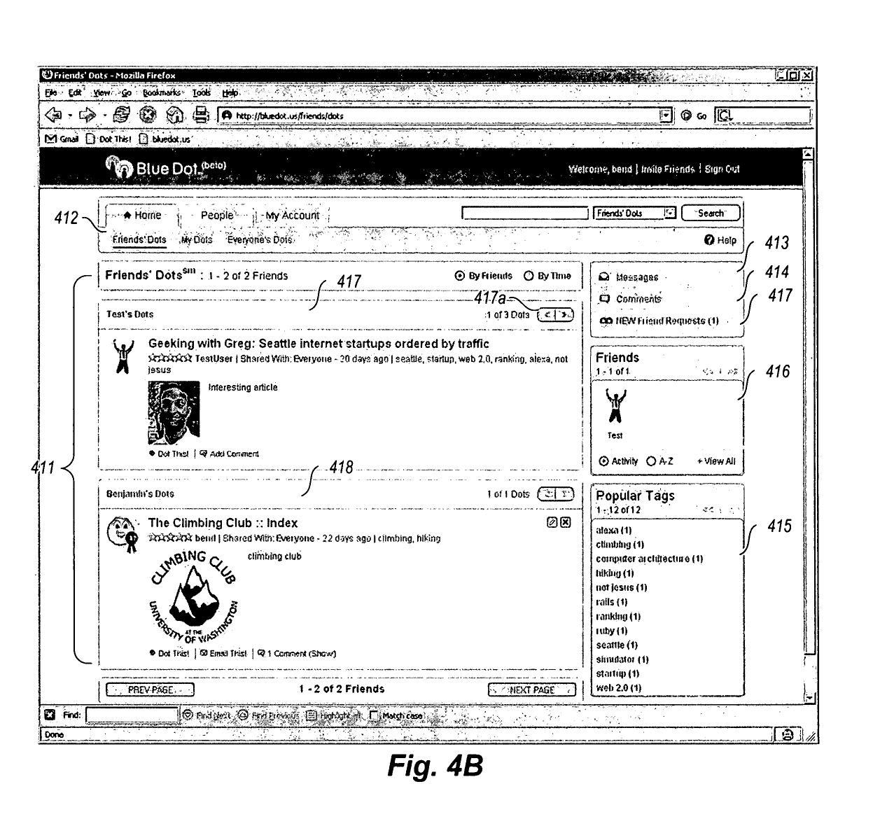

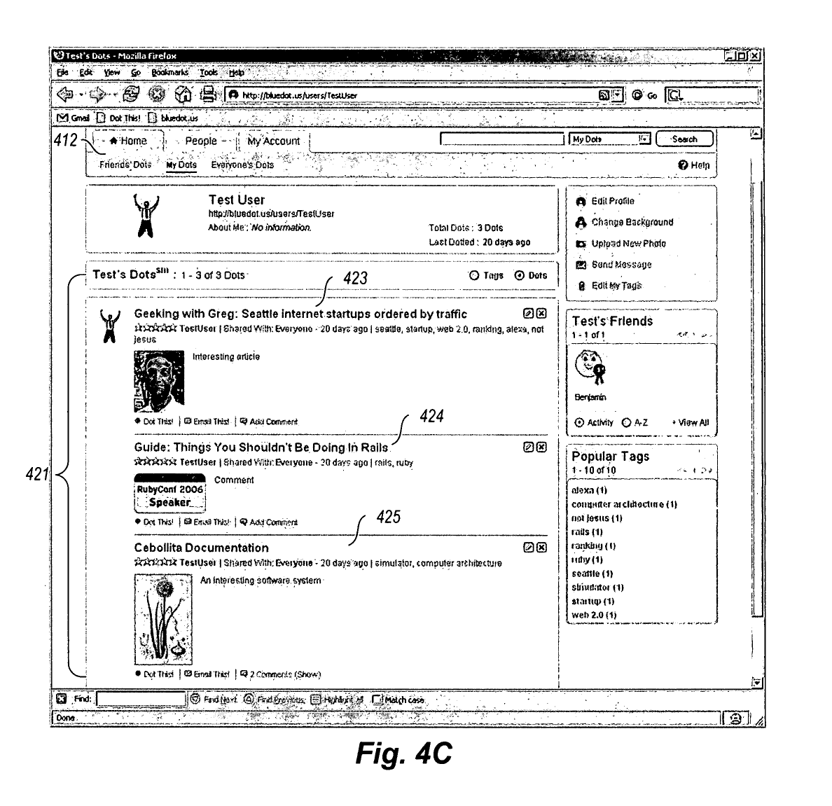

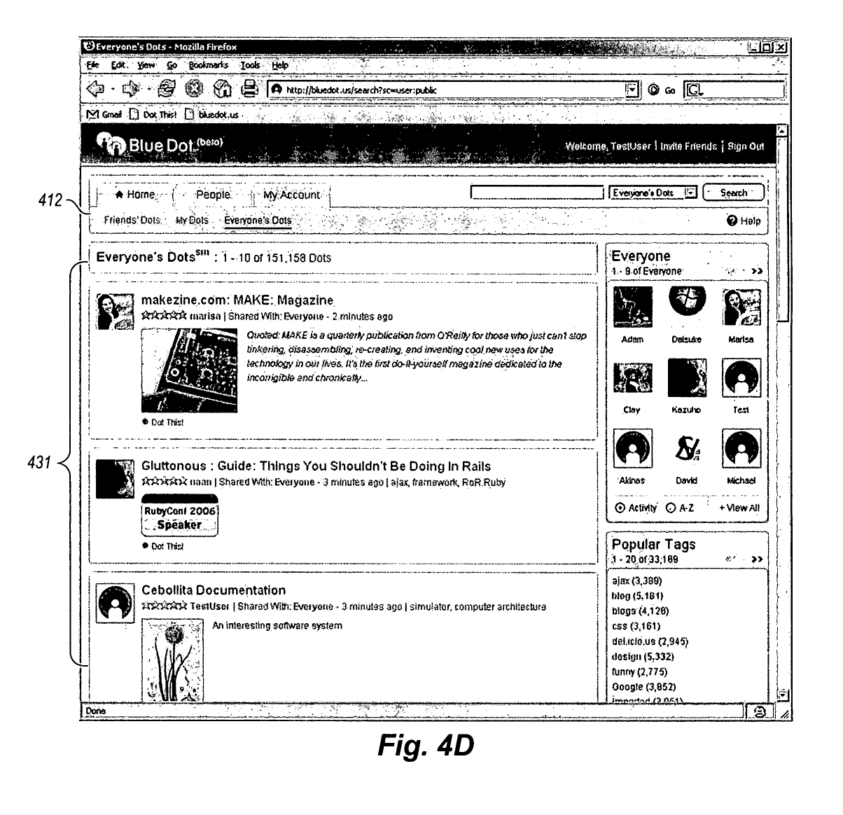

FIGS. 4A-4D show various example screen displays of example websites for social discovery.

FIG. 4A is another example screen display of a website for social discovery. Similar capabilities are provided for creating, editing and managing dots, managing groups and memberships, searching for information, and exploring the system. In the website 400, the dot presentation area 401 currently shows a portion all of the dots that match the selected community (here “All”). Community information is indicated in area 402 and can be edited by pressing the “Manage” button 403. Alternatively, the user's community and relationships can be created and managed by selecting the My Account button 407. Note that although certain terms such as buttons, links, etc. are referred to, any substitutable user interface element or component may be similarly incorporated. Tags Area 405 shows the most relevant tags (e.g., the most frequently used or recently used tags, etc.) that correspond to the dots presented in the dot presentation area 401. (The tag area 405 is currently shown collapsed.) The widgets area 404 has been expanded to show the most recently dotted information that corresponds to a Music category, a Movies category, and a Books category.

Similar to FIG. 3, the search area 406 provides an easy interface for the user to enter special terms (such as a category or a user or a group name) or keywords to be used to retrieve a portion of all of the possible dots available to the user through the user's community. Categories links 408 provide shortcuts to retrieving dots in the user's community that related to a particular category. Note that the SDS provides a comprehensive dot retrieval API and search language for retrieving subsets of dots. Reserved terms typically begin with the prefix “BD” or “bd” (e.g., “BD<term>” or “bd<term>”) and otherterms by default are considered keywords. Different algorithms can be employed for determining what fields of dots are considered when matching such keywords and potentially how they might be used to correlate to particular users in a designated community as well.

In one example SDS, each dot presentation comprises a set of information, a portion or all of which may be displayed depending upon the view. Some of the information may be provided upon authoring the dot. Other information may be provided by the system on creation, or perhaps intelligently added over time. For example, a dot presentation typically includes a title, a rating, the date the dot was published, a publisher's comment regarding the dot, a 25-word snippet from the underlying source data, name or image of the publisher, a representative image of the dot, hover over title and permissions (described below), a visualization of permissions with two actions for edit or delete for dots authored by the current user, and a “Dot This!” link to allow other users to add a comment and publish this dot as their own. Dot This! is described further below with respect to new user installation and authoring.

FIG. 4B is another example screen display of a website for social discovery. The illustrated screen display provides functionality for displaying dots matching predetermined criteria. In particular, the screen display includes a dot display filter control 412 that provides various controls that may be selected by a user in order to display only dots that have been authored by friends of the current user, only dots that have been authored by the current user, or all dots. In the illustrated example, the current user has selected to view dots that have been authored by friends of the current user, and in response, a dot presentation area 411 has been displayed. By utilizing the illustrated screen display in this manner, the current user can conveniently obtain information related to dots authored by his friends, so as to stay up to date with their latest interests. The dot presentation area 411 includes two dot presentations 417 and 418. Each dot presentation 417 and 418 displays all dots authored by a single friend of the current user. For example, dot presentation 417 displays dots authored by a user named “Test,” and dot presentation 418 displays dots authored by a user named “Benjamin.” Dot presentation area 417 also includes a dot browsing control 417a that may be utilized by the current user in order to view the other dots authored by the user associated with dot presentation area 417 (i.e., the user named “Test”). By using this control, the current user may efficiently browse or otherwise view dots authored by a particular user.

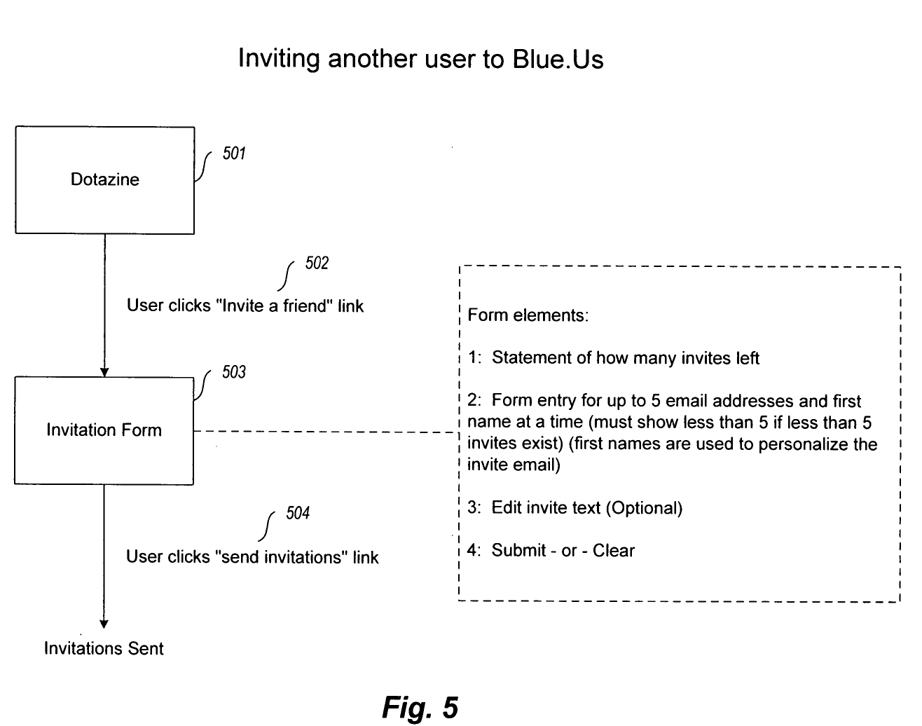

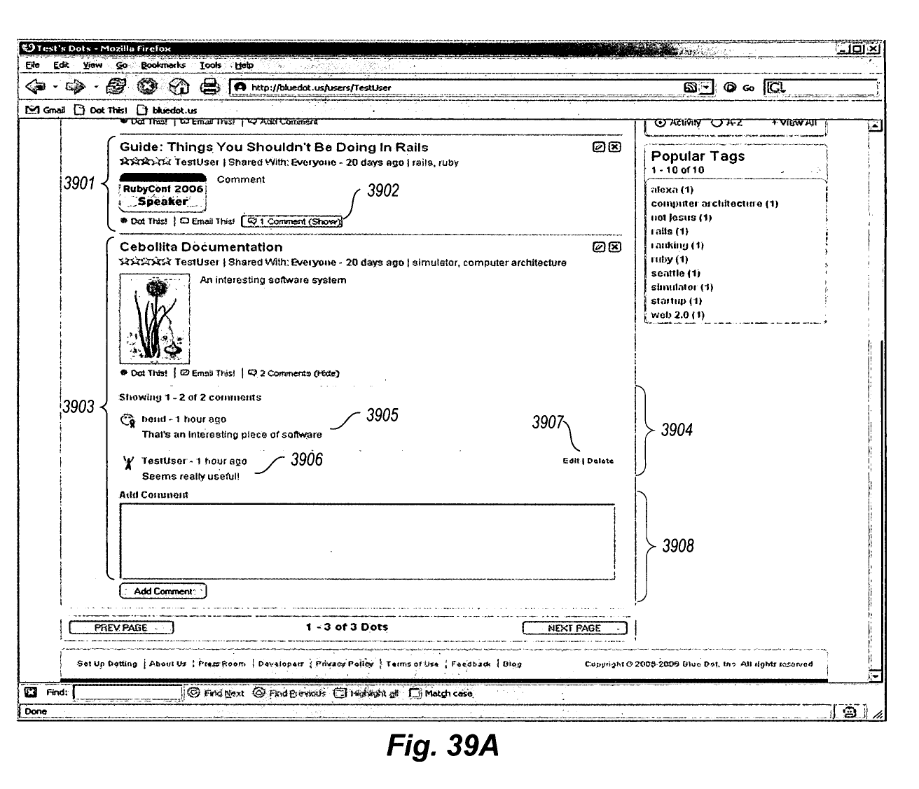

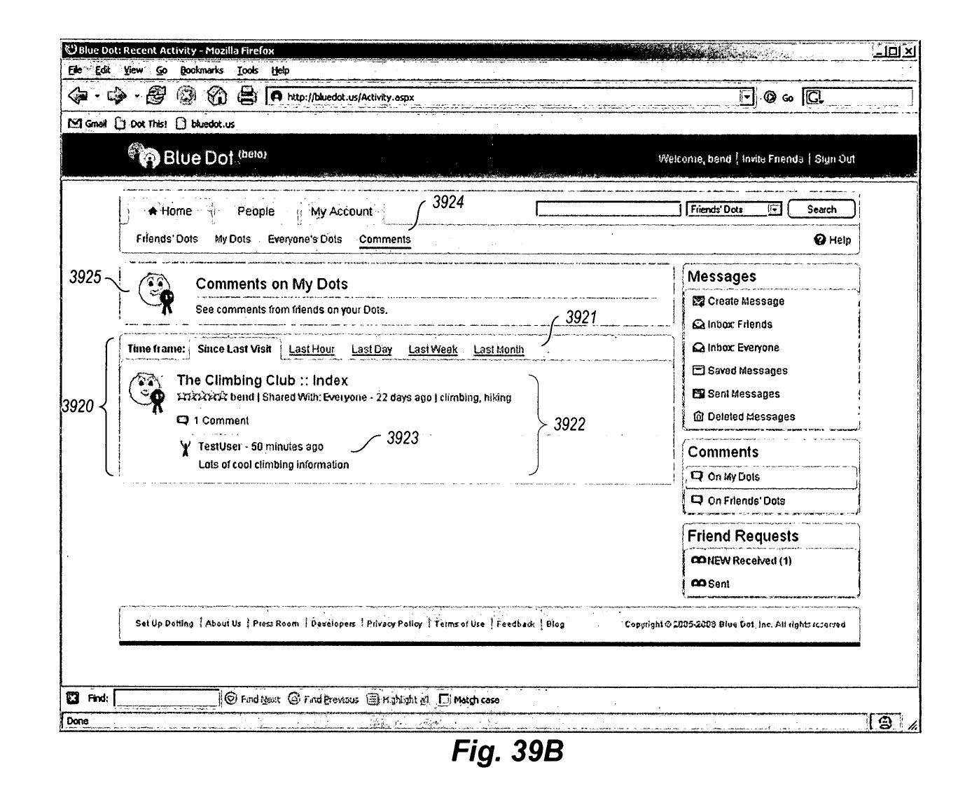

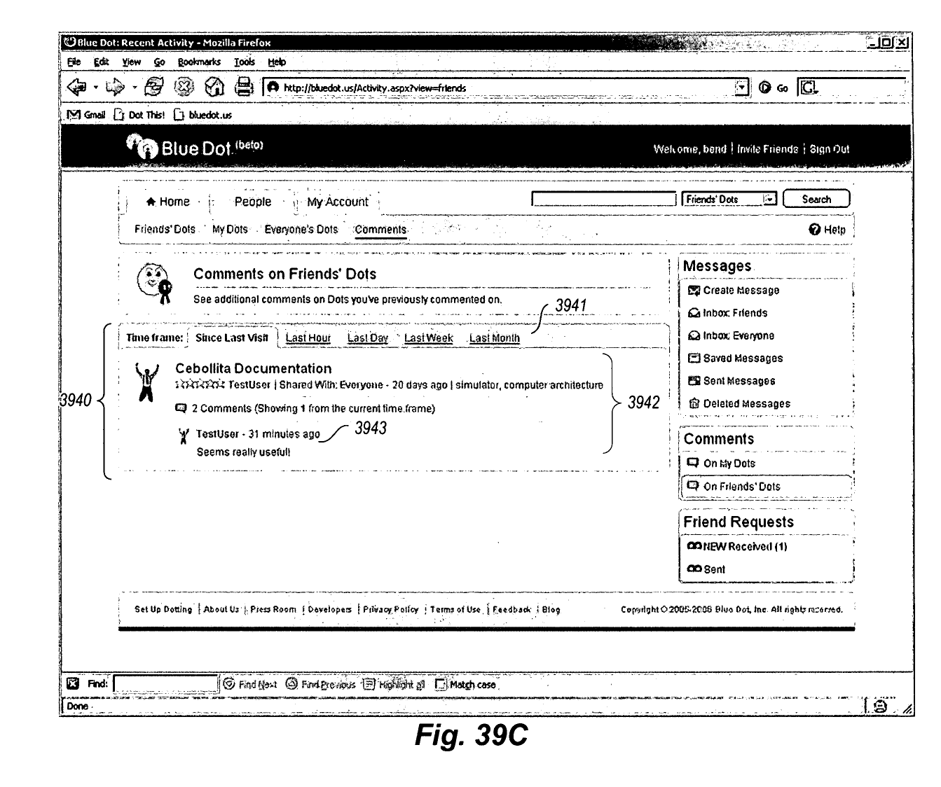

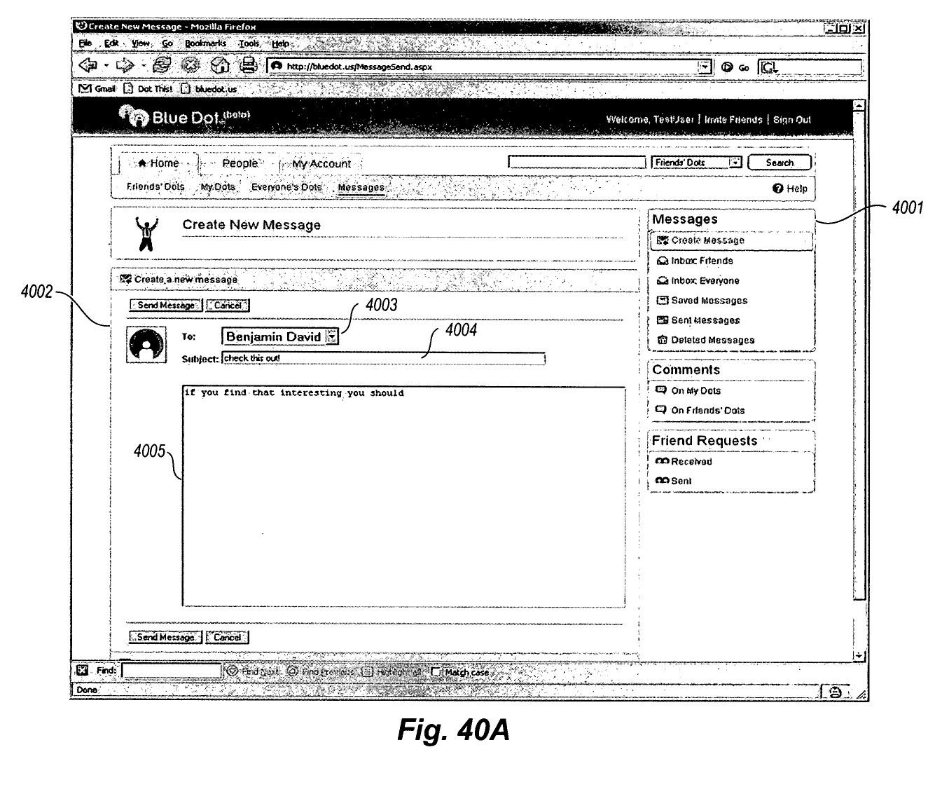

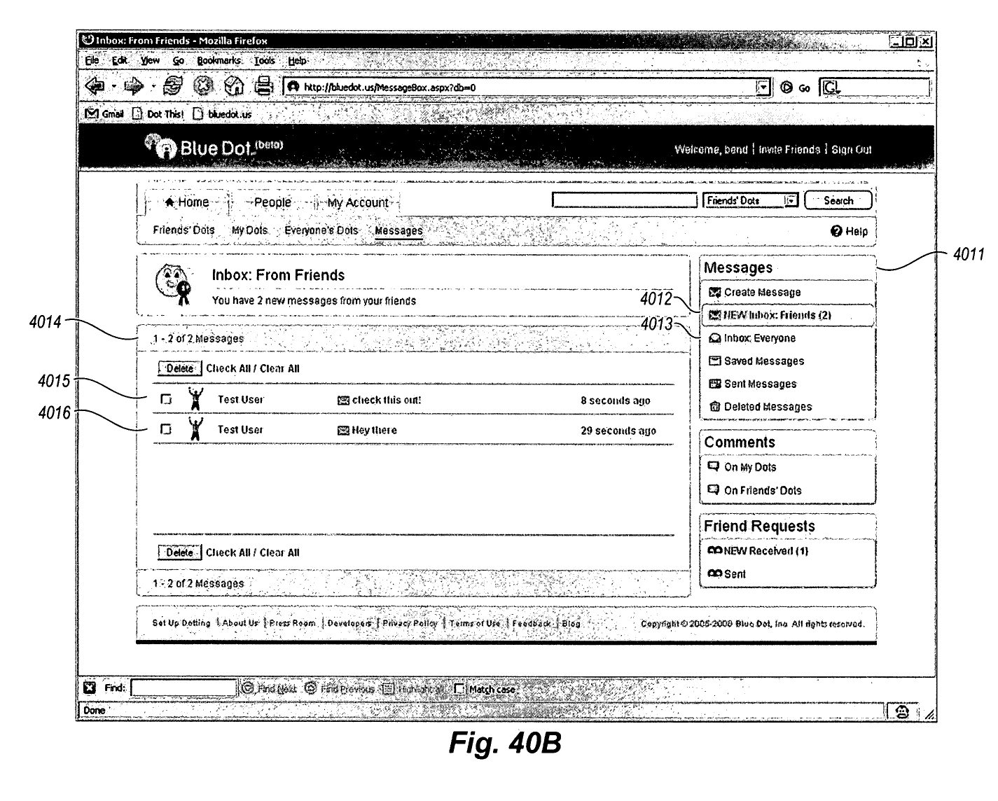

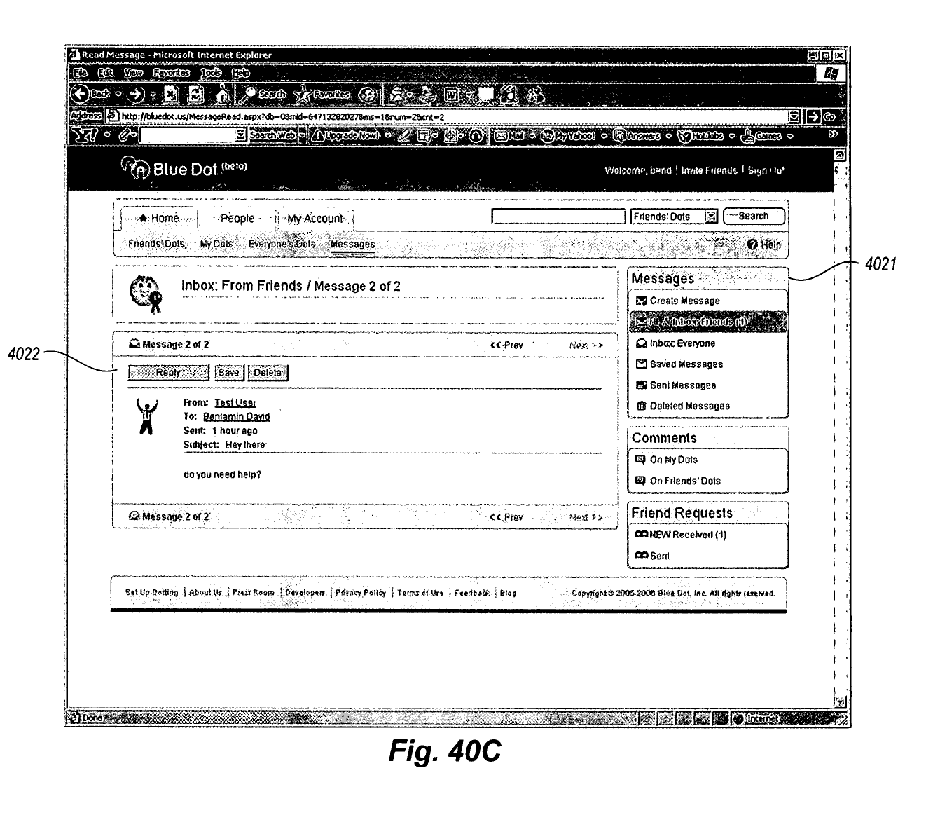

The screen display shown in FIG. 4B also includes a number of other user interface controls that may be utilized by the current user to participate in social discovery. In particular, the illustrated screen display includes a messaging control 413, a comments control 414, a tag area 415, a friend browse control 416, and an invitation control 417. The messaging control 413 may be utilized to send and/or manage messages exchanged with other users of the Social Discovery System. In one embodiment, the SDS messaging capabilities are delivered using whatever underlying email/message system(s) is (are) available. Additional details regarding messaging are provided below with reference to FIGS. 40A-40C. The comments control 414 may be utilized view and/or update comments that have been associated with dots in the Social Discovery System. Additional details regarding dot comments are provided below with reference to FIGS. 39A-39C. The tag area 415 is similar to the tag area 405 described with reference to FIG. 4A. The friend browse control 416 may be utilized to view and/or obtain information about friends of the current user. The invitation control 417 may be utilized to obtain information about friend requests sent to the current user and/or send friend requests to other users. Additional details regarding inviting new users are provided with reference to FIGS. 5-7.

FIG. 4C is another example screen display of the website for social discovery depicted in FIG. 4B. As described with reference to FIG. 4B, the illustrated screen display provides functionality for displaying dots matching predetermined criteria. In particular, the screen display includes the dot display filter control 412 described with reference to FIG. 4B. In the illustrated example, the current user has selected to view dots that have been authored by the current user, and in response, a dot presentation area 421 is displayed. The dot presentation area 421 includes three dot presentations 423-425 reflecting dots that have been authored by the current user. By utilizing the illustrated screen display a user can conveniently obtain information related to dots that he has authored, such as comments associated with those dots by other users.

FIG. 4D is another example screen display of the website for social discovery depicted in FIGS. 4B and 4C. As described with reference to FIGS. 4B and 4C, the illustrated screen display provides functionality for displaying dots matching predetermined criteria. In particular, the screen display includes a dot display filter control 412 described with reference to FIG. 4B. In the illustrated example, the current user has selected to view all dots in the Social Discovery System. The dot presentation area 431 includes multiple dot presentations, displayed in order of recency, such that more recently authored dots are displayed prior to older dots. In other embodiments, other orderings may be utilized, such as by popularity or other measure of activity (e.g., measured by counting the number of dots referencing the same underlying information item, by counting the number of users that have “clicked-through” a dot or otherwise obtained additional information related to a dot, by counting the number of comments that have been added to a dot, etc.)

FIG. 5 is an example flow diagram of an example process of inviting a user to join a Social Discovery System community. As shown in FIG. 2, the “Blue.us” community is one example embodiment of an SDS. A current user invites new users to join the Blue.us community by means of clicking on a link (not shown). In FIG. 5, this process is shown by progressing from page 501 to 503 via step 502. In response, the SDS displays an invitation form 503. When the user selects, in step 504, the “Send invitations” link, an invite is sent. Different embodiments of the system provide users with different numbers of invites (including unlimited) based upon some criteria such as dotting activity, longevity, etc.

Note that in FIG. 5 and several of the flow diagrams that describe the SDS user interface, the “steps” are depicted by means of progressing from one data view (e.g., webpage) to another. This yields a more data-centric description. Equivalent flow diagrams that focus on actions for each “step” to progress the system from state to state are also contemplated and would present a more event-centric view. For the purposes of this description, they are considered fully substitutable for each other.

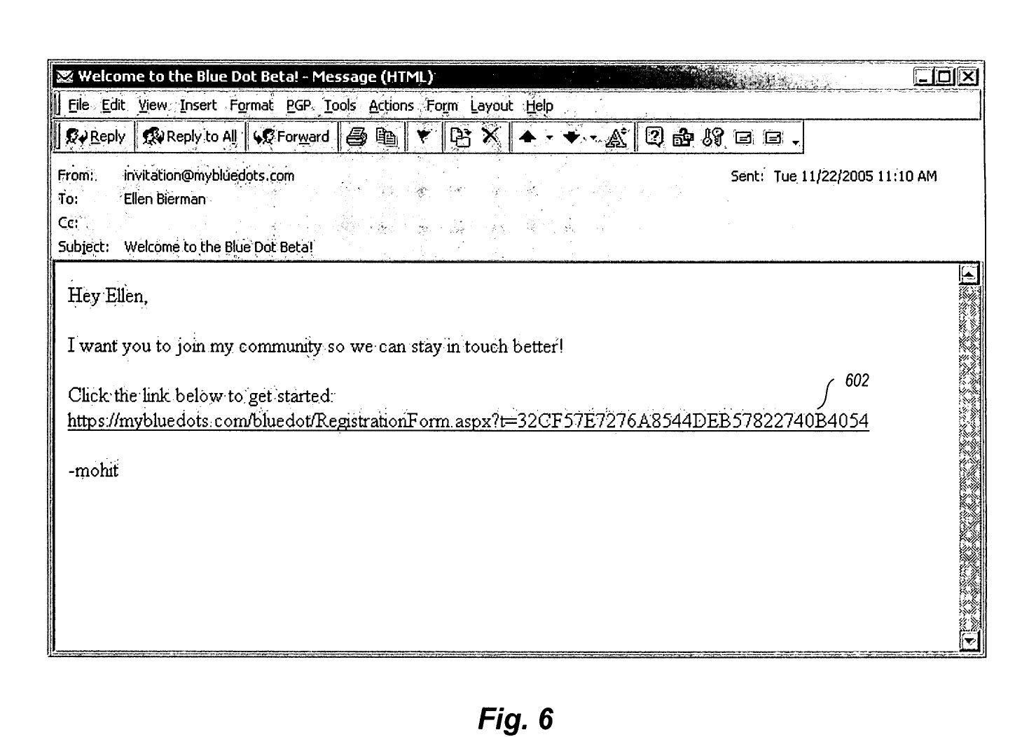

Once an invitation is sent, a new potential member receives an email or other indication of the invite. FIG. 6 is an example screen diagram of an example email invitation. In the illustrated embodiment, the SDS automatically creates the email on behalf of the inviting user and provides sufficient information so that the invitee merely has to click on the link 602 to get started.

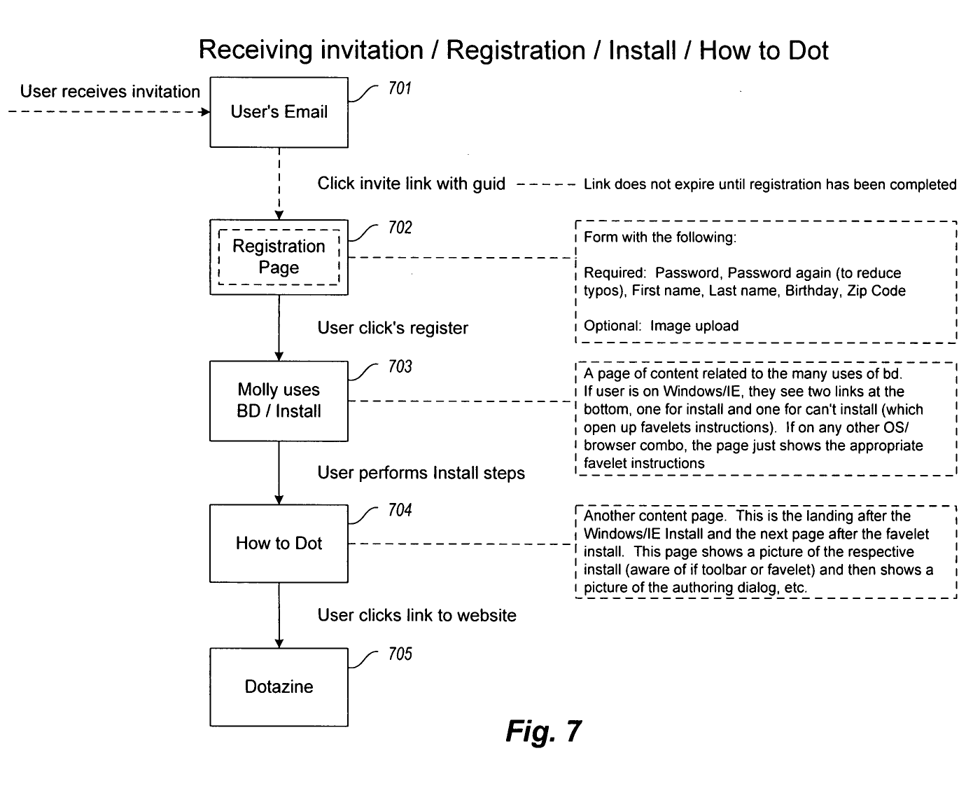

FIG. 7 is an example flow diagram of an example overall process for inviting and receiving a new user into an example Social Discovery System. In step 701, the user receives and responds to an email as shown in FIG. 6. In step 702, a registration page is presented. In step 703, the SDS presents a page explaining what a user can do (generally) and instructions for installing easy access to the SDS home page and links for creating dots. In step 704, the SDS presents a page with instructions to the user on how to create dots. In step 705, the SDS navigates to a page that represents the user's community view, such as that shown in FIGS. 3 and 4.

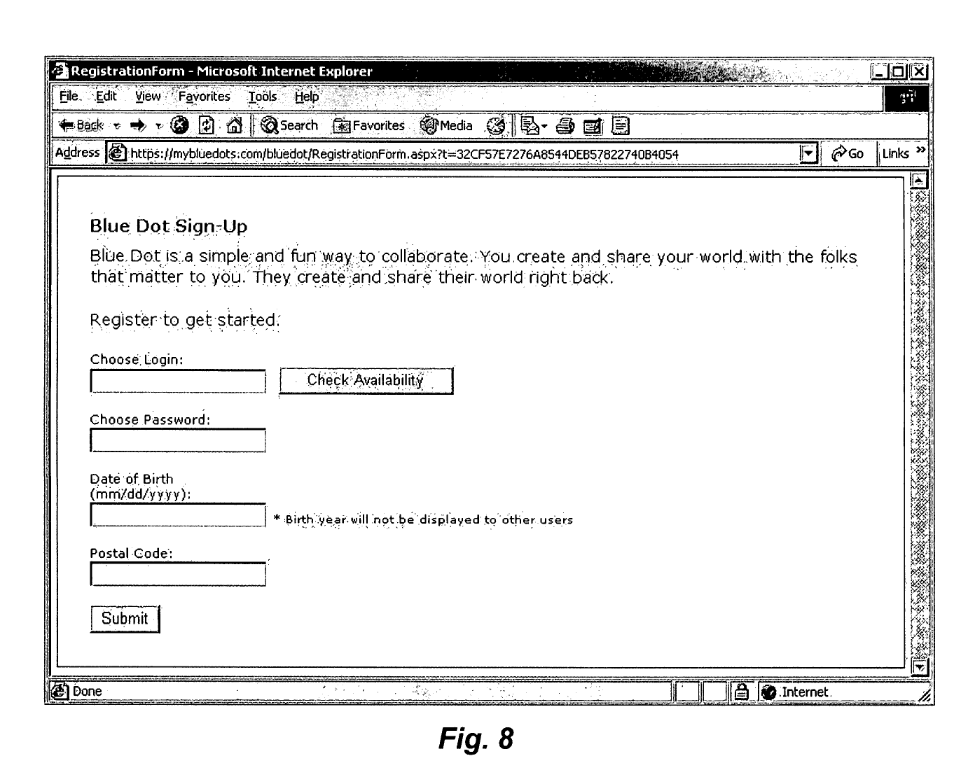

More specifically, FIG. 8 is an example screen display of a registration page and interface for creating a new user in an example Social Discovery System such as that displayed in step 702 of FIG. 7. The user enters basic information so that s/he can be recognized by the SDS on subsequent visits to the website.

In other embodiments, anonymous users may be allowed to utilize the SDS. Anonymous users include users that have not authenticated themselves to the SDS, either because they do not have a user account, or because they desire not to identify themselves, even though they do have a user account. Such users may be allowed to utilize some or all of the capabilities provided by the SDS without engaging in a registration process. The SDS, in turn, may track such users and/or maintain sufficient state such that those users may still be provided with a rich user experience (e.g., by utilizing cookies or other techniques for identifying and/or tracking anonymous users). Anonymous users may of course elect to register at a later time, in order to take full advantage of the features and functionality offered by the SDS. Allowing anonymous users further provides a mechanism by which automated processes (e.g., search engine spiders or robots) can obtain information about the SDS (e.g., by traversing all publicly viewable dots).

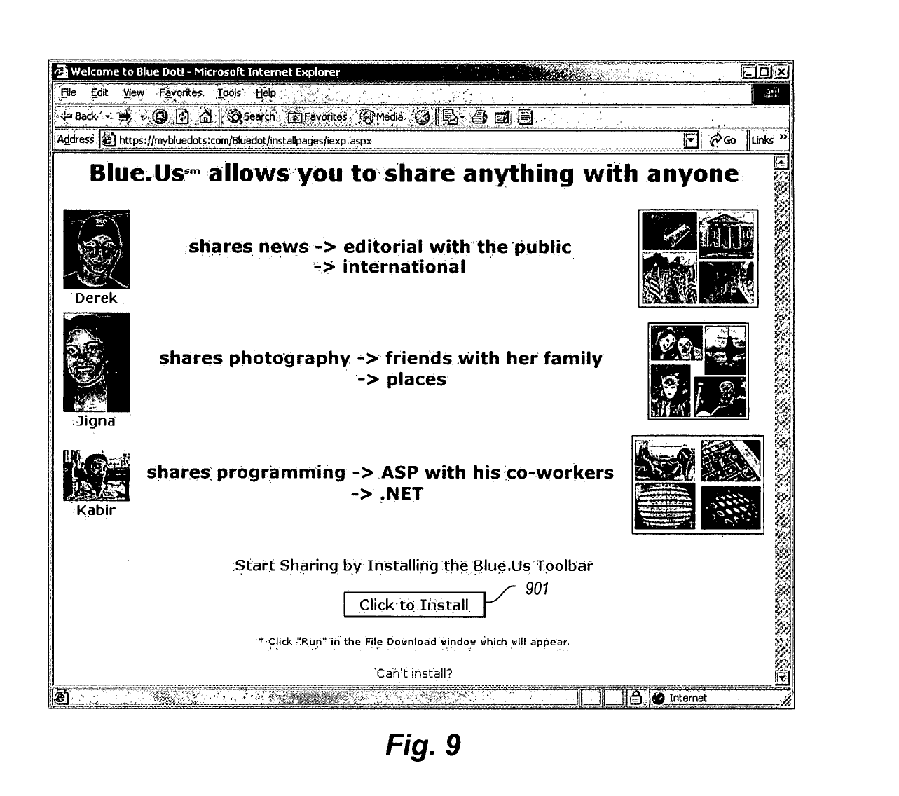

FIG. 9 is an example screen display of informative descriptions of how a user might use an example Social Discovery System. In one embodiment, the use cases described are dynamic and are chosen according to attributes specified during registration, such as the geographic location or age of the user. The new user selects the Install button 901 to install a toolbar of links to create dots (“Dot This!”) and to easily navigate to the SDS website via a homepage link. If the user doesn't install the toolbar at this time, the SDS presents other options for installing. For example, a general interface for installing the SDS toolbar is shown when a user navigates to the website and selects an Install link.

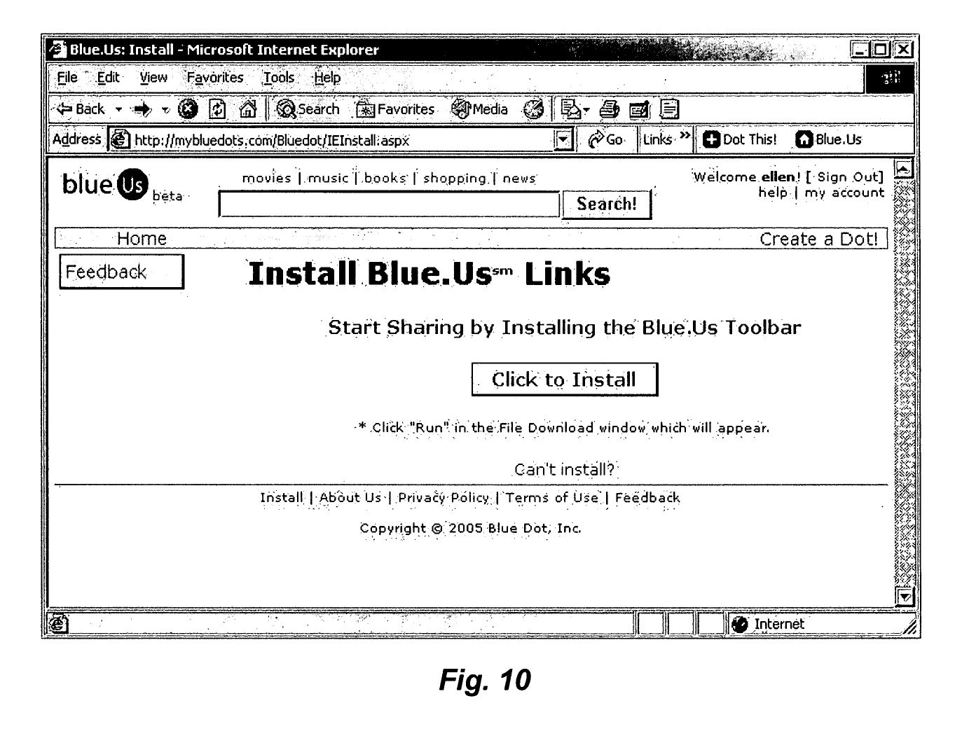

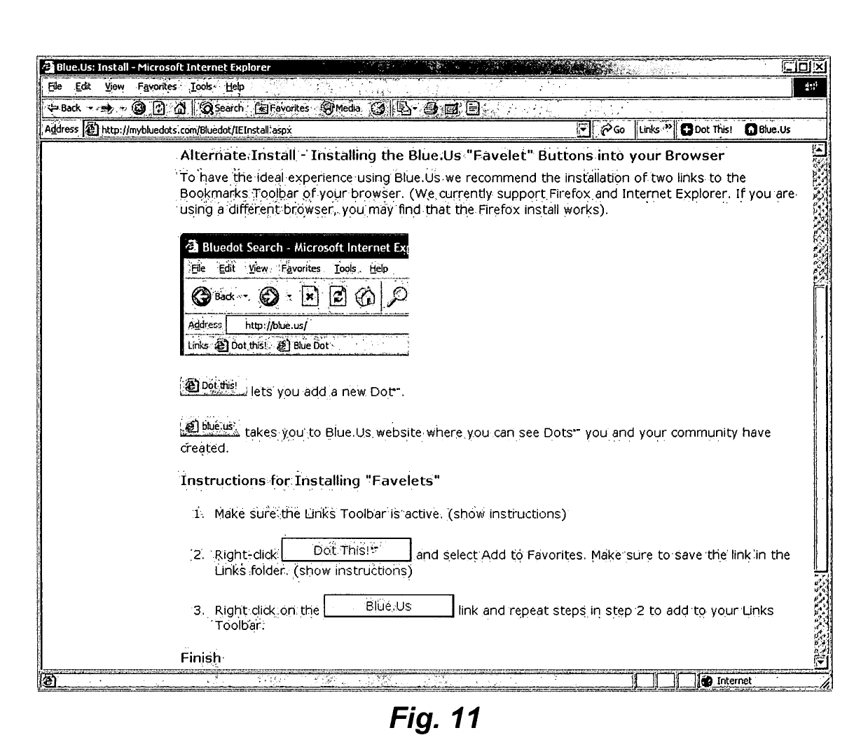

FIG. 10 is an example screen display of an install interface for installing a dot creation Bookmarklet. The install interface is responsible for inserting a Bookmarklet (also referred to as a favelet or scriptlet) link into the user's client web browser application for creating new dots. This link, when selected, injects javascript into the underlying page, which bootstraps the authoring process. Bootstrapping the authoring process includes loading or otherwise obtaining an initial authoring user interface. In some embodiments, the initial authoring interface may be a general-purpose authoring interface that may be utilized by the user to immediately start authoring a new dot. By dynamically loading an authoring interface, versioning problems related to out of date installs may be avoided. In some embodiments, some or all components of the authoring interface may be stored locally (e.g., cached) and utilized so long as their versions are up to date with versions hosted by the SDS. In this manner, such components may in many cases (e.g., when new versions of the components have not been released) be efficiently loaded from local storage. Also, additional authoring interfaces can be loaded that are specific to the dot being authored, specific to one or more characteristics of a device (e.g., cellular telephone or PDA), or to provide additional functionality for particular classes of users, as described further below. FIG. 11 is an example screen display for an alternative installation process for inserting dot creation and navigation links into other portions of a client application (such as the links toolbar of the application).

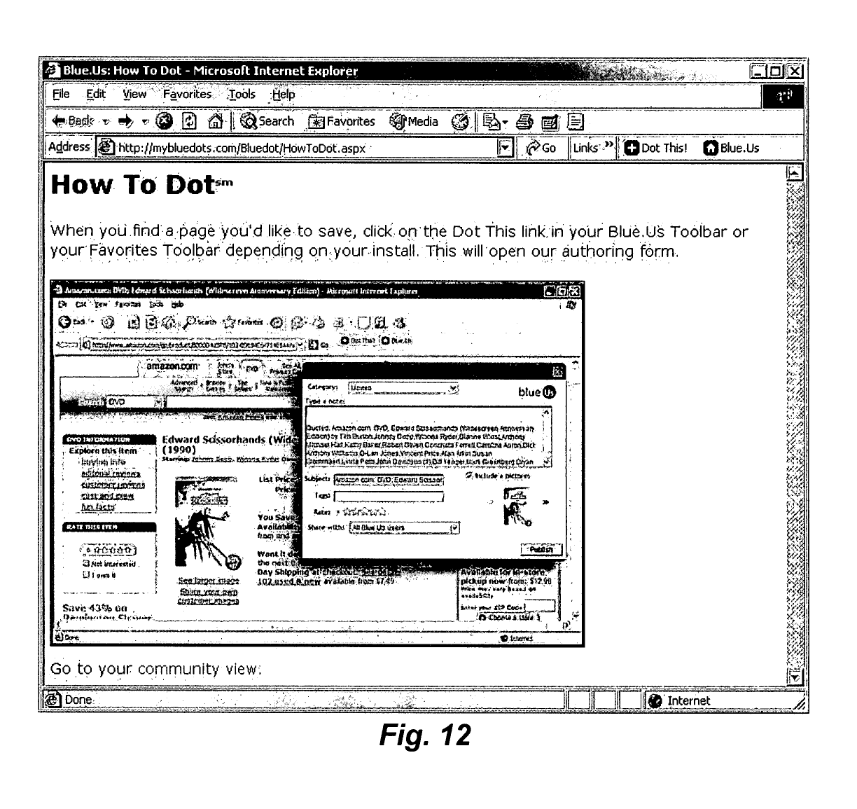

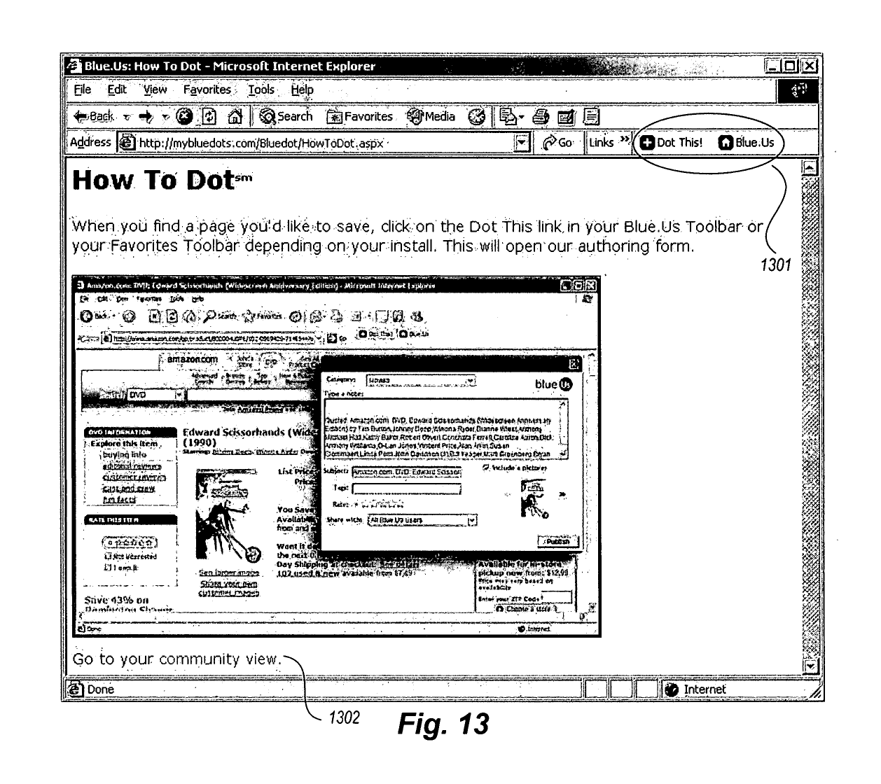

Once the user has successfully installed the Dot This! link and the homepage link, then the SDS (e.g., in step 704 of FIG. 7) presents a web page with instructions on how to create new dots. FIG. 12 is an example display screen of a page that describes an example dot creation process. If the user has already installed the links, then they may already appear in the browser. For example, in FIG. 13, links 1301 show the “Dot This!” link for creating new dots and a link to return to the user's home page in the SDS. When the user selects the “Go to your community view” link 1302, then (e.g., in step 705 of FIG. 7) the SDS presents a view of the SDS appropriate to that user's community. Typically, since the user may have not yet configured sub-communities etc., the user's community at this point may be a community of one user. In some embodiments, the SDS may automatically provide the user with initial community members. The displayed community view may be similar to that shown in FIG. 3 or 4, for example. This view is sometimes referred to as a “dotazine” view that provides a “magazine-like” view of dots.

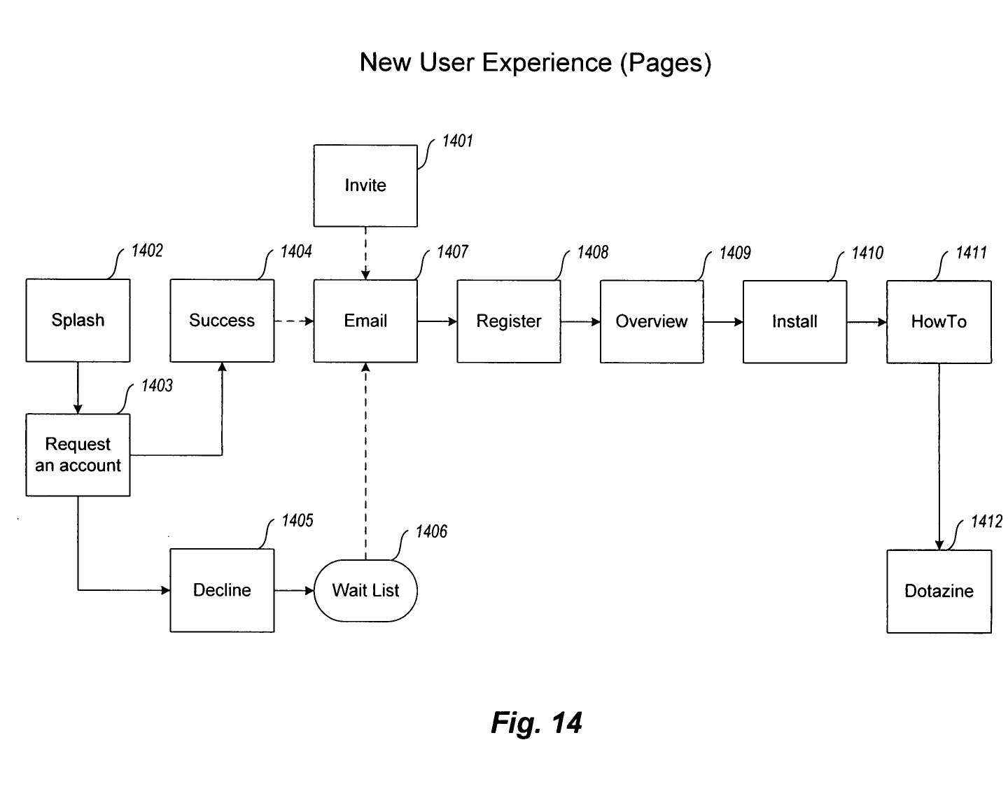

FIG. 14 is an example overview flow diagram describing the experience of a new user in an example Social Discovery System. Specifically, FIG. 14 is an overview flow diagram of the pages displayed in the process described in FIGS. 5-13 to navigate ultimately to a dotazine view. A new user may obtain an invitation either by their request, or by request from another user. In step 1401, a user fills out an invite form such as the one described with reference to FIG. 5. Next, in step 1407, an invitation email, such as the one described with reference to FIG. 6, is sent to the new user. Alternatively, in step 1402, the new user may visit the SDS home page, or “splash” page. Next, in step 1403, the new user may request an account via a new account request page. Then, the new user is either presented with a success page in step 1404 or a decline page in step 1405. The new user is either accepted or declined based on various factors, such as system resources, user identity (e.g., particular e-mail addresses may be banned from the system for various reasons), etc. After step 1404, the new user is sent an invitation email in step 1407. If the new user was declined in step 1405, the new user will be placed on a wait list in step 1406. After step 1406, when it is determined to send an invitation to the new user (e.g., based on increased availability of memberships), the new user may be sent an invitation email in step 1407.

After the new user receives the invitation email of step 1407, the new user can visit a registration page in step 1408, such as the one described with reference to FIG. 8. After filling out the registration form successfully, the new user is presented with an overview page in step 1409, such as the one described with reference to FIG. 9. After electing to install the SDS toolbar, the new user is presented with an install page in step 1410, such as the one described with reference to FIGS. 9 and/or 10. After installing the SDS toolbar, such as by selecting the Install button 901, the new user is presented with an instructional page in step 1411, such as the one described with reference to FIGS. 12 and 13. After viewing the instructional page, the new user may visit the dotazine page in step 1412, such as the ones described with reference to FIGS. 3 and/or 4A-4D.

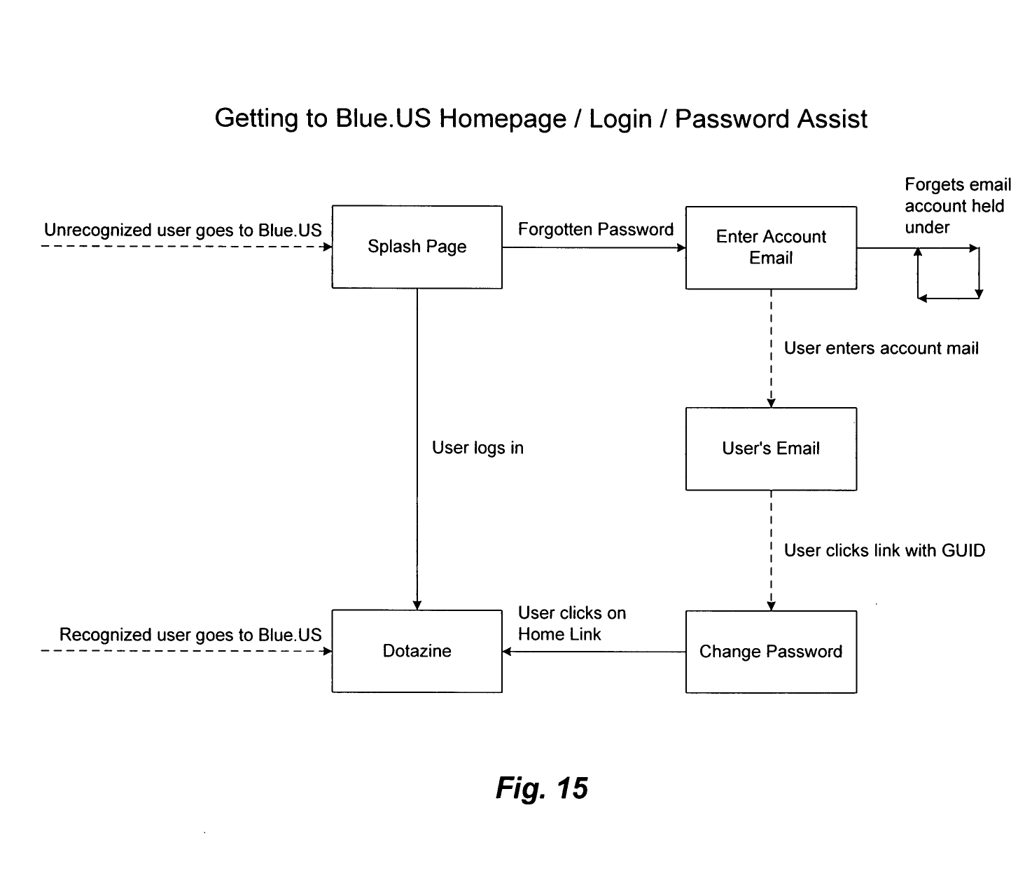

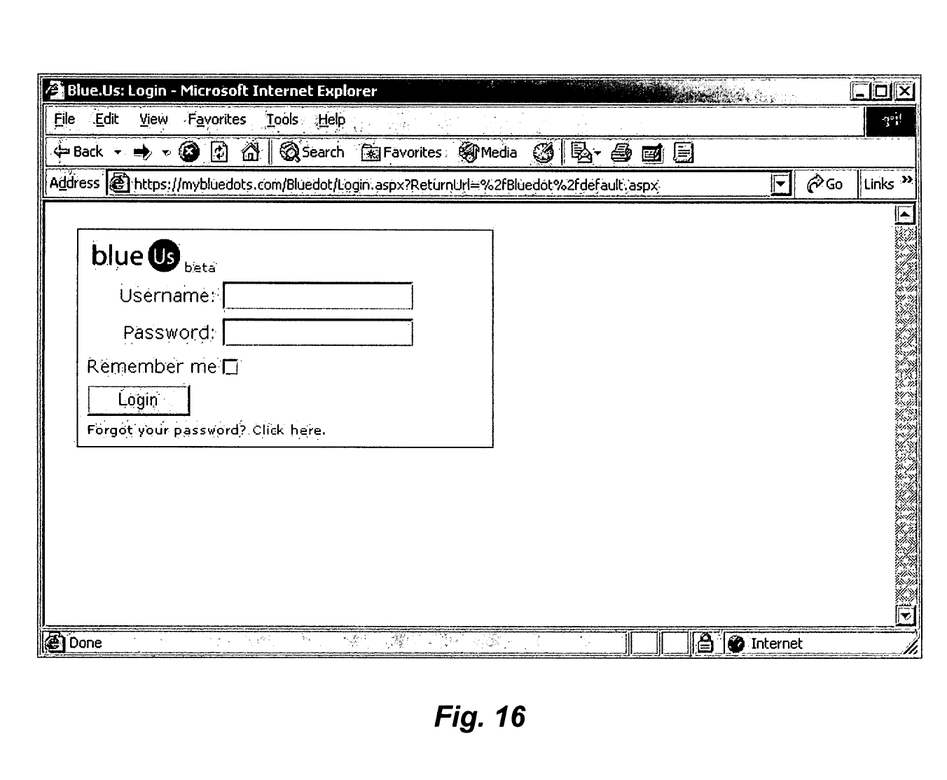

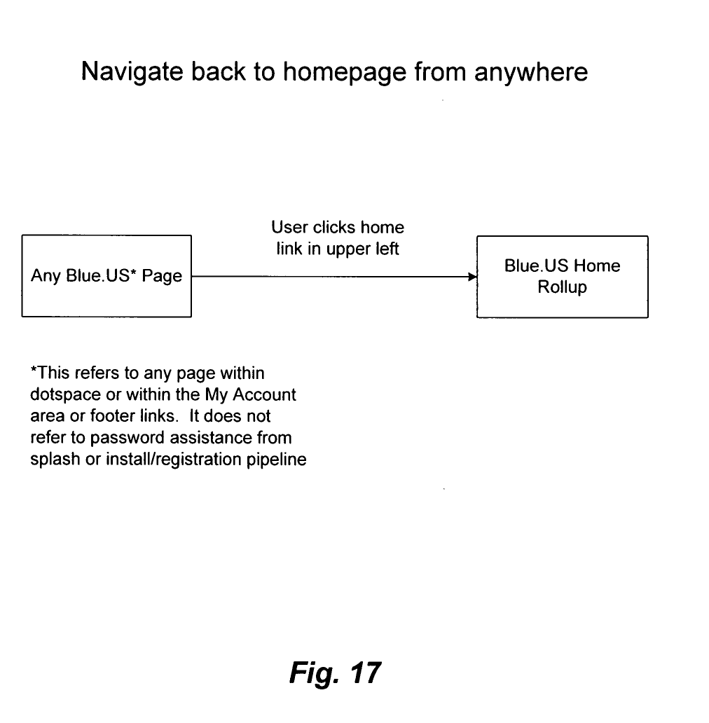

Once a user has successfully registered with the system, the user can navigate to the homepage and login if necessary and proceed with social discovery and exploration. FIG. 15 is an example flow diagram of logic invoked when a user navigates to an example Social Discovery System homepage (website). If the user is unrecognized, then the user is required to login or otherwise authenticate himself or herself. FIG. 16 is an example login display screen for authenticating a user of an example Social Discovery System. If the user is recognized, then the SDS logic navigates to the user's dotazine view. For easy navigation, note that the user can navigate back to this homepage from anywhere by means of the homepage link once installed. FIG. 17 is an example screen display showing logic associated with an example installed Social Discovery System homepage link.

In the example SDS, the logged in user can now perform a variety of operations. For example, the user can filter the dot presentation (for example, create a “filtered dotazine” view) by group, buddy, community, sub-community, category, or search specification. The user can also expand or collapse or otherwise manipulate display widgets, search for dots that match a specified criteria, author new dots, edit existing dots, or manage the user's account. Other operations can be supported by the SDS as desired.

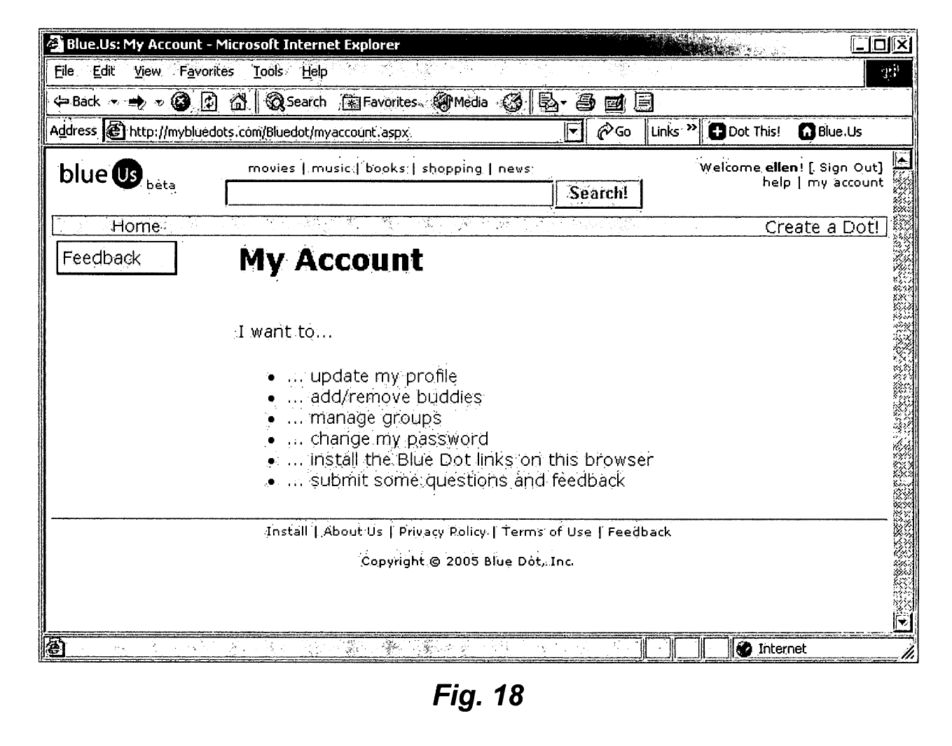

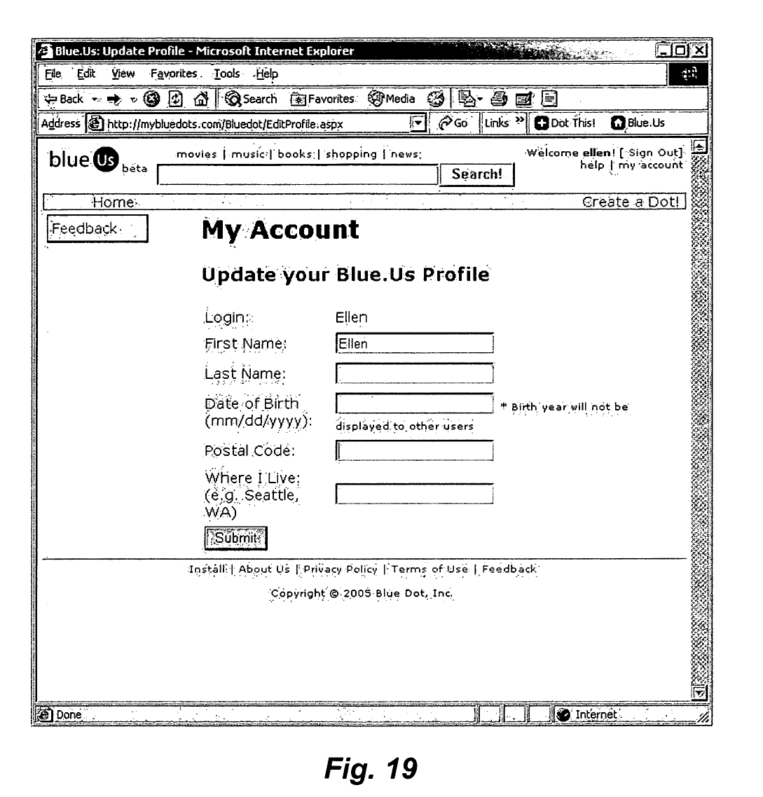

A user can manage the user's account by selecting a link (e.g., the my account button 407 in FIG. 4) from the dotazine view. FIG. 18 is an example screen display of an interface presented to manage a user's account. The user can update his/her profile, add or remove buddies, manage groups of buddies (e.g., sub-communities of the user), etc. FIG. 19 is an example screen display of a web page for changing a user's profile information.

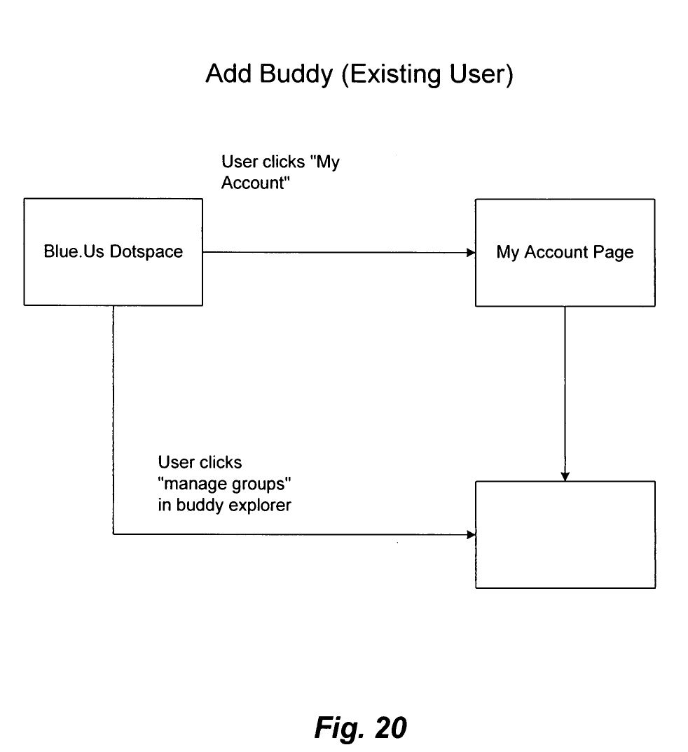

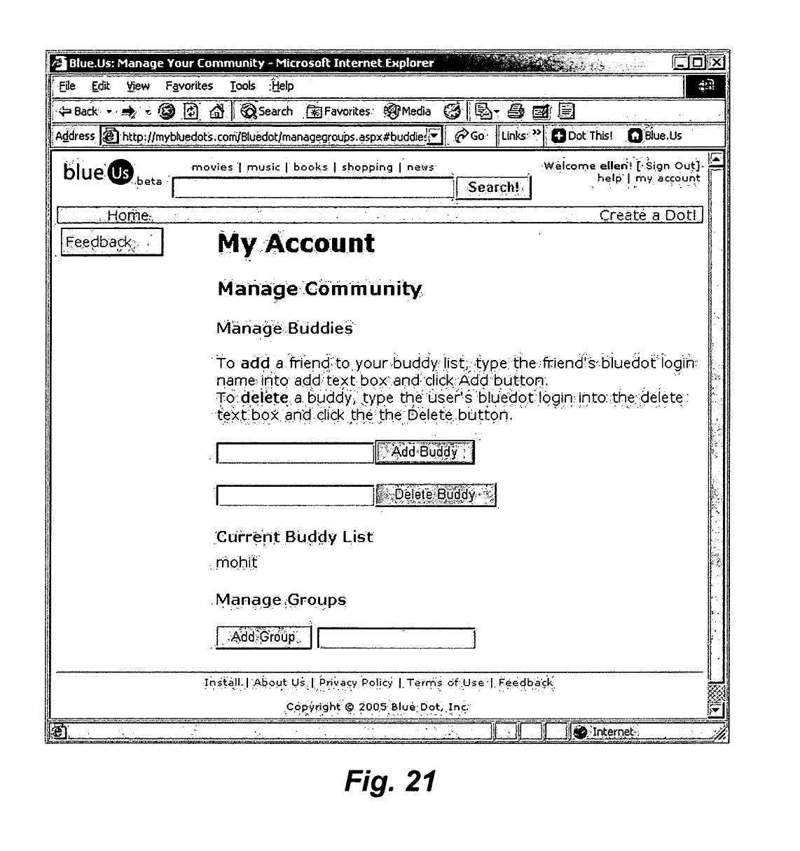

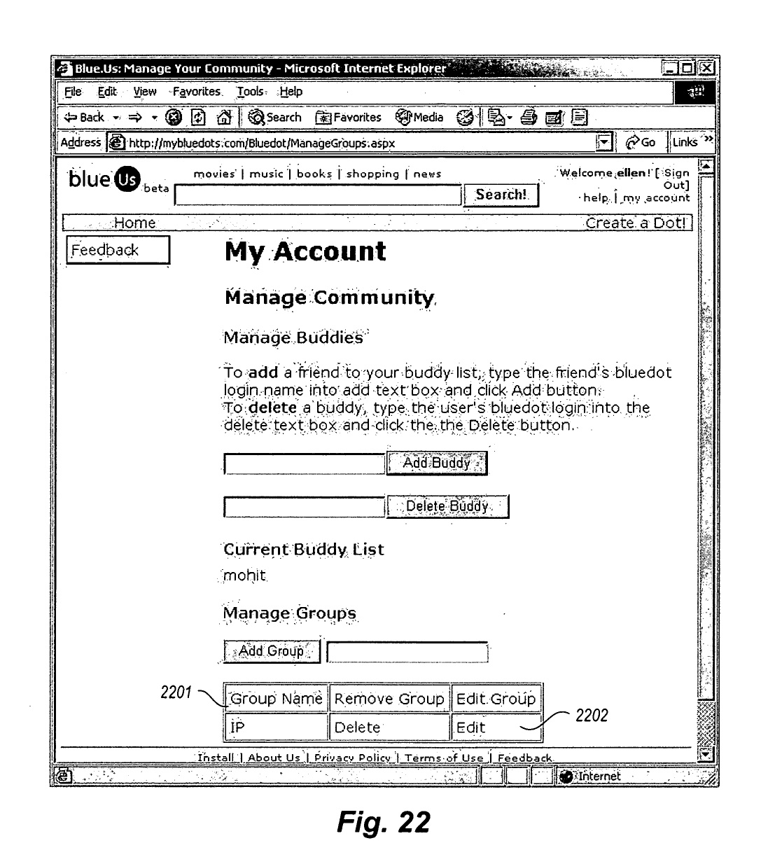

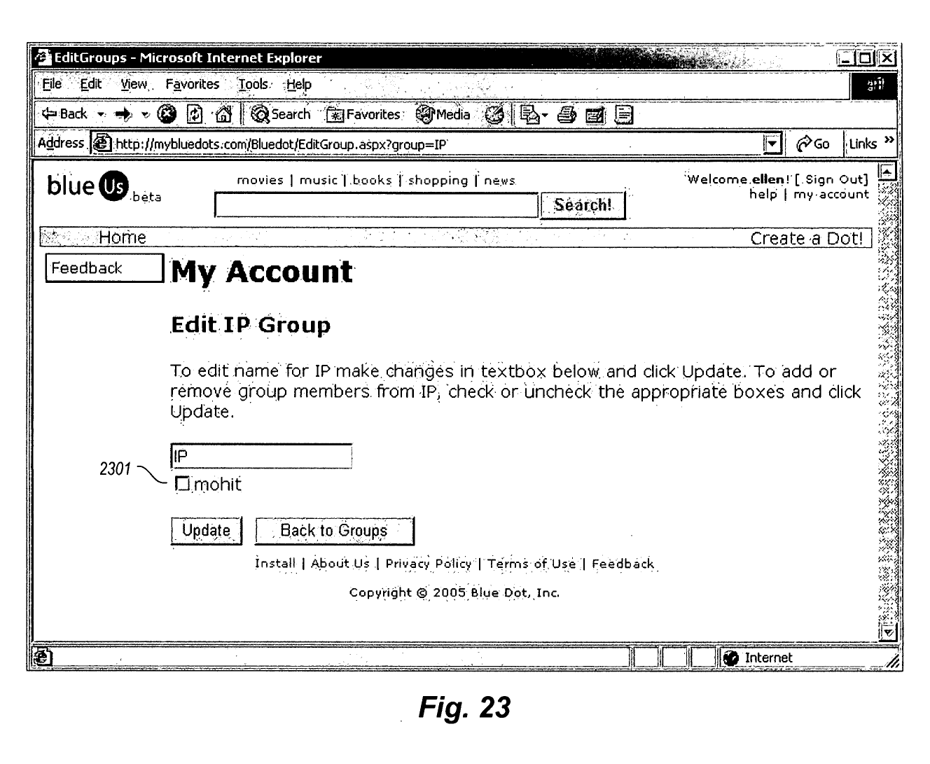

FIG. 20 is an example flow diagram for example pages displayed to manage buddies and groups in the Social Discovery System. FIG. 21 is an example screen display of an interface for adding other users to a user's community (as buddies). A user can also group buddies into groups, for example, to associate permissions to view certain of the user's dots. This allows the user during dot creation to target dots to particular sub-communities of the user's community. Once a user creates a group, the user can designate buddies to belong to that group. A user can belong to more than one group. FIG. 22 is an example screen display for managing a user's community once the user has defined a group. For example, in FIG. 22, the user has defined one group “IP” which is shown in Group area 2201. To edit the group (e.g., add/remove buddies from the group), the user selects the “Edit” link 2202. FIG. 23 is an example screen display of an interface for modifying the members of a sub-community. A list of potential members 2301 of the user's community is provided with checkboxes to indicate inclusion or exclusion.

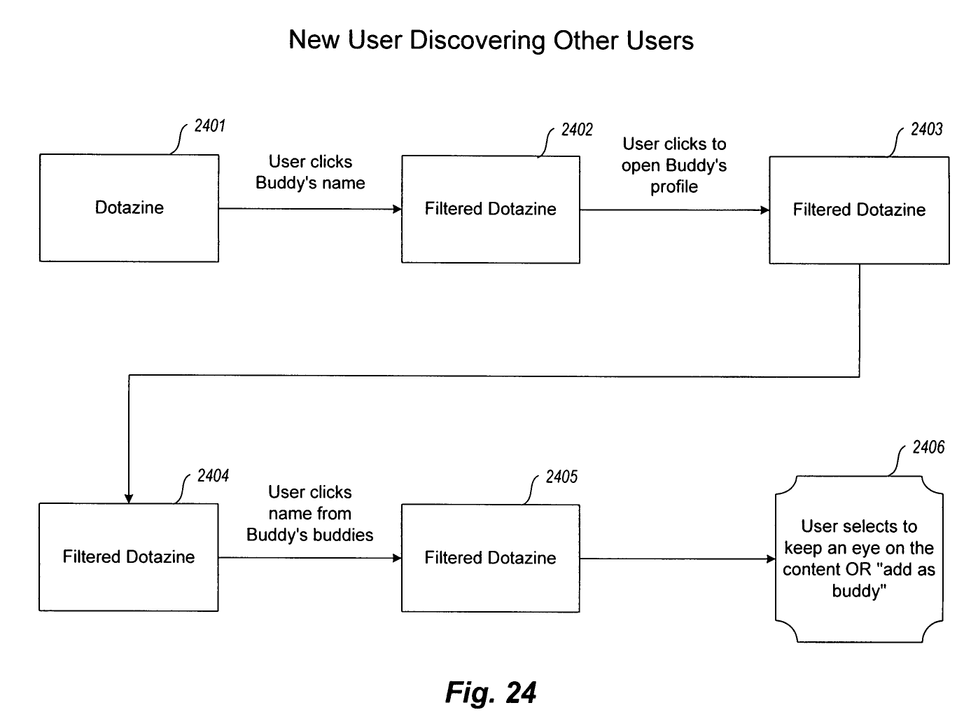

In addition, in some embodiments, the SDS provides a means for discovering additional buddies in the system. FIG. 24 is an example flow diagram of a process for discovering and adding new buddies. Typically, these new buddies are discoverable (if permissions allow) as friends of friends—that is buddies of the user's existing buddies. In step 2401, from the dotazine view, the user selects one of the user's buddies. A filtered view of that buddy's dots are presented along with the buddy's name. In step 2402, the user selects the buddy's name to open that buddy's profile. The display is then modified in step 2403 to present the buddy's profile. From there, in step 2404 the user can select buddies of that buddy (whose profiles are public to that community) to display a filtered dotazine view, step 2405, of that buddy of buddy's dots. In step 2406, the user can decide whether to add the buddy of buddy to the user's buddy list directly or not.

In other embodiments, other types of relationships between two or more users of the SDS may be established and/or represented. For example, a first user may be able to establish a “watch” or “observe” relationship with a second user, possibly without the knowledge or consent of the second user. The SDS may then periodically notify the first user of the activities (e.g., newly created dots) performed by the second user. In this manner, a user may “subscribe” to dots created by another user without having to first establish a friend or buddy relationship with that user.

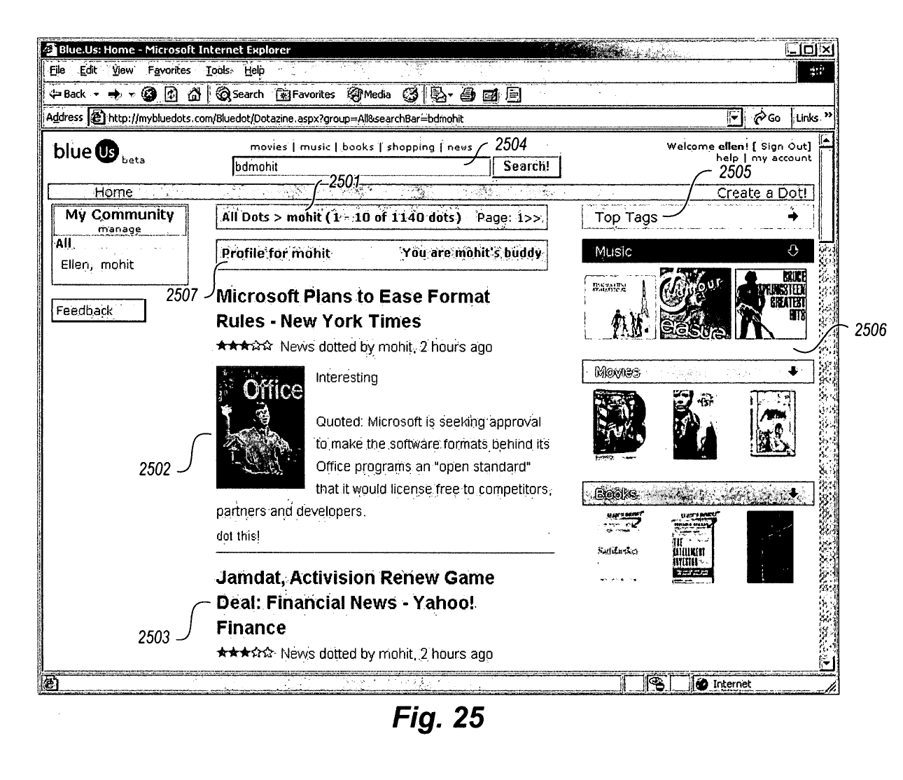

As mentioned, a user can filter the dot presentation in a variety of ways. For example, a user can select a buddy in the community area and show all the dots authored (also referred to as published) by that buddy. FIG. 25 is an example screen display of a dot presentation filtered according to a particular buddy. In this case, the system performs a search using the buddy name as a special term, as can be seen in the search specification field 2504. Note that the buddy name is prefixed by “BD” to indicate that it is a special term understood by the system. The dots displayed in the presentation area, namely dots 2502 and 2503 are the most recent dots published by the buddy. A variety of different algorithms can be used to determine what dots are displayed in what order, including time-based (e.g., most recent dot first), author-based, alphabetized, according to some computed measure of statistical relevance, etc. In one embodiment, the top tags 2505 and bookshelf widgets 2506 are also filtered to show tags and dots, respectively, that have be used/published by the selected buddy. From this filtered dotazine view, the user can access the buddy's profile information through link 2507.

Although not shown, the user can similarly select a group and filter the dot presentation to show only those published by any member of that group.

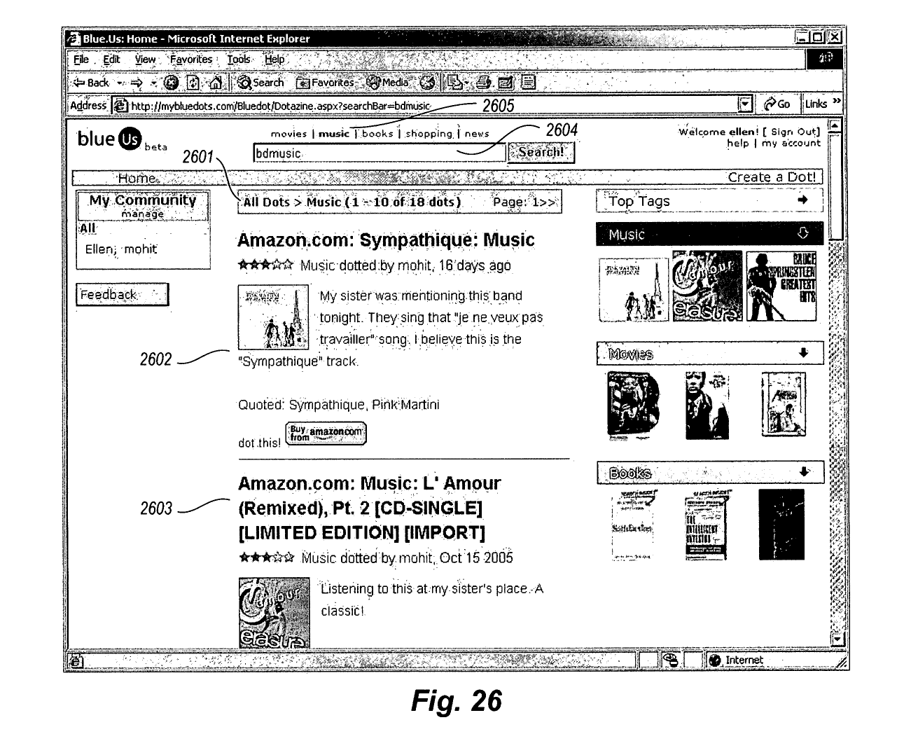

The user can also filter the dot presentation according to category type. In one example SDS, each dot is associated with a category. In many cases when the dot is created, the system is able to auto-categorize the dot for the user. Having a category associated with the dot allows the system to be intelligent about displaying the dot, providing additional interfaces for manipulating the dot, filtering, etc. In one example SDS, the categories include: movies, books, music, food, news, blogs, shopping, events, home dots (private), check it out (other). Other categories can be incorporated, and sub-categories can be defined as part of a taxonomy created over time by the system. FIG. 26 is an example screen display of a dot presentation filtered according to a category. The user can designate a category by selecting a category link such as music link 2605 or can directly enter a category as “bdmusic” as a search term. In the case illustrated, the user has selected the music link 2605 and in response, the system performs a search for “bdmusic” as can be seen in the search specification field 2604. The dot presentation is then filtered to show the music dots 2602 and 2603 for the user's community. The filter designation information can be seen in status information 2601.

Depending upon the display engine implementation, the SDS could also change the presentation of dots when they correspond to a particular category. For example, dots that relate to event information might be shown as somehow associated with a calendar display. Other dot categories and subcategories may have other “smart” or rich presentations. In addition, the SDS may also exploit various standards or protocols for expressing categorical and/or ontological information, so as to efficiently create, display, or provide dots.

The user can also specify any combination of filters by using a search specification string. In the embodiment shown a particular search language is used, which allows special terms prefixed by “BD” or other words specified as keywords. Other embodiments could incorporate a rich set of operators (such as Boolean expressions) or other forms for specifying instruction to the SDS.

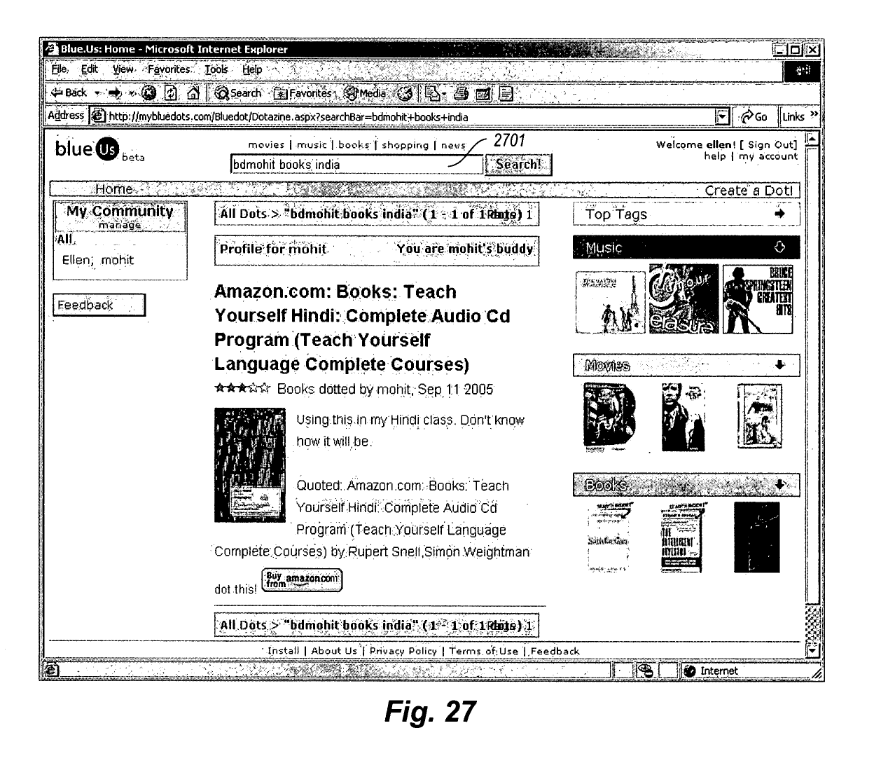

FIG. 27 is an example screen display of a dot presentation filtered by a search string. Search string 2701 combines a buddy search with search terms. Search terms are treated as a keywords in a “context search.” Although the search string specified a category word as a keyword (without the “BD” prefix), a search could have been performed as “bd<buddyname> bd<category name><keyword><keyword>” etc. Any dimension with respect to the dots could potentially be used to provide a filtered view. A context search is performed using any keywords specified in the search string 2701 according to an algorithm that specifies what aspects of dots should be looked at in what order. In one example SDS, the keywords are compared against tags, then dot metadata, category, subject, and then the text of the URL or digital reference itself. Other algorithms are of course possible to integrate into the SDS. Of note, by combining information about the users in a communities and keywords against the dot “corpus”—a view of social knowledge can be tailored more easily to anticipate what might truly be relevant to the user.

Although FIGS. 25-27 describe various ways that users can filter dot presentations, dot presentations may be automatically determined and/or filtered based on information related to users and their communities. For example, in some embodiments the SDS may provide contextual browsing capabilities, such that a user may access or otherwise be provided with social knowledge that is customized based at least in part on the context of the user. Context may include various features and/or attributes of the user, such as an activity the user is currently engaged in (e.g., driving a car), the current geographic location of the user, a website that is currently being visited by the user, etc. Context may also include information regarding past features of, attributes of, and/or activities performed by the user (e.g., a browsing history of the user, a route consisting of multiple geographic waypoints traversed by the user over the course of traveling through a city, etc.) The SDS may leverage knowledge about the user's current context in order to provide the user with information relevant to his/her current context. For example, if a user is visiting a particular website, he may be informed by the SDS of reviews or other information about that web site authored by himself or other users of the SDS (e.g., his community). In another embodiment, if a user is using a location-aware mobile device (e.g., a GPS equipped cellular telephone), the SDS may automatically send the user text messages that include dots that are relevant to the user's current location (e.g., dots describing particularly good restaurants or clubs at or near the user's location).

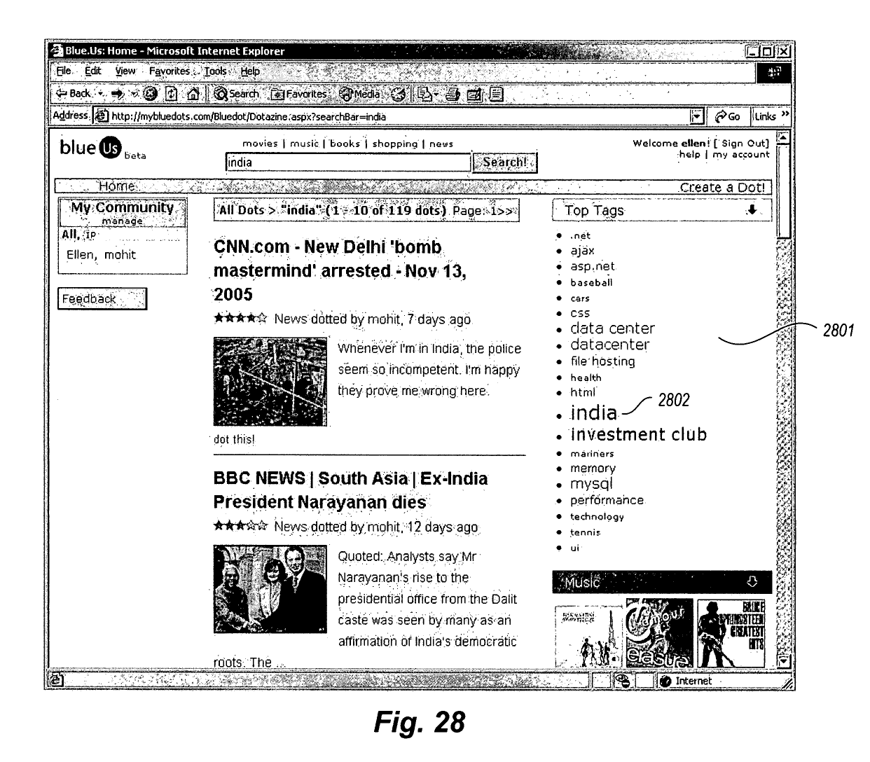

As mentioned, in one embodiment the SDS provides a “top tags” area for presenting relevant tags to a user. The user can select a particular tag from the tag list to filter the dot presentation as well. FIG. 28 is an example screen display of a dot presentation filtered by selecting a tag. Specifically, FIG. 28 shows a dot presentation filtered by selecting the tag “India” 2802 from the tag list 2801. In one example SDS, the tag list corresponds to whichever part of the community is most applicable to the dot presentation. For example, if a dot presentation has been filtered according to a user, then the tag list 2801 reflects the tags relevant to that user. Note that many forms of presenting information about the tags can be incorporated. For example, different fonts, sizes, colors, etc. can be used to indicate characteristics of the various tags. In addition, different orderings and rankings can be supported, for example, alphabetic, most frequently used, most recent, etc.

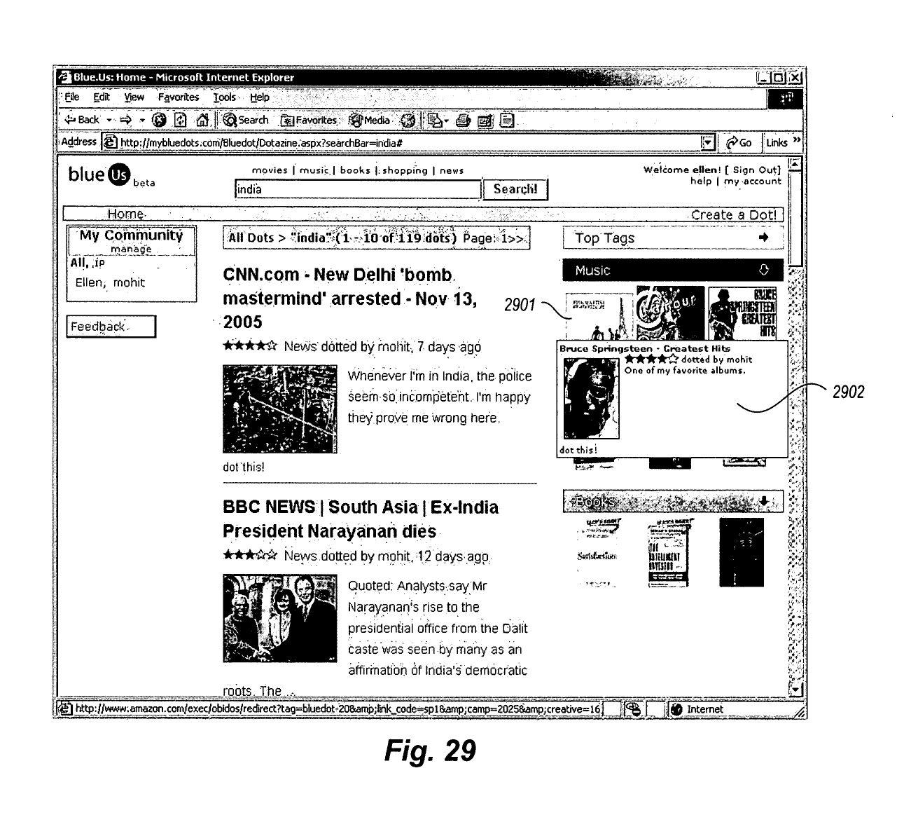

The SDS also supports various interactions with other display widgets. For example, the user can “hover” an input device over a bookshelf widget to obtain detailed information regarding the featured dot. FIG. 29 is an example screen display of a tooltip presented in response to hovering over a music widget. The user has placed a mouse cursor over music widget 2901 causing tooltip 2902 to be displayed. Tooltip 2902 displays information such as the publisher of the dot, a description, a portion of content from the dot source, a ranking, a link to purchase (if such option is available), etc.

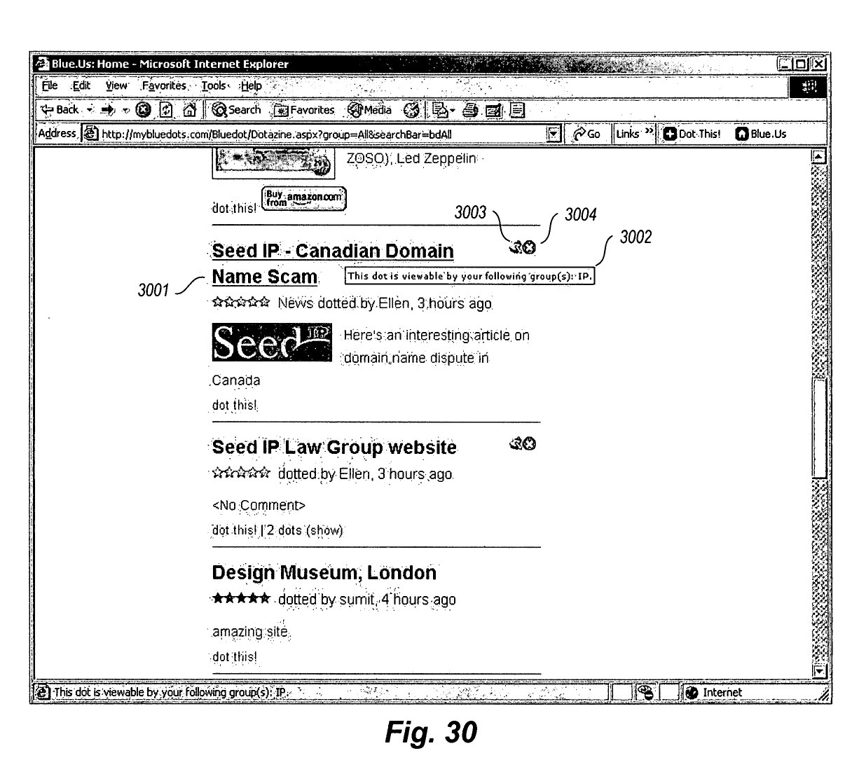

Note that by hovering over the title of a dot presentation, the user can also obtain permissions information. FIG. 30 is an example screen display of a permissions tip. When the user places the cursor over dot presentation title 3001, the SDS shows a permissions tip 3002 which explains the current permissions associated with that item of content. Note that since the dot was authored by the current user, an edit widget 3003 and a delete widget 3004 are displayed to allow the user to manipulate the dot.

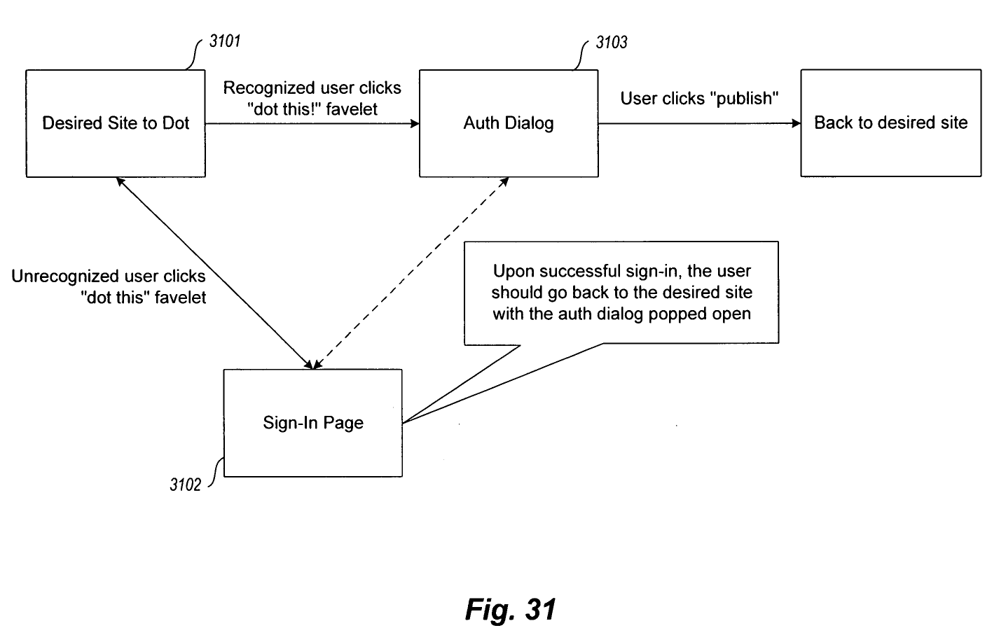

One of the other capabilities provided by the example SDS is the ability to author dots. FIG. 31 is an example overview flow diagram of an example process of dot creation. Dot creation is also known as dot authoring, dot publishing, dotting, etc. As mentioned above, if a “Dot This!” link has been installed, the user need only navigate to the web page that is to provide source content for the new dot and click on the link. Specifically, from the source content page in step 3101 if the user selects the Dot This! link and is recognized by the system, then appropriate authoring dialog(s) is(are) displayed in step 3103. Otherwise, in step 3102, the system first presents a login page (such as FIG. 16) requesting the user to provide authentication information. Once the user is recognized, the user then clicks on a “publish” button in step 3103 from the authoring dialog. If the user wishes to provide no custom entered information, then dot authoring can be accomplished in a single click operation. A detailed description of authoring and the authoring dialogs are provided further below. In summary, the “Dot This!” link causes successive authoring user interface fragments (e.g., widgets, components, etc.) to be loaded which are generic and content- or user-specific as indicated by the underlying data. The SDS attempts to be smart about what user interfaces are required and attempts to automatically provide as much information and intelligence as possible so that dot creation can be as automated as possible. By locating at least some of the SDS authoring components on the client side (e.g., by use of client-side scripts), intelligence and customization capabilities may be provided efficiently and responsively (e.g., because some of the authoring processing occurs on the client system). In addition, at least some of these authoring components can be cached on the client system, such that rich user interfaces can be provided with a minimum of network (e.g., download) latency.

Furthermore, in some embodiments, “fall back” authoring interfaces may be provided (e.g., ordinary HTML forms on separate web pages) that may be utilized when a user is operating a system that does not support particular execution environments, languages, or technologies utilized by the SDS, so as to provide access to the SDS to as many client systems as possible.

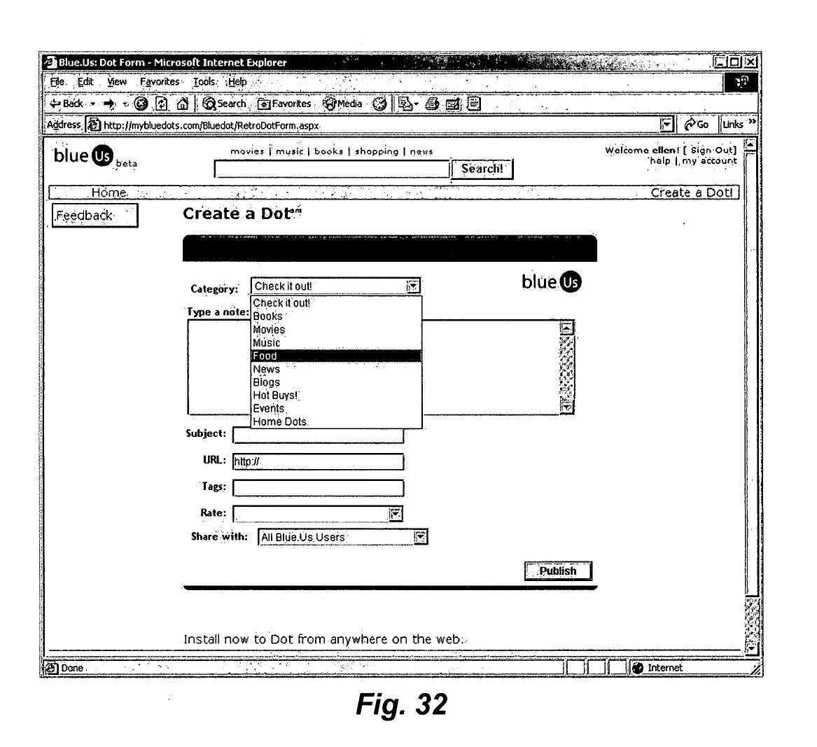

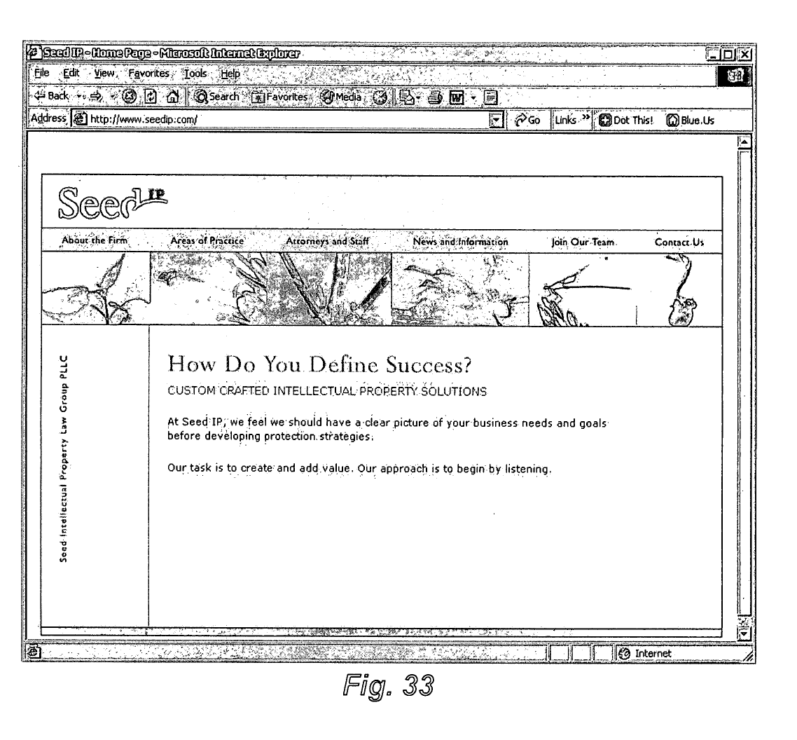

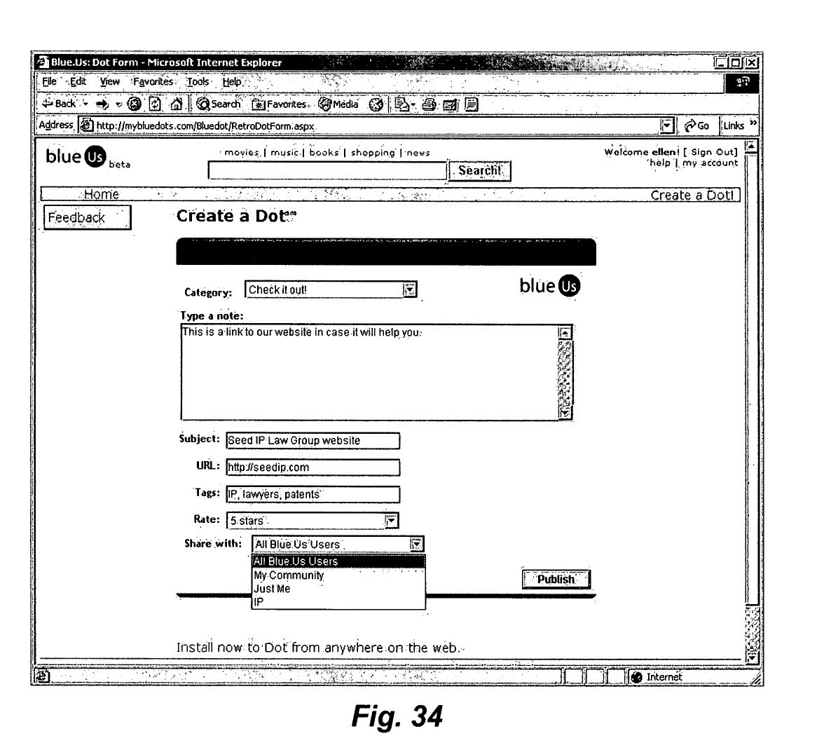

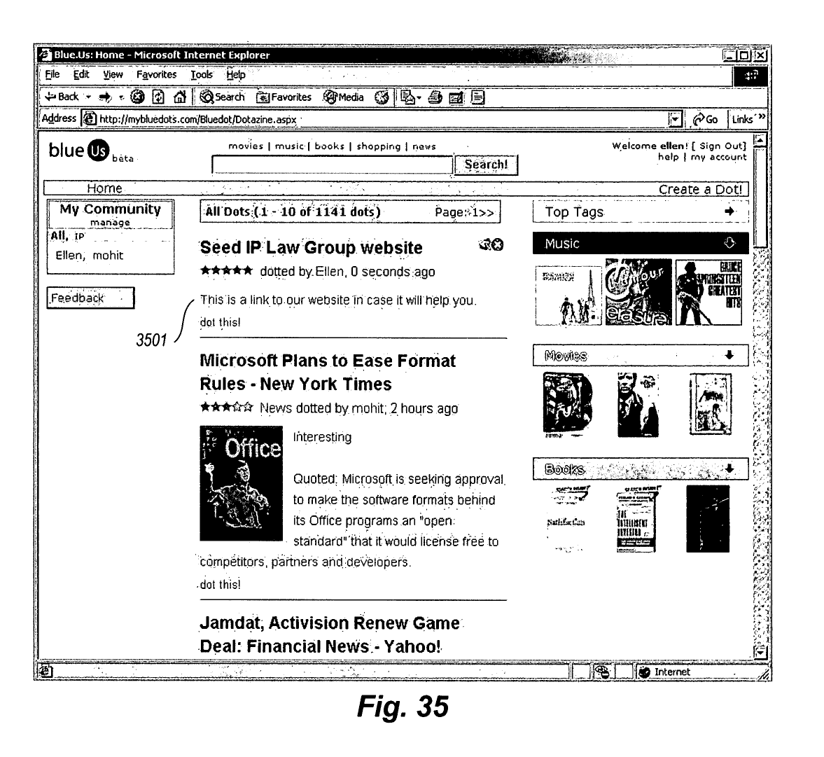

FIG. 32 is an example screen display of an authoring dialog where minimal information has been automatically filled by the system. In other embodiments, as described in more detail below, the SDS may provide assistance to the user, by pre-filling one or more input controls based on intelligent analysis of a target web page or other information item. FIGS. 33-35 show the process of authoring a dot with user-supplied data. FIG. 33 is an example screen display showing a target web page to use as source content for dot creation. Specifically, FIG. 33 shows a website that a user has navigated to and that the user wishes to dot. FIG. 34 is an example screen display of an example dot authoring dialog. This dialog is presented in response to the user selecting the “Dot This!” link. In this example the user has entered all of the information in the dialog. FIG. 35 is an example screen display showing the result of authoring a dot. When the user navigates back to the homepage (website), the newly created dot appears as dot presentation 3501.

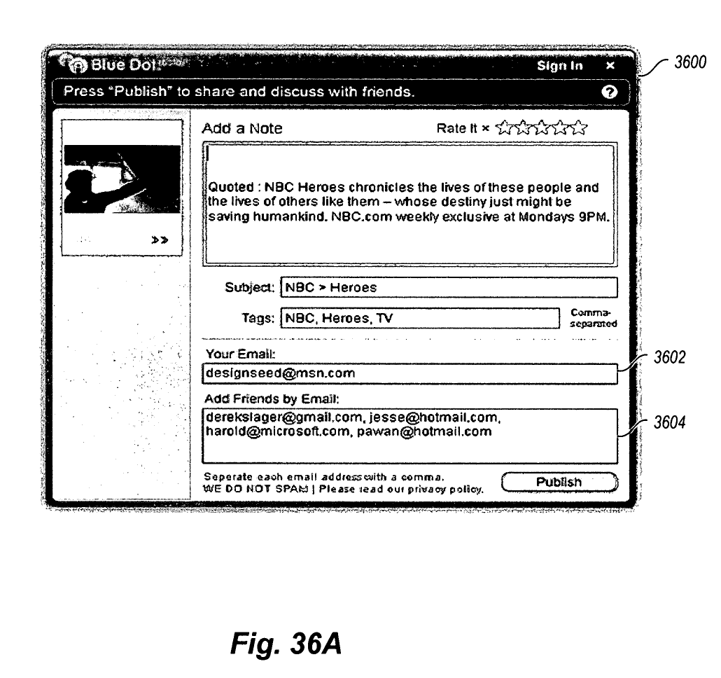

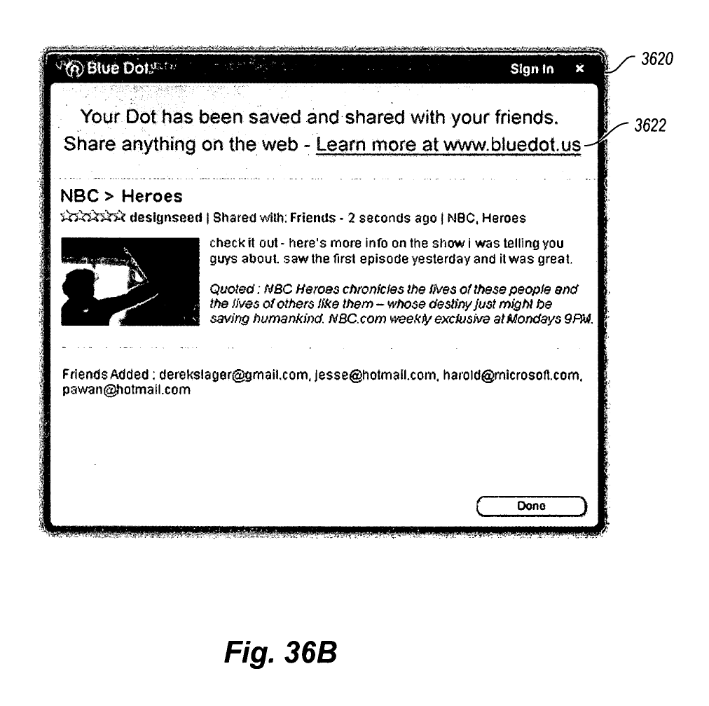

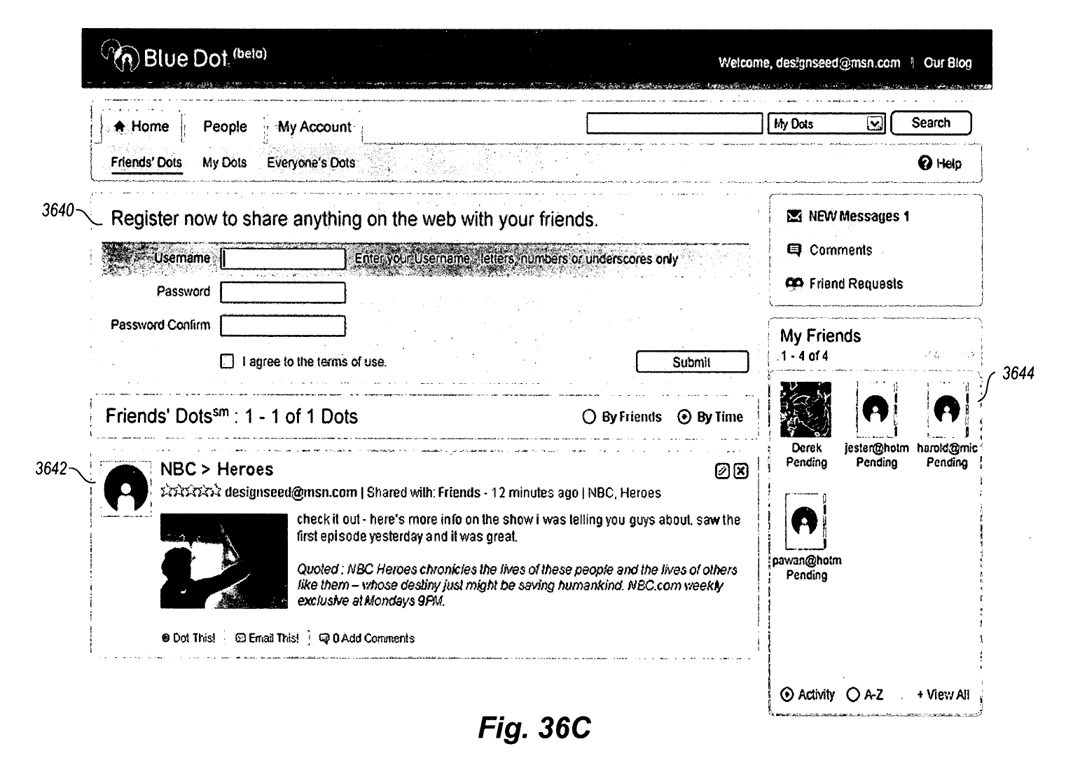

As noted, in some embodiments, anonymous users may be allowed to utilize the SDS in various ways. FIGS. 36A-36C show example screen displays of authoring dialogs and dot presentations that may be provided to anonymous users. FIGS. 36A-36C show a running example of dot creation and subsequent confirmation and dot presentation provided by an example SDS to anonymous users. The illustrated figures demonstrate how many of the features of the SDS may be provided to anonymous users without the users first engaging in any registration and/or installation steps.

FIG. 36A is an example screen display of an authoring dialog that may be utilized by an anonymous user. FIG. 36A shows an authoring dialog 3600 that is similar to the authoring dialog described with reference to FIG. 34. The authoring dialog 3600 includes an author email input control 3602 and a friend email input control 3604. The authoring dialog 3600 may be presented to the user in various ways. In some embodiments, a third-party web site may have included one or more links (e.g., URLs) that allow visitors to that web site indicate interest in a particular page on the web site by authoring a dot for that page. In this way, even users that have not engaged in the invitation, registration, and installation process described with reference to FIG. 7 can be provided with the opportunity to author dots and contribute social knowledge. During authoring, such users may identify themselves by providing an email address via the email input control 3602. In addition, the user may provide one or more email addresses of friends via the friend email input control 3604 with whom the user wishes to share the newly created dot. The provided email addresses may then be sent a message by the SDS that includes information about the newly created dot and/or a link or other reference that the recipients may use to access the SDS and obtain information about the dot and/or register to become new users.

FIG. 36B is an example screen display of an authoring confirmation message that may be provided to an anonymous user. After completing and submitting the authoring dialog 3600 described with reference to FIG. 36A, the SDS may present the user with an authoring confirmation message 3620 that includes a link 3622 that the user can use to visit the SDS. In other embodiments, the user may be provided with such a confirmation message in other ways, such as via an email message.

FIG. 36C is an example screen display of a dot presentation that may be provided to an anonymous user. The illustrated screen display includes a registration control 3640, a dot presentation 3642, and a friend browser control 3644. The illustrated screen display may be provided by the SDS in response to an anonymous user clicking the link 3622 described with reference to FIG. 36B, or alternatively in response to an anonymous user clicking a link provided via an email such as one sent by the SDS in response to the authoring of the dot described in FIG. 36A. The registration control 3640 may be utilized by the user if the user desires to create an account with the SDS. The dot presentation 3642 shows the dot created as described with reference to FIG. 36A. The friend browser control 3644 shows the email addresses of the friends specified via the friend email input control 3604 described with reference to FIG. 36A. Note that the friends are all listed as “Pending” because they have not yet elected to register with the SDS.

The features and techniques described with reference to FIG. 36A-36C are equally applicable in the context of non-anonymous users. For example, the combination of authoring and new user invitation described with reference to FIG. 36A may also be provided to registered users in order to streamline and/or encourage the process of inviting new users to the SDS.

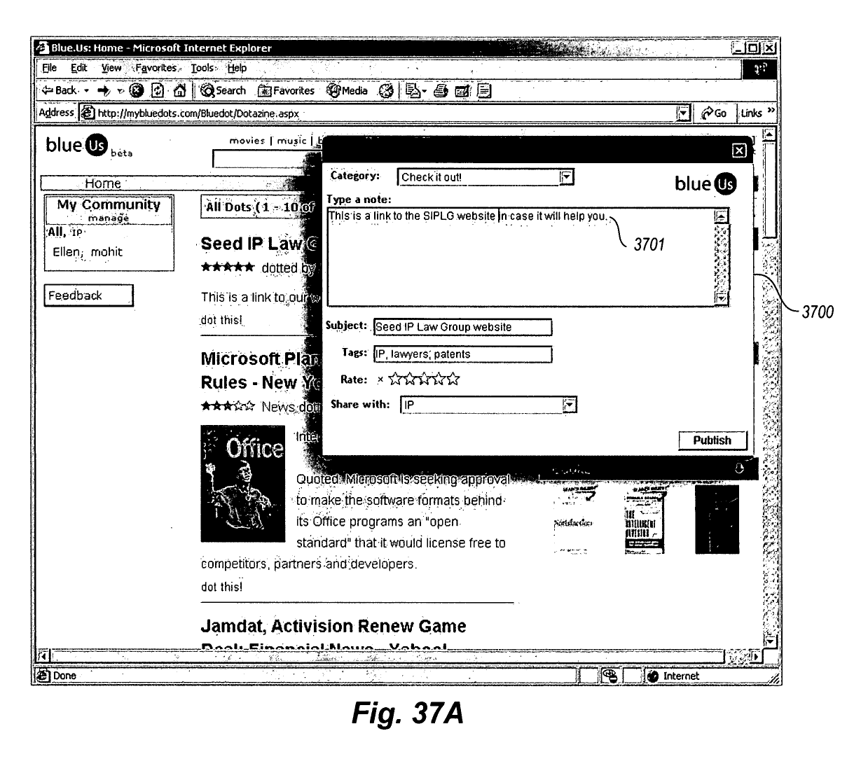

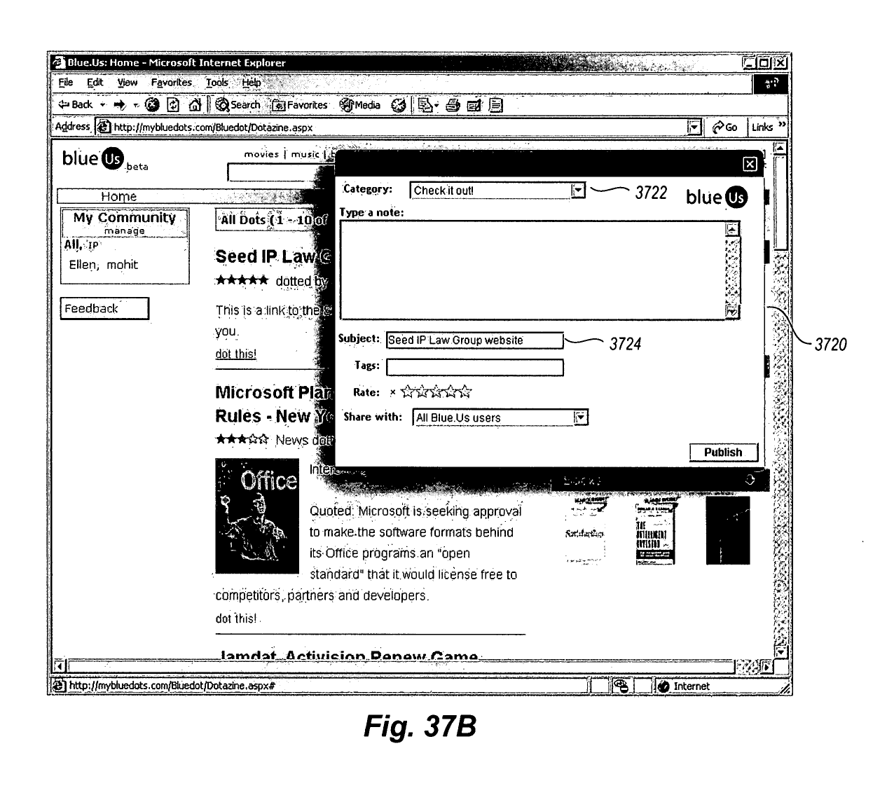

As mentioned, in some embodiments, once a dot is created, the user, and possibly other users, can use an edit widget (e.g., an authoring and/or editing dialog) to edit the dot. FIGS. 37A-37B show example screen displays of editing widgets to that may be used by users to edit existing dots.

FIG. 37A is an example screen display showing a user in the process of editing the publisher comment regarding a dot. Specifically, FIG. 37A shows an authoring dialog 3700 being used by the user to edit a publisher comment 3701 associated with the dot. Note that the authoring dialog is displayed within the context of the underlying application (e.g., a web browser). Authoring dialogs for newly created dots may of course be displayed in a similar manner.

Also, in some embodiments, any dot which a user has permission to view can be authored (again) by the user. For example, a dot created by a user's buddy can in some embodiments be authored by the user and shared to enable the user to add additional commentary thereby contributing to the social relevance of the dot.

FIG. 37B is an example screen display of an example pre-filled author dialog displayed when a user attempts to dot an already existing dot. Specifically, FIG. 37B shows a pre-filled authoring dialog 3720. Note that even though the first time this dot was authored the SDS could not pre-fill any fields, now it is able to pre-fill many of them, such as category 3722 and subject 3724.

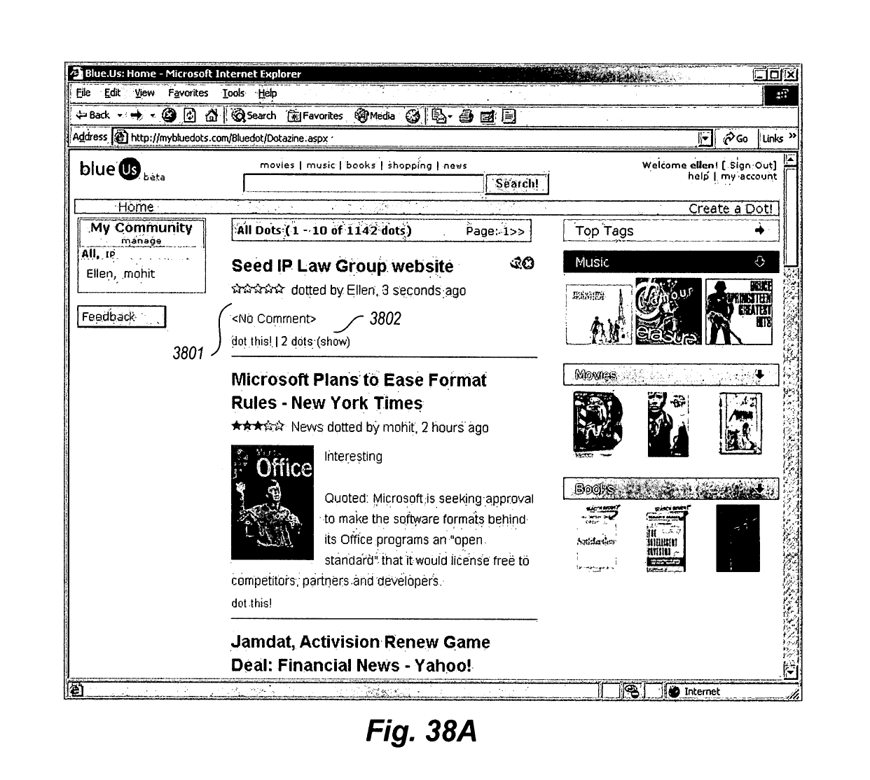

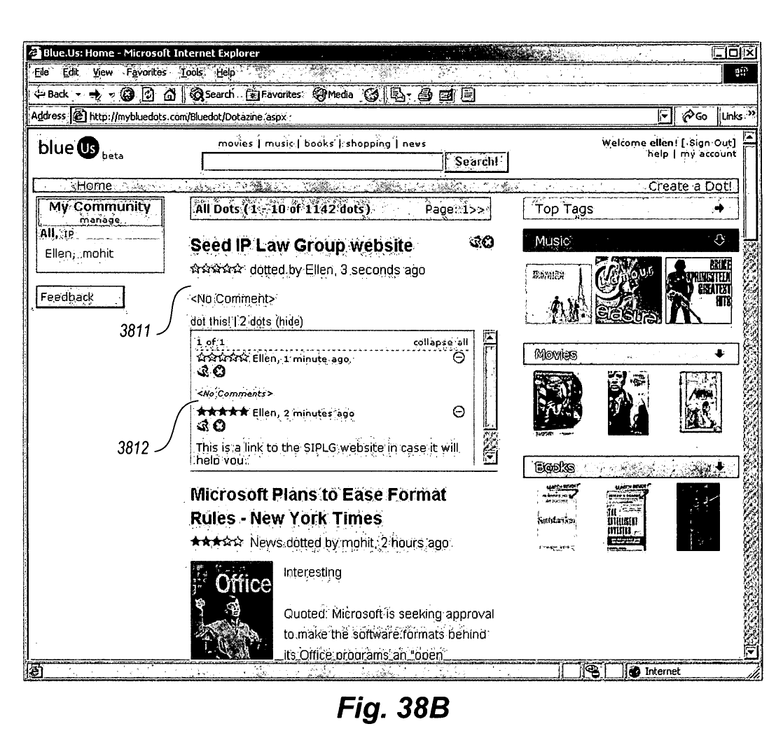

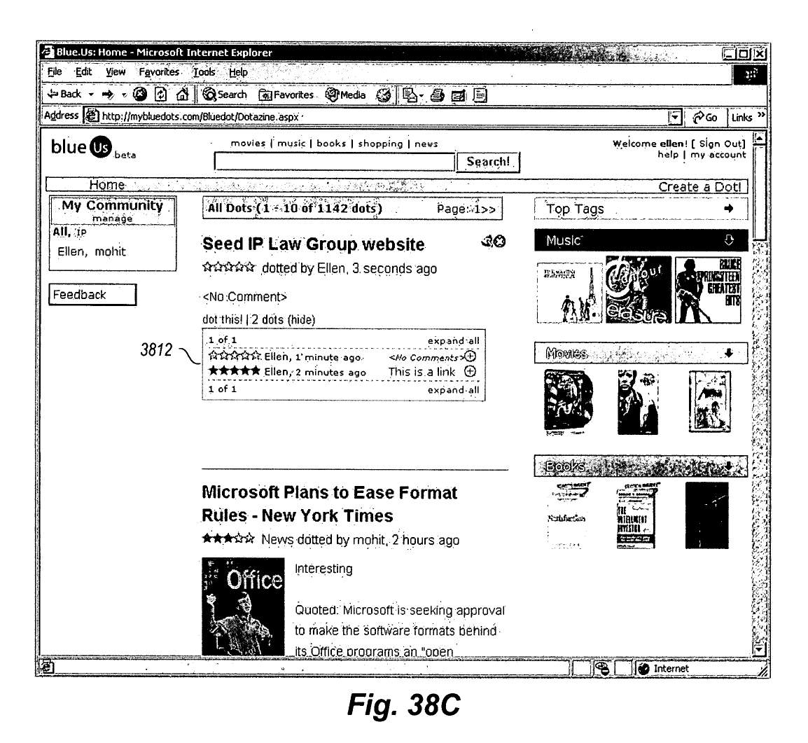

Once a second dot relating to the same underlying data is created (e.g., two dots corresponding to the same URL), in one example SDS, the dot presentation is modified to include all the related dots in one location. FIGS. 38A-38C show example screen displays illustrating various presentations of related dots. FIG. 38A is an example screen display of a dot presentation modified to cluster related dots. Dot presentation 3801 is modified to indicate that there are actually two dots relating to this same source. By selecting the show link 3802, the user can display all of the dot information that relates to the underlying data. FIG. 38B is an example screen display of dot clustering. Dot presentation 3811 is modified to present cluster information 3812 relating to all of the clustered dots. The cluster information 3812 can be expanded or collapsed as desired. FIG. 38C is an example screen display of the cluster information 3812 collapsed, but still showing summary information related to the dots, such as author and time of creation.

The authoring capabilities of the example SDS are quite extensive. The SDS attempts to add intelligence to dots as it can when they are created and for presenting a most relevant view to a user, based upon aspects of the user's community. For example, the user as a community of one yields a social taxonomy that can be utilized by the SDS to assist the user to find information acting as an expert search “agent.” And, the user as part of a larger community yields a social taxonomy that is used by the SDS to determine relevance and other attributes relative to that user as the user relates to the designated community. The SDS can also adapt its analyses to third party information such as external databases both in terms of authoring and presenting dot information to the user.

In addition, some embodiments may provide other functionality as part of the authoring process. For example, one embodiment may provide user interface controls as part of a dot authoring user interface that allow a user to specify one or more email addresses of persons who may not be members of the Social Discovery System, with whom the newly created dot is to be shared. When such a dot is created, email messages will be sent to the specified email addresses. The sent email messages will include a reference (e.g. URL) to the newly created dot, as well as possibly an invitation to join the Social Discovery System. In this way, new users may be motivated to join the Social Discovery System, both because of the useful information provided by the dot and the knowledge that users they are acquainted with are already members of the system.

As noted above, some embodiments may provide functionality with which users may add comments to existing dots. FIGS. 39A-39C show example screen displays that provide functionality for adding and/or displaying comments related to existing dots. By adding comments to dots, users may start or hold conversations about information related to the dots. For example, a first user may create a dot about a feature film that they have recently seen, and possibly provide a publisher's comment about their interpretation of some aspect of the film. Later, other users of the Social Discovery System may respond to the first user's comment, or add their own interpretation or analysis of the film, by adding their own comments to the dot.

FIG. 39A is an example screen display showing user interface controls that provide functionality for adding a comment to an existing dot. In particular, FIG. 39A includes a first dot presentation 3901 and a second dot presentation 3903. The first dot presentation 3901 includes a comment control 3902 that indicates that the dot reflected in the dot presentation 3901 currently has one associated comment. The comment control 3902 may be selected by the user to obtain more information about the comment, add additional comments, and/or modify existing comments.

The second dot presentation 3903 includes a comment presentation area 3904 and a comment creation control 3908. Either or both of these user interface elements may be displayed in response to user selection of a comment control, such as comment control 3902. The comment presentation area 3904 includes a first comment presentation 3905 and a second comment presentation 3906, illustrating details related to each of the two already existing comments that have been added to the illustrated dot, such as an indication of the identity of the user that added the comment, the text of the comment, and information related to the age of the comment (e.g., how long ago or the date/time the comment was added). The second dot presentation 3903 further includes a comment authoring control 3908 that provides functionality for adding a new comment to the illustrated dot.

In addition, in some embodiments, users may be able to modify (e.g., edit and/or delete) existing comments. For example, in the illustrated embodiment, a user may later modify a comment added by that user, but not by other users. In the illustrated example, the user currently viewing the screen display is the same user that added the comment reflected in the second comment presentation 3906. As such, a comment modification control 3907 is displayed associated with the second comment presentation 3906 so that the current user may edit and/or delete the underlying comment. Furthermore, because the current user did not add the comment reflected in the first comment presentation 3905, no comment modification control is displayed in association with that comment presentation.

FIG. 39B is an example screen display showing user interface controls for displaying comments that have been added to dots that have been authored by a current user. In particular, in the illustrated screen display, the dot presentation area 3925 has been filtered to present comments on the user's dots. The dot presentation area 3925 includes a dot comment display control 3920 for displaying dots authored by the current user having associated comments. The dot comment display control 3920 includes a filter control 3921 that allows the current user to filter the display of dots based on when comments have been added to the dots. For example, the user may select, by way of the filter control 3921, to view dots having comments that have been added since the last visit of the current user, within the last hour, during the last day, during the last week, or during the last month. Other time frames may be incorporated as well as other criteria for filtering the comments. In the illustrated example, the user has selected to view only dots having comments that have been added since the last time the user visited the website provided by the example Social Discovery System. In this case, the dot comment display control 3920 is showing a single dot presentation 3922 that has a single associated comment presentation 3923, reflecting a comment that was added 50 minutes ago.

FIG. 39C is another example screen display showing user interface controls for displaying comments. The illustrated screen display differs from that of FIG. 39B in that the illustrated screen display shows comments that have been added to dots that have been authored by friends of the current user, rather than the current user himself. In particular, the illustrated screen display only displays comments that have been added to dots that have been authored by friends of the current user, and to which the current user has added at least one comment. In this manner, the illustrated screen display provides a convenient mechanism by which the current user may browse or otherwise view comments related to friends' dots about which the current user has expressed some interest by adding his own comments. The illustrated screen display includes a dot comment display control 3940 and filter control 3941 similar to the dot comment display control 3920 and filter control 3921, respectively, of FIG. 39B. In the illustrated example, the user has selected to view only dots having comments that have been added since the last time current the user visited the example website. In response, the dot comment display control 3940 shows a single dot presentation 3942 having a total of two comments. The dot presentation 3942, however, displays only a single comment presentation 3943, reflecting that only one of these comments was added during the relevant time frame selected by the user via the filter control 3941 (i.e., since the current user's last visit).

Other embodiments may provide alternative and/or additional functionality to assist users in adding, managing, tracking, viewing, and/or modifying comments to dots. For example, one embodiment may provide various types of search controls that allow a user to search for dots having comments matching specified search criteria (e.g., to search for all dots and/or comments created during specified time periods, having been authored by particular users, having particular tags and/or textual content, etc.) Other embodiments may provide mechanisms to handle comments provided by particular users in specified ways, such as to block or otherwise hide comments from users that tend to provide offensive or otherwise non-constructive commentary, to order the presentation from users based on information about those users such as relationship (e.g., to present comments provided by all or specified friends prior to comments provided by other users), characteristics (e.g., age or gender), etc. In addition, in some embodiments, users may be restricted in their ability to add comments in various ways. For example, a given user may only be able to add comments to dots authored by the user or by friends of the user. Alternatively, users that author dots may be able to specify particular users or groups of users that should be allowed to add comments to their dots. In this manner, the capabilities of other users to leave unsolicited and/or otherwise non-constructive comments may be restricted, so as to increase the value of comments to users of the Social Discovery System.

As noted above, some embodiments may provide functionality with which users may send messages to other users. FIGS. 40A-40C show example screen displays that provide functionality for sending and viewing messages sent within an example Social Discovery System. In particular, FIGS. 40A-40C demonstrate a running example of a first user, “TestUser,” sending a message to a second user, “bend,” followed by the second user viewing the message sent by the first user.

FIG. 40A is an example screen display showing user interface controls for creating and sending new messages. The illustrated screen display includes a messaging control 4001 which provides controls for invoking various functionality related to managing messages, such as message creation, message reading, message deletion, etc. The illustrated screen display also includes a message creation control 4002 with which a user can create a message to be sent to a user specified via a user selection control 4003. The user selection control 4003 in the illustrated example is a drop down menu that includes a list of friends of the current user. In other embodiments, it may include only friends with which the current user has previously or recently corresponded, or some other possibly dynamically determined list of users. The message creation control 4002 also includes a subject input control 4004 and a message text input control 4005 that may be utilized by the current user to compose the body of a new message.

FIG. 40B is an example screen display showing user interface controls for obtaining information about received messages. In this example, the current user (“bend”) obtains information about the message composed and sent by user “TestUser” via the example interface described with reference to FIG. 40A, above. The illustrated screen display includes a messaging control 4011 similar to the messaging control 4001 described with reference to FIG. 40A. In some embodiments, received messages may be segregated or otherwise ordered, sorted, or processed based on the identity of the sending user and/or other factors (e.g., time of message receipt, message contents, rules specified by the current user, etc.). In the illustrated embodiment, for example, received messages are segregated based on whether they have been sent by friends of the current user or not. In this manner, knowledge about the social network (e.g., friends that have been identified by the user, friends of such friends, etc.) of the current user may be exploited to reduce the incidence and/or impact of “spam,” or unsolicited messages sent by users that are not known to, or identified by, the current user as likely to send interesting messages. Such message segregation is illustrated by way of separate controls 4012 and 4013 for accessing messages sent by users that are friends and those that are not friends, respectively. By selecting the control 4012, the current user is provided with message inbox control 4014 that includes a first message control 4015 and a second message control 4016, which each provide summary information about a received message (e.g., message subject and receipt time). In addition, the current user may select these controls 4015 and 4016 to obtain additional information about the received messages.

FIG. 40C is an example screen display showing user interface controls for obtaining detailed information about a received message. In this example, the current user (“bend”) has selected control 4016 of FIG. 40B to obtained detailed information about a message received from user “TestUser.” In response, the current user is presented with the illustrated screen display which includes a messaging control 4021 similar to the messaging control 4011 described with reference to FIG. 40B, as well as a message detail control 4022. The message detail control 4022 displays detailed information about the message (e.g., sender, time sent, subject, message body, etc.), as well as provides additional controls for responding to, deleting, saving, or performing other operations on or with the received message. Other example embodiments may provide additional or different capabilities and/or interfaces for processing and managing messages.

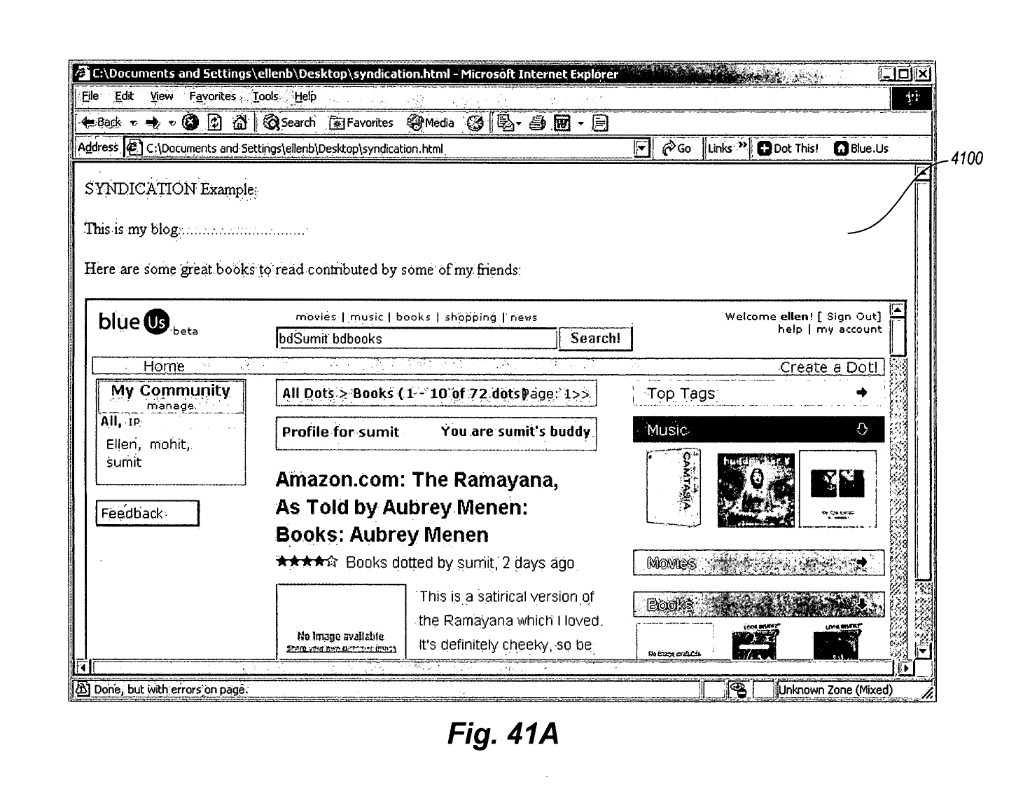

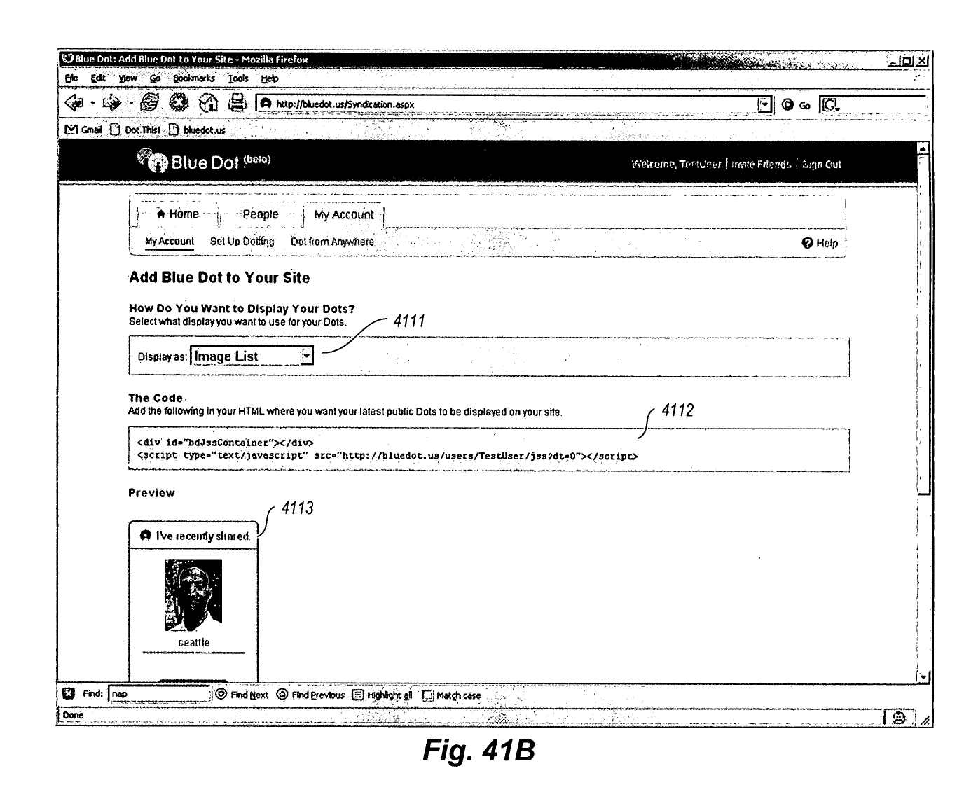

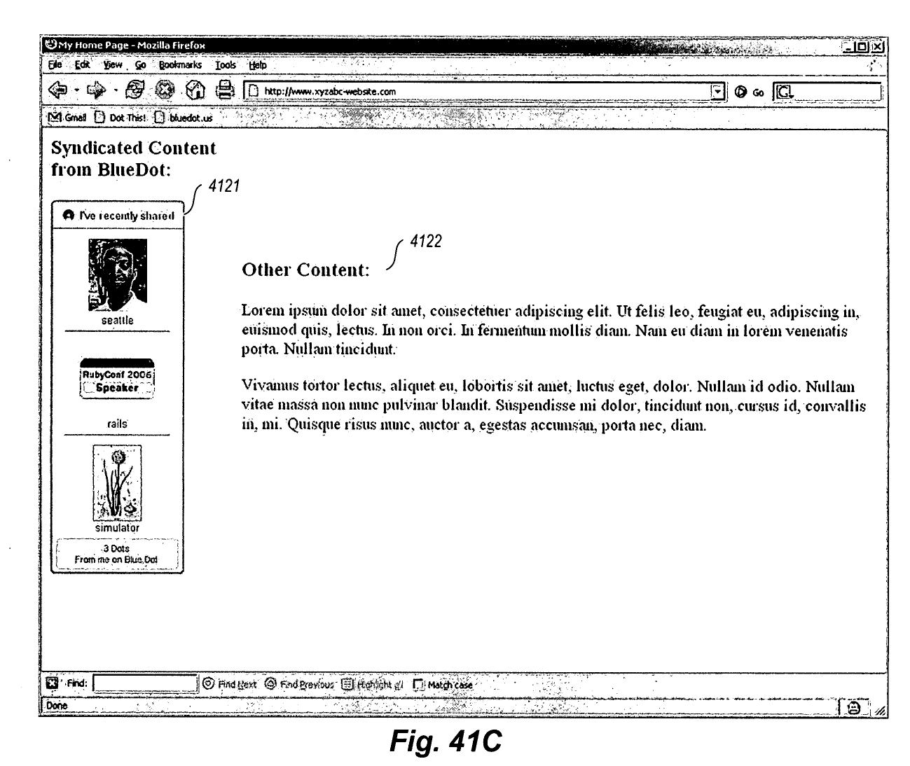

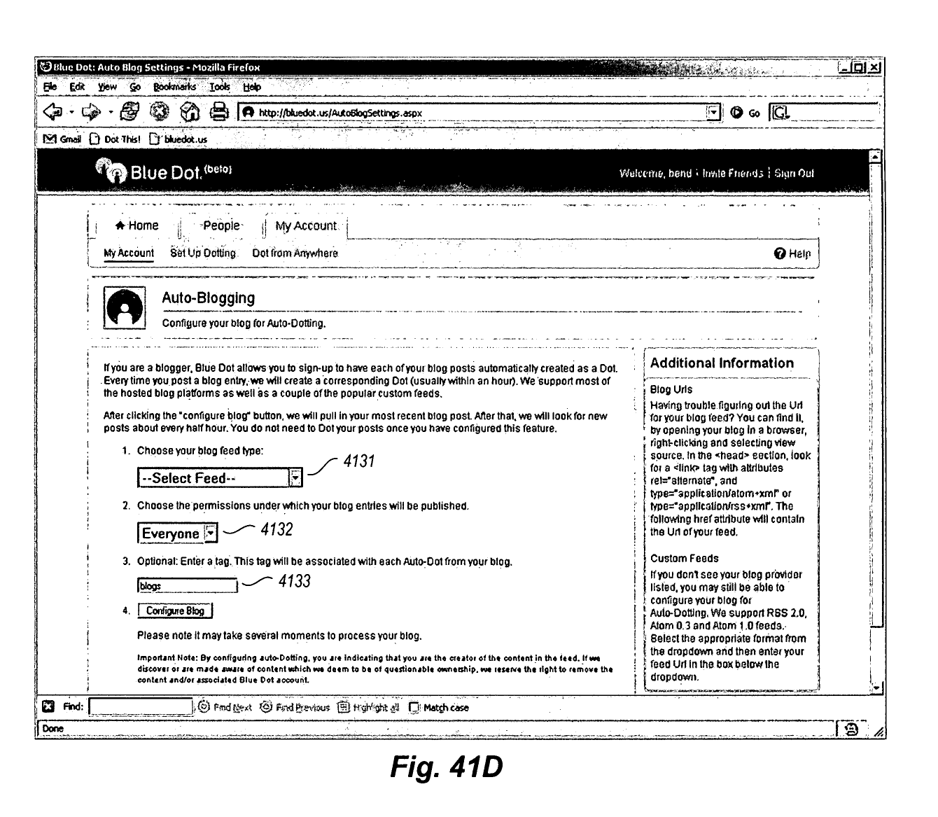

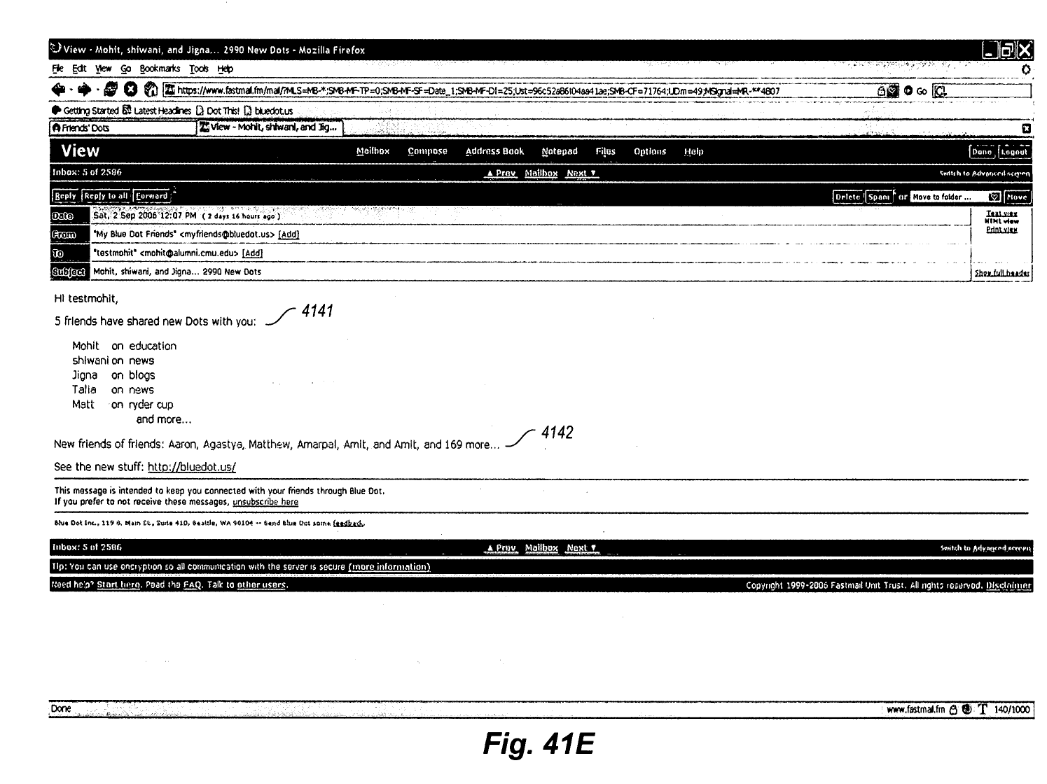

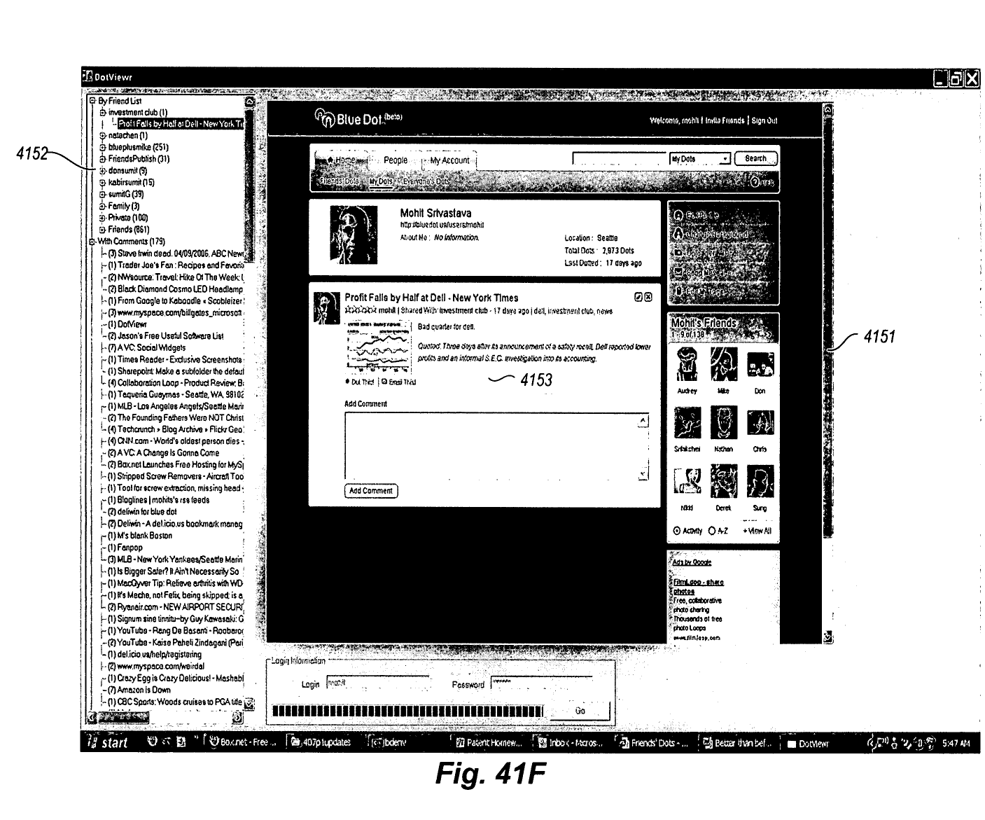

As previously noted, some embodiments provide various mechanisms to “import” (e.g., obtain information for the purposes of dot generation) and/or “export” (e.g., provide information, notifications, updates to other users and/or systems) information to and from the Social Discovery System. FIGS. 41A-41E illustrate various examples of information import and export functionality provided by embodiments of the Social Discovery System.

In one aspect of the SDS, a user can syndicate the user's dots or any portion of the SDS environment. This allows third parties to access information from the SDS without necessarily even knowing where the information comes from. Moreover, based upon the permissions for the information, although the same dot information may be syndicated, it may be displayed differently (or in part or not at all) for different users. Syndication can be used simply to customize a website. For example, a user may wish to customize the default home page for the user's web browser to show the most recent music dotted by members of his “key” friends. SDS dot information can be syndicated by inserting a properly formatted link into the target application. FIG. 41A is an example screen display of syndicated dot information displayed in a user's blog.

Example HTML (“Hypertext Markup Language”) code inserted into the user's blog to achieve the syndication shown in FIG. 41A is as follows:

<HTML>
<BODY>
<p>SYNDICATION Example:

| | |
|---|---|
| <p> | This is my blog |
| <p> | Here are some great books to read |
| | contributed by some of my friends: |

<p>
<IFRAME SRC=“http://abc.us/dots.aspx?searchBar = bdSumit bdbooks”
width = 800 height = 400/>
<BODY>
</HTML>

In this example, the initial code is rendered by the browser as shown in screen display 4100. Other code, other instructions using potentially even different language instructions can similarly be incorporated. In addition, different levels of complexity can be supported, different widgets syndicated, etc.

FIG. 41B is an example screen display that provides a user with various mechanisms for configuring a dot syndication widget, as well as instructions for installing or otherwise operating that widget within another application or system. Other applications or systems may include applications and/or systems that are distinct from, separate from, or independent of the Social Discovery System. The illustrated screen display includes a syndication configuration control 4111, a generated syndication code segment 4112, and a syndication preview 4113. The current user may initially choose, by way of the syndication configuration control 4111, one of several template configurations for presenting syndicated dots on the user's site. In response to a selection of the syndication configuration control 4111, the generated syndication code segment 4112 is automatically updated to reflect the code that the user should add to the web page or other information source, and the syndication preview 4113 is automatically updated to provide the user with a preview of how the syndicated dots will appear on the website.

In the illustrated example, the user has selected a configuration that displays syndicated dots as a list of images, which is reflected in the syndication code segment 4112 and the syndication preview 4113, respectively. In the illustrated embodiment, a fixed number of dots (e.g. three dots) are automatically selected to be displayed, based at least in part on characteristics of the dots, such as the time of authoring (e.g., more recently created dots may be selected preferentially to older dots), whether the dots include images, etc. Other SDS “intelligence” may be used to determine the selection of dots that are syndicated. In addition, the syndication preview 4113 displays at least one tag for each dot, to provide users with an indication of the topic or subject of the dot. Again, the tags are selected automatically by the SDS, based at least in part on characteristics of the tags, such as tag length, tag popularity (e.g., how many other dots in the SDS utilize a given tag), etc. Various embodiments may provide the user with additional or alternative capabilities for configuring the style and content of syndicated information, such as providing mechanisms for selecting from various display themes (e.g., bulleted lists, tables, etc.), for specifying the amount and type of dot information to display (e.g., subject, image, number of dots shared, etc.), and for selecting from and/or configuring various implementation mechanisms (e.g., HTML, JavaScript, Flash, Java Applets, etc.) that provide different levels of interactivity and/or functionality within the provided syndication widget.

FIG. 41C is an example screen display of syndicated dot information displayed on a web page hosted by a website. Similar to FIG. 41A, the website is distinct from a website provided by an embodiment of the Social Discovery System. In particular, the illustrated screen display includes a dot syndication widget 4121, such as one configured with reference to FIG. 41B, as well as some additional content 4122. The dot syndication widget 4121 displays information and controls related to three dots recently authored by the author and/or operator of the illustrated web page. Users visiting the illustrated web page may select (e.g. by clicking) any of the displayed dots to obtain more information related to the dot. In some embodiments, the information related to a selected dot may be displayed within the context of the Social Discovery System (e.g., by displaying a web page provided by the Social Discovery System that presents the dot). The dot syndication widget 4121 is dynamic, that is, the dots it displays are updated dynamically (e.g., at some time period or interval) as new dots are added to the Social Discovery System. In some embodiments, dot syndication widgets are not tied to dots authored by particular users, but rather may include information related to dots authored by any users of the Social Discovery System, so as to notify users of recently added, popular, controversial, and/or active dots. In some embodiments, dot syndication widgets may perform other functions besides providing dot information to other users, such as displaying advertising and/or providing a gateway for potential new users to sign up and become members of the Social Discovery System. Dot syndication widgets may also provide statistics (e.g., a number of times that they have been viewed or otherwise accessed) or other information about their use to the Social Discovery System.

As another example, syndication can be used to provide “smart” content to a third party application. For example, suppose a newspaper is trying to attract new members from a college community. The newspaper third party site can tap into current discussions surrounding featured articles by performing searches in the background that relate to that community and presenting the comments from similarly situated students. Of course, the permissions of the items that are syndicated need to be sufficiently broad to allow presentation of the information. And, depending upon who is viewing the newspaper's site, the information displayed may be different. For example, if a current member of the SDS is browsing the newspaper, then special information might be displayed, whereas when a non member is browsing, only public dot information is displayed. In addition, the newspaper might filter on ranking information to present information it believes relevant to its college community. Many variations are possible.

Various embodiments may provide additional mechanisms for exporting information related to the Social Discovery System. For example, some embodiments may allow other information aggregators (e.g., search engines, news readers, etc.) to access the Social Discovery System in various ways to obtain information related to users, dots, or other aspects of the system. For instance, spiders, robots, or other automated systems may be allowed to traverse all dots of the Social Discovery System to index them for search purposes. In this manner, users may be provided access to information within the Social Discovery System via third-party information processing tools and/or systems (e.g., by typing keywords into a search control provided by a third-party search engine).

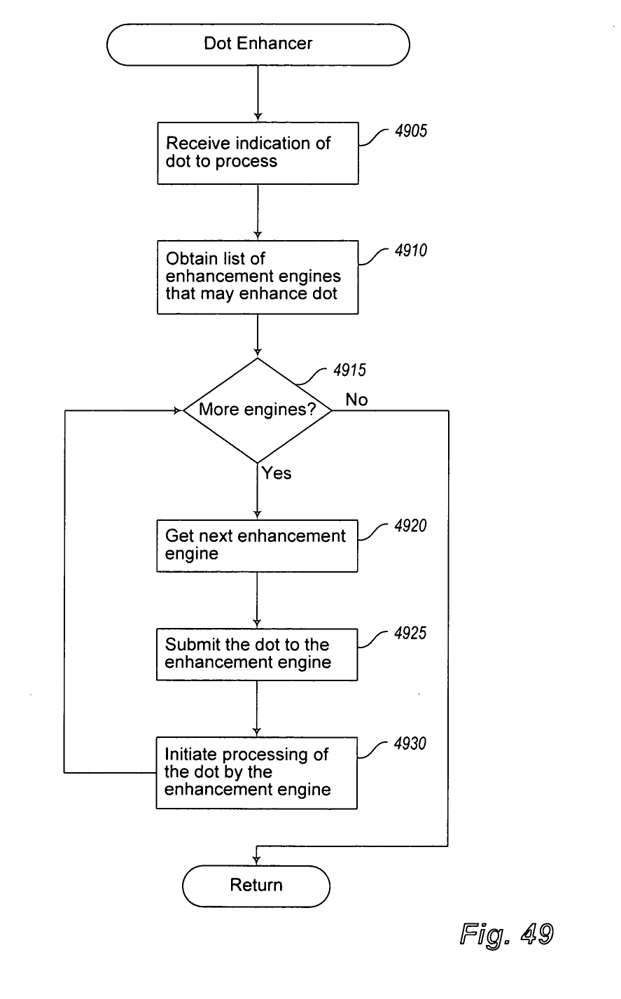

FIG. 41D is an example screen display that provides controls for configuring a mechanism for importing information into an example Social Discovery System. In particular, FIG. 41D provides a user with controls to configure an information import mechanism which automatically creates dots based on blog entries hosted on a distinct website and created by a user of the Social Discovery System, or possibly some other person. By configuring this mechanism, the Social Discovery System will automatically “pull” newly-created blog entries into the Social Discovery System by creating dots that correspond to those blog entries. Note that blog entries may include other source data that is presented in a format or fed by a mechanism that allows it to be shared. The illustrated screen display includes a feed configuration control 4131, a publication permissions control 4132, and a tag specification control 4133. The feed configuration control 4131 may be used by the user to specify one of multiple syndication and/or content feed standards, such as a Blogger feed, LiveJournal feed, MySpace feed, WordPress feed, Atom feed, or RSS (“Really Simple Syndication”) feed. Depending on the feed selection, additional information (e.g., a username, a URL, etc.) may be requested to further configure the information import mechanism. The publication permissions control 4132 may be used to specify which users (e.g., only the current user, only friends of the current user, everyone, specific groups of users, etc.) will be able to view and/or modify dots created by the SDS import mechanism. The tag specification control 4133 may optionally be utilized to specify one or more tags that are to be associated with dots created by the import mechanism. When dots are created by the import mechanism, the Social Discovery System may in some embodiments enhance the dots by automatically determining and/or selecting additional information (e.g., subject lines, tags, images, etc.) to associate with each dot. Automatic dot enhancement is described further with reference to FIGS. 49-51C. Although FIG. 41D describes an import mechanism with respect to blogs, other embodiments may provide additional import mechanisms configured to import information from various kinds of information sources. For example, import mechanisms may be configured to import information from any information source that provides a standardized protocol (e.g., an API, Web Service, etc.) for retrieving information. In addition, some import mechanisms may even be configured to import information from information sources that do not provide such standardized protocols by, for example, heuristically analyzing content provided by such information sources (e.g., by scraping, harvesting, filtering, or otherwise intelligently processing) to determine which portions of the content to import as newly-created dots.

FIG. 41E is an example screen display showing an example email sent by an example Social Discovery System to notify of a user of recent events and/or occurrences within the Social Discovery System. In some embodiments, the Social Discovery System may periodically send a message such as an electronic mail message to a user informing them of recent events within the Social Discovery System. The illustrated screen display shows an email that includes information related to new dots 4141 that have been shared with the recipient, as well as information 4142 related to new friends of friends of the recipient. Other embodiments may also include other information, such as recent comments added to the user's dots, indications of messages recently sent within the SDS to the user, etc. Various embodiments may send such notifications to users at various times, such as on a periodic basis (e.g., every day), based on information volume (e.g., when a predetermined threshold number of new dots have been created), based on lack of activity (e.g., if a user has not logged in within a predetermined time period), etc. In some cases, triggers for sending such notifications may be specified by the user. In addition, different amounts (e.g., a maximum number of new dots) and kinds of information (e.g., related to dots, comments associated with dots, friends, etc.) may be sent, possibly as specified by the user. Other embodiments may utilize other notification mechanisms instead of or in addition to electronic mail, such as text messages (e.g., Short Message Service), chat, etc.

In some embodiments, a user may create a “subscription” that includes one or more indications of dots the user wishes to be notified about by the SDS. For example, a user may specify that they wish to be notified about newly created dots having a particular tag, authoring user, and/or category. In some embodiments, subscriptions may be created via a user interface that provides search-like controls, that allow the user to provide multiple criteria (e.g., user, group, tag, date or time of creation ranges, category, etc.) that may be combined with various logical operators (e.g., AND, OR, NOT, etc.) and saved in association with a subscription. The SDS may then automatically match dots against the provided criteria, in order to determine a collection of dots about which to notify the user. As discussed elsewhere, the notifications may be provided in various ways, such as via emails, web pages, etc. Furthermore, in some embodiments, subscriptions may be automatically generated by the SDS, based on activities and actions of users. For example, the SDS may learn that a given user is interested in dots related to feature films, by analyzing the user's browsing patterns and/or search queries, and in response, automatically generate and suggest or recommend a subscription for such dots to the user.

In addition, in some embodiments, a user may create one or more “profiles” that may be used to share information about themselves, such as recently created dots. In some embodiments, each profile may be associated with a particular tag or category, such that the profile reflects the user's current activity (e.g., dots having the associated tag that are newly created by the user). In other embodiments, each profile may be associated with arbitrary search criteria, such that the user that created the profile can exert fine-grained control over the content provided as part of the profile. For example, a user may create a “Favorite New Horror Movies” profile, that reflects dots that the user has created or updated within the last 30 days, that have been assigned to a movie or entertainment category, that have been associated with the tag “horror”, and that have been given a rating of at least three out of five stars by the user.

In addition, some embodiments may provide one or more APIs that provide mechanisms for retrieving or displaying information from, and/or adding information to the Social Discovery System. Third-party developers can then implement applications that provide users with alternative interfaces to the Social Discovery System. FIG. 41F is an example screen display of an example application that utilizes such a Social Discovery System API. The illustrated screen display includes a browse pane 4151 that provides information and controls related to navigating the Social Discovery System. The browse pane 4151 includes a dot presentation area 4153 for displaying information related to dots. The illustrated screen display also includes a tree-based navigation control 4152 that a user may utilize to navigate and/or filter the presentation of dots within the Social Discovery System based on various criteria (e.g., based on dot author, whether the dots have associated comments, etc.). When the user selects one or more criteria displayed by the tree-based navigation control 4152, the dot presentation area 4153 is updated automatically to display any dots matching the selected criteria.

In some embodiments, functionality may be provided to integrate social knowledge provided by the SDS with other applications, either by a provided an API or by other mechanisms (e.g., a software development kit). Such functionality may be leveraged in order to create “overlays” or enhancements of social knowledge over or on other data displays. For example, customized web browser applications may be created that automatically overlay (e.g., via a pop up window, a window pane, a message widget, etc.) social knowledge that is relevant to the current context of the web browser. For instance, if the user of the web browser is currently visiting a product page for a particular brand and model of shoe, the user may be informed (e.g., via a message widget) that one or more of their friends in the SDS have recently created dots that reference the particular brand and/or model of shoe.

The techniques described herein can be employed in many contexts. Example applications include, but are not limited to, dating or match-making systems or sites, social networking systems or sites, organizational directory applications, calendaring applications (e.g., by providing social knowledge such as reviews related to events scheduled in a calendar), rolodex or address-book applications (e.g., by providing access to social knowledge associated with entries in an address book), email applications (e.g., by providing access to social knowledge associated with recipients or contents of emails), educational software, and/or various kinds of generalized list management applications (e.g., mailing lists, subscriber lists, class lists, wedding invitation lists, etc.).

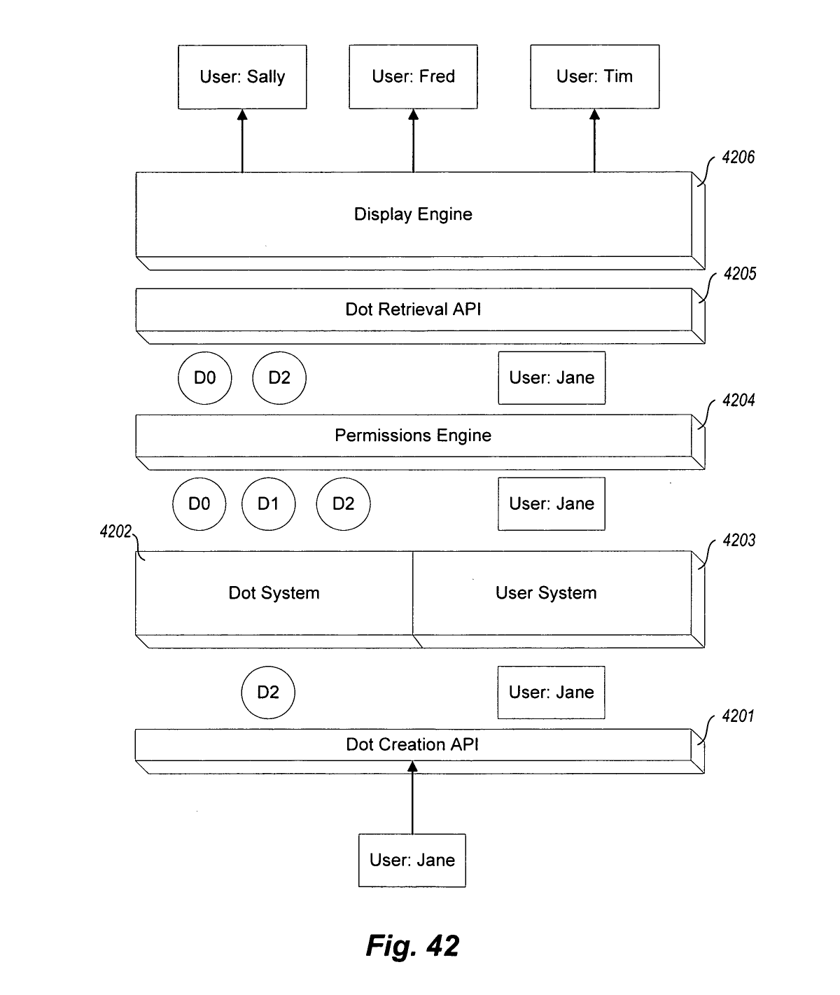

FIG. 42 is an example block diagram of example components of an example Social Discovery System implemented to provide at least some of the user interfaces described with reference to FIGS. 1-41. The components shown can be modified and different components can be added to achieve the aspects described herein. The illustrated example components include a dot creation API component 4201, a dot system component 4202, a dot user system component 4203, a permissions engine component 4204, a dot retrieval API component 4205, and a display engine component 4206. The dot creation API component 4201 provides access to functionality related to creating and/or modifying dots represented by the Social Discovery System. The dot creation API component 4201 may be utilized by a user interface (not shown) such as one of those described with reference to FIGS. 1-41. The dot system component 4202 provides functionality related to representing and/or managing dots such as the data structures used to store dots. In some embodiments, the dot system component 4202 may also provide mechanisms that automatically enhance some or all information related to dots, such as by automatically identifying or otherwise determining images, titles, tags, or other information to associate with dots. The dot user system component 4203 provides functionality related to representing and/or managing users and relationships between those users. The permissions engine component 4204 provides functionality related to representing and/or enforcing dot permissions. The permissions engine component 4204 may utilize information and/or functionality provided by both the dot system component 4202 and the user system component 4203, so as to restrict the ability of particular users or types of users to access particular dots. The dot retrieval API component 4205 provides functionality related to retrieving or otherwise accessing information related to dots and/or users. The display engine component 4206 provides functionality related to presenting dots and related information to users of the Social Discovery System, such as by directly displaying dots and/or organizing, decorating, and/or formatting for dots for display.

FIG. 42 also shows an example of data flow between components of the example Social Discovery System. In the illustrated example, user Jane utilizes the dot creation API component 4201 to create a dot, D2. Typically, Jane's interaction with the dot creation API component 4201 may be intermediated via an application that provides a user interface (not shown), such as a web browser. The newly created dot D2 passes into the dot system component 4202 where it is stored for later retrieval and possibly augmented with additional, automatically determined information, such as images, tags, etc. Also shown are two other dots, D0 and D1 that have been previously created by user Jane. The permissions engine component 4202 may restrict the visibility of dot D1, if Jane has previously specified that dot D1 should remain private, thereby restricting access of any other user (e.g., users Sally, Fred, and/or Tim) to dot D1.

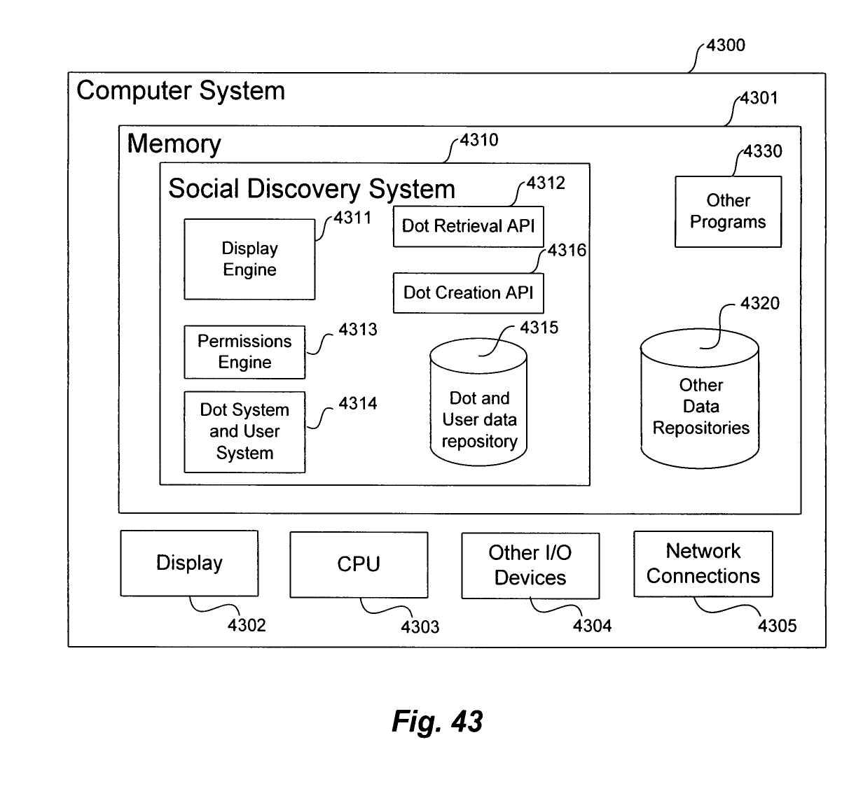

FIG. 43 is an example block diagram of a general purpose computer system for practicing embodiments of a Social Discovery System. The general purpose computer system 4300 may comprise one or more server and/or client computing systems and may span distributed locations. In addition, each block shown may represent one or more such blocks as appropriate to a specific embodiment or may be combined with other blocks. Moreover, the various blocks of the Social Discovery System 4310 may physically reside on one or more machines, which use standard or proprietary interprocess communication mechanisms (such as TCP/IP) to communicate with each other.

In the embodiment shown, computer system 4300 comprises a computer memory (“memory”) 4301, a display 4302, a Central Processing Unit (“CPU”) 4303, Input/Output devices 4304, and network connections 4305. The Social Discovery System (“SDS”) 4310 is shown residing in memory 4301. The components of the Social Discovery System 4310 preferably execute on CPU 4303 and manage the generation and use of dots, as described in previous figures. Other downloaded code 4330 and potentially other data repositories, such as data 4320, also reside in the memory 4310, and preferably execute on one or more CPU's 4303. In a typical embodiment, the SDS 4310 includes one or more display engines 4311, permissions engines 4313, dot system and users system 4314, dot retrieval API 4312, dot creation API 4316 and one or more dot and user data repositories 4315.

In an example embodiment, components of the SDS 4310 are implemented using standard programming techniques. One skilled in the art will recognize that the implementation described above uses well-known or proprietary asynchronous client-server computing techniques. However, any of the SDS components 4311-4316 may be implemented using more monolithic programming techniques as well. In addition, programming interfaces to the data stored as part of the SDS can be available through standard means such as through C, C++, C#, and Java API and through scripting languages such as XML, or through web servers supporting such. The dot and user data repository 4315 is preferably implemented for scalability reasons as a database system rather than as a text file, however any method for storing such information may be used. In addition, many of the components may be implemented as stored procedures, or methods attached to social discovery “objects,” although other techniques are equally effective.

The SDS 4310 may be implemented in a distributed environment that is comprised of multiple, even heterogeneous, computer systems and networks. For example, in one embodiment, the display engine 4311, the dot retrieval API 4312, and the dot and user data repository 4315 are all located in physically different computer systems. In another embodiment, various components of the SDS 4310 are hosted each on a separate server machine and may be remotely located from the tables which are stored in the dot and user data repository 4315. Different configurations and locations of programs and data are contemplated for use with techniques described herein. In example embodiments, these components may execute concurrently and asynchronously; thus the components may communicate using well-known or proprietary message passing techniques. Equivalent synchronous embodiments are also supported by an SDS implementation. Also, other steps could be implemented for each routine, and in different orders, and in different routines, yet still achieve the functions of the Social Discovery System.

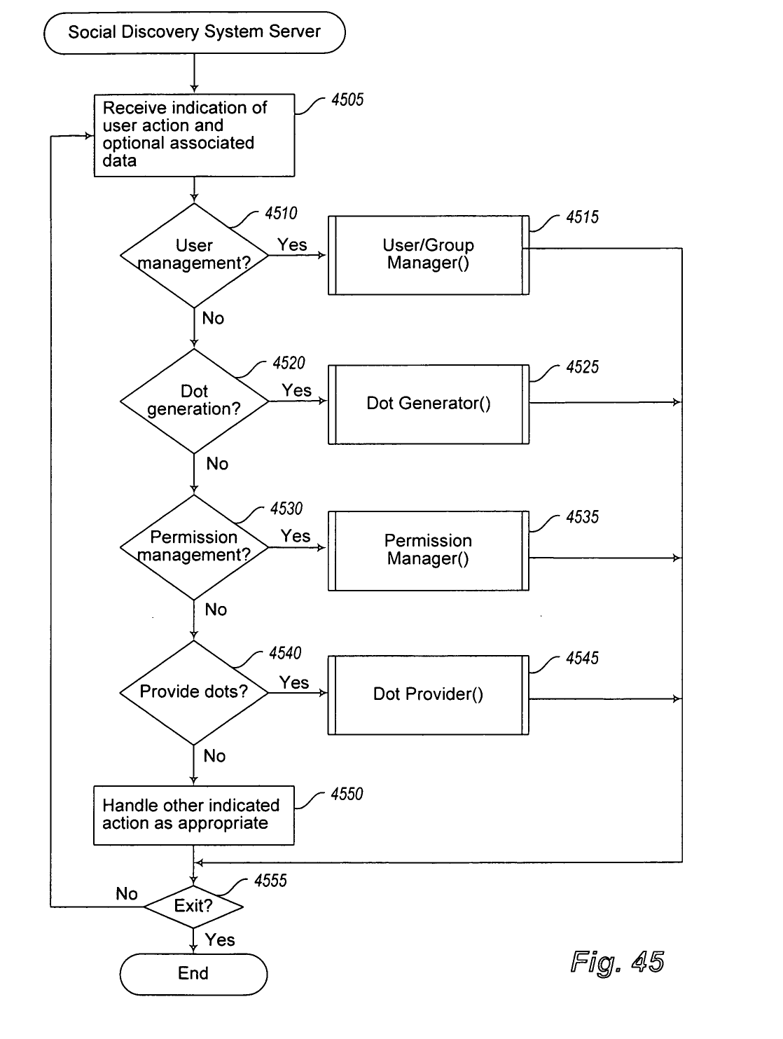

The functionality presented to a user as shown in FIGS. 1-41F is implemented in an example embodiment according to the components described in FIGS. 42 and 43 organized in a client-server architecture. FIGS. 45-52 primarily describe the role of a server and some of the services provided to realized this functionality. In other embodiments, the allocation of some or all of the illustrated functionality may be implemented by a client or other type (e.g., standalone, peer-to-peer, etc.) of application or system.

FIG. 45 is an example flow diagram of an example Social Discovery System server routine provided by an example embodiment of a Social Discovery System. The illustrated routine may be provided by, for example, execution of multiple components (e.g., the permissions engine 4313, the dot system and user system 4314, etc.) of the Social Discovery System 4310 of FIG. 43 to provide functionality of the Social Discovery System to multiple users operating client systems.

In steps 4505-4555, the routine performs a loop in which it repeatedly receives or determines an indication of an action to perform, and performs or initiates performance of the indicated action. Specifically, the routine begins in step 4505 where it receives an indication of an action and optional associated data. The action may be received from various sources, such as from a user operating a client system and/or from automated systems (e.g., a search engine, robot, etc.) The optional associated data may include one or more indications of objects managed by the Social Discovery System (e.g., users, groups, dots, etc.) and/or data that is to be contributed to the Social Discovery System (e.g., a URL indicating a web page that a user wishes to dot).

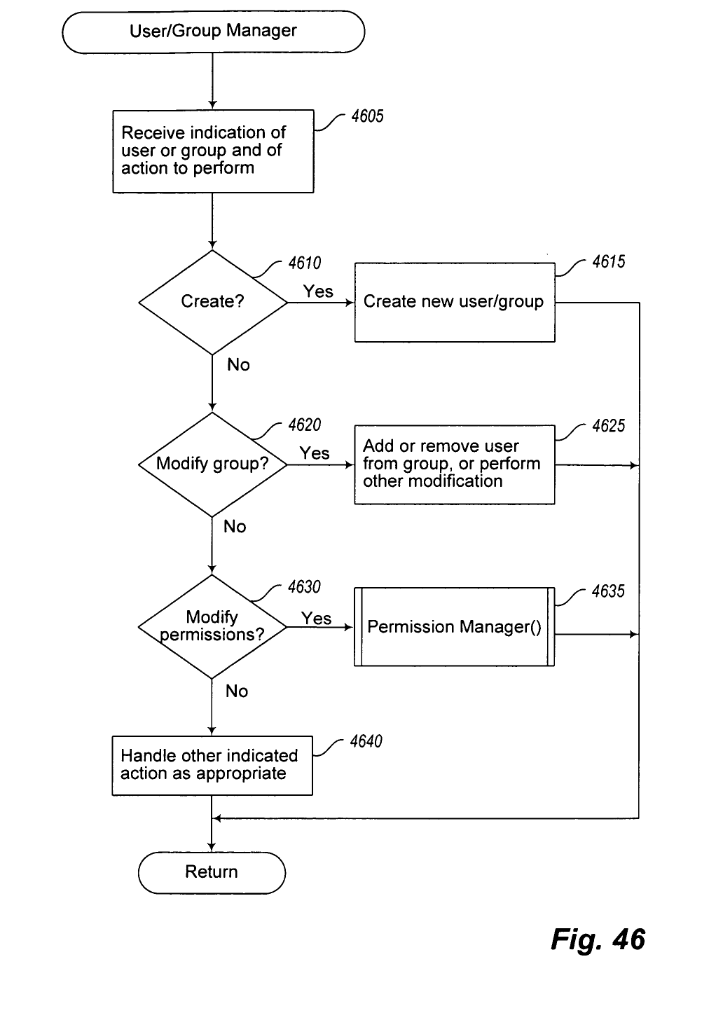

In step 4510, the routine determines whether the indicated action is related to user and/or group management, and, if so, continues in step 4515, else continues in step 4520. User and/or group management actions include creating new users (e.g., registration), modifying user preferences and/or account settings, creating and/or modifying groups, etc. In step 4515, the routine invokes a User/Group Manager routine to perform the indicated user and/or group action, and continues in step 4555. The User/Group Manager routine is described further with reference to FIG. 46.

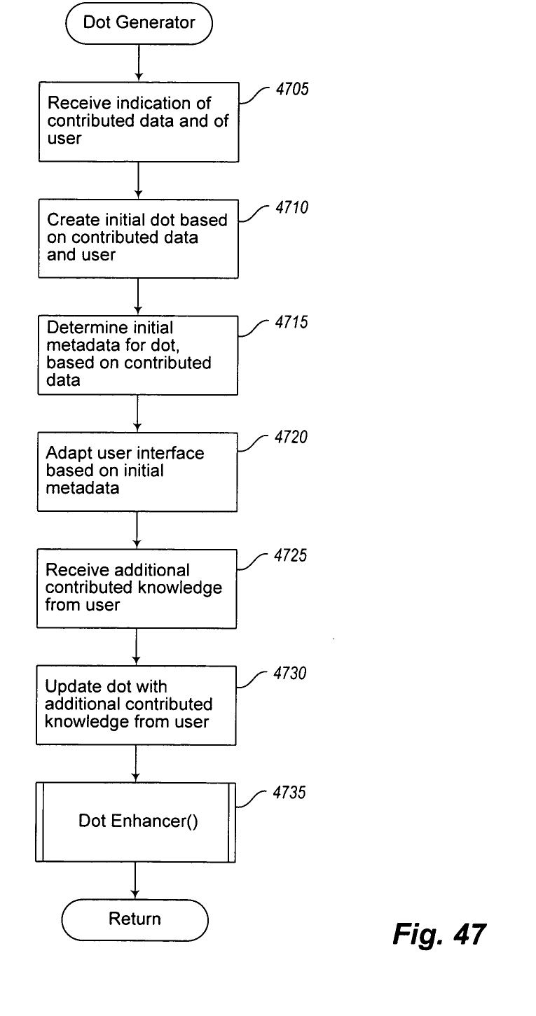

In step 4520, the routine determines whether the indicated action is to create a new dot, and, if so, continues in step 4525, else continues in step 4530. In step 4525, the routine invokes a Dot Generator routine to create and/or assist the user in the creation of a new dot, and continues in step 4555. The Dot Generator routine is described further with reference to FIG. 47.

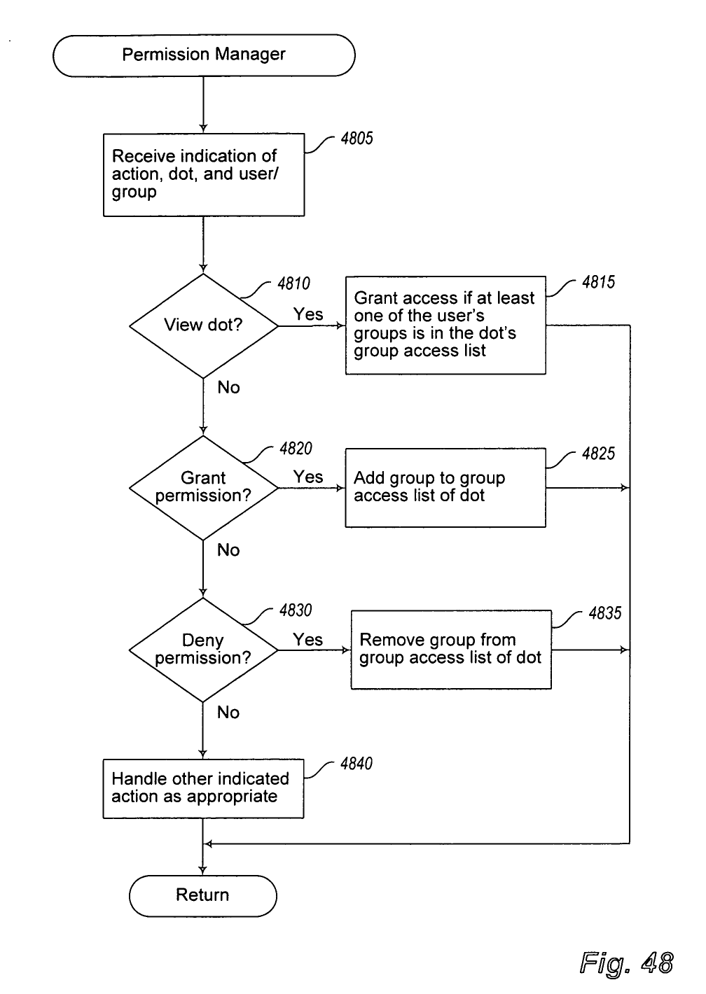

In step 4530, the routine determines whether the indicated action is related to permission management, and, if so, continues in step 4535, else continues in step 4540. Permission management actions include specifying permissions related to dots, users, and/or groups (e.g., that one or more groups have permission to view particular a particular dot), as well as the enforcement of permissions (e.g., whether a particular user has permission to view a particular dot). In step 4535, the routine invokes a Permission Manager routine to perform the indicated permission management action, and continues in step 4555. The Permission Manager routine is described further with reference to FIG. 48.

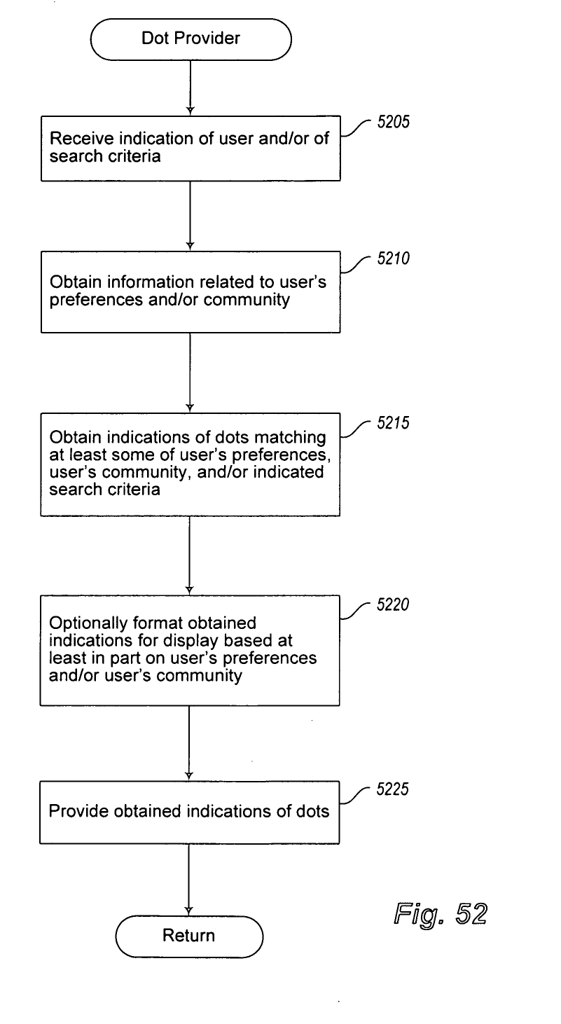

In step 4540, the routine determines whether the indicated action is to provide information related to one or more dots, and, if so, continues in step 4545, else continues in step 4550. Providing information related to dots includes performing searches, responding to requests for dots or dot-related information, notifying users of recent events in the SDS (e.g., newly created dots that may be of interest to them), etc. In step 4545, the routine invokes a Dot Provider routine to perform the indicated action, and continues in step 4555. The Dot Provider routine is described further with reference to FIG. 52. The routine then continues in step 4555.

In step 4550, the routine performs any other indicated actions as appropriate, and continues in step 4555. Other actions may include, for example, other actions related to dot management (e.g., deletion, update, modification, etc.), other actions related to the user interfaces described with respect to FIGS. 1-41F (e.g., adding comments to dots, sending messages to users, etc.), periodic housekeeping operations (e.g., backing up and/or restoring data stores, logs, and/or other information stores), etc. In step 4555, the routine determines whether it is appropriate to exit or if there is any other work to be performed, and, if it is appropriate to exit, ends, otherwise returns to the beginning of the loop in step 4505 to wait for and process additional received actions.

FIG. 46 is an example flow diagram of an example user and group manager routine provided by an example embodiment of a Social Discovery System. The illustrated routine may be provided by, for example, execution of the dot system and user system 4314 of FIG. 43 to provide functionality related to user and group management for the Social Discovery System, such as user and/or group creation and/or modification.

The routine begins in step 4605 where it receives an indication of a user or group, as well as an indication of an action to perform. The indicated user/group and action to perform may be received from, for example, the Social Discovery System Server routine described with reference to FIG. 45.

In step 4610, the routine determines whether the indicated action is to create a new user or group, and, if so, continues in step 4615, else continues in step 4620. In step 4615, the routine creates a new user or group and stores an indication of the new user/group in a data store, such as the dot and user data repository 4315 described with reference to FIG. 43. Creating a new user or group may in some embodiments include obtaining additional information related to the user, such as personally identifying information, contact information, user interface preferences, etc.

In other embodiments, such additional details may be provided to the routine when it is initially invoked. The routine then returns. In step 4620, the routine determines whether the indicated action is to modify an existing user or group, and, if so, continues in step 4625, else continues in step 4630. In step 4625, the routine performs the indicated modification action, such as adding or removing a user from a group, updating user-related information (e.g., user contact information, user interface preferences, etc.), etc. The routine then returns.

In step 4630, the routine determines whether the indicated action is to modify permissions associated with a user or group, and, if so, continues in step 4635, else continues in step 4640. Modifying permissions includes specifying permissions related to users and/or groups (e.g., granting permission to a group to view a particular dot). In step 4635, the routine invokes a Permission Manager routine to perform the indicated permission modification action, and then returns. The Permission Manager routine is described further with reference to FIG. 48.

In step 4640, the routine performs any other indicated actions as appropriate, and then returns. Other actions may include, for example, deleting users and/or groups, periodic housekeeping operations (e.g., backing up and/or restoring data stores, logs, and/or other information stores), performing and providing analyses of relationships between various users (e.g., for purposes of determining or identifying networks of users for enhancing the functionality of the Social Discovery System), etc.

FIG. 47 is an example flow diagram of an example dot generator routine provided by an example embodiment of a Social Discovery System. The illustrated routine may be provided by, for example, execution of some combination of the dot creation API 4316 and/or the dot system and user system 4314 of FIG. 43 and/or client-side user interface components such as those illustrated with reference to FIGS. 31-36 to provide functionality related creating new dots.

The routine begins in step 4705, where it receives an indication of contributed data and of a user. The indication of contributed data may include a URL or other indication of an information item, such as a web page, an audio file, a video file, etc. In step 4710, the routine creates an initial dot based on the contributed data and the user. In some embodiments, this may include generating an initial, mostly “empty” dot data structure or database record and defining fields that indicate an information item, an associated user, and other housekeeping (e.g., a globally unique identifier) data, while leaving other fields (e.g. those related to metadata such as keywords, comments, title, subject, quotes, rating, category, etc.) undefined.

In step 4715, the routine determines an initial set of metadata for the dot, based on an analysis of the contributed data. Such an analysis may include performing initial processing to determine likely keywords, subjects, titles, categories, etc. The analysis will typically be quickly and efficiently performed, so as to rapidly determine an initial set of metadata within the context of an interactive authoring session, so that the user interface provided to the user may be customized or adapted based on the determined metadata. This analysis may be performed entirely on a client system, entirely on the Social Discovery System server, or in some combination that results in acceptable tradeoffs between latency and accuracy of results. In addition, in some embodiments, some or all of this analysis may be performed by the Dot Enhancer routine described with reference to FIG. 49.

In step 4720, the routine adapts the user interface based on the metadata determined in step 4715. As noted above, embodiments of the SDS may provide contextual authoring capabilities by adapting an authoring user interface to the user's current context (e.g., web page being visited, device being operated, etc.) Adapting the user interface includes customizing the user interface by, for example, providing additional or alternative user interface widgets or components that are specialized for authoring a dot for the indicated information item. For example, it may be determined that the user is authoring a dot related to online shopping (e.g., about a good deal that is available at a particular Internet merchant), and thus may provide user interface widgets specialized to online shopping (e.g., a fill-in form having fields such as price, item name, product number, etc.).

A list of example user interface widgets that may be provided in response to a determined category or other characteristic of the indicated information item includes, but is not limited to: price, wish list, and recommendation widgets for online shopping information items; album chooser, song chooser, show times, and wish list widgets for music-related information items; date selector, friend invitation, mapping, and venue widgets for event-related information items; menu, mapping, recommendation, and related restaurant widgets for restaurant-related information items; comment, image, and related stories widgets for news-related information items; show time, comment, ratings, and movie metadata widgets for movie-related information items; and author biography, comment, rating, and reading list widgets for book-related information items.

Furthermore, some or all of the fields or other user interface controls in a provided user interface component may be pre-filled (e.g., the price field), so as to improve, enhance, or simplify the authoring experience for the user. For example, a tag completion user interface widget may be provided that assists the user in defining or providing a set of tags or keywords for the dot. Such a tagging widget can exploit knowledge about the user's tagging history to determine possibly overlapping collections or sets of tags that may be used by the user in various contexts.

In step 4725, the routine receives additional contributed knowledge from the user. Such additional contributed knowledge may include items such as keywords, ratings, categories, comments, etc. Such additional contributed knowledge may be provided by the user via the adapted user interface provided by step 4720. In step 4730, the routine updates the dot with the additional contributed knowledge received from the user.

In step 4735, the routine invokes a Dot Enhancer routine in order to enhance the newly generated dot by further improving the quality of its metadata. In some embodiments, the Dot Enhancer routine may run in an offline or asynchronous mode, so as to perform computationally expensive processing that may be too burdensome to perform in the context of an interactive authoring session. The Dot Enhancer routine is described further with reference to FIG. 49. After step 4735, the routine returns.

As noted, aspects of the dot generator routine of FIG. 47 may be provided by the execution of both client and server systems operating together in order to provide a rich, efficient, and expressive user experience. In particular, the described techniques may be utilized to provide an “in-page” authoring user interface components, that operate within, or have access to, the context of a particular information resource. For example, a user may indicate (e.g., via a control installed in their Web browser) that they wish to create a new dot. In response, an initial, generalized authoring component may be provided that allows the user to get started authoring the page. In the meantime, the authoring component may perform additional processing and/or analysis (e.g., on its own and/or with the assistance of one or more possibly remote server systems) of the Web page, by, for example, accessing the DOM (“Document Object Model”) associated with the web page, in order to determine additional information. The additional processing may be performed asynchronously so as to enhance responsiveness during the authoring process. Such additional information may, in turn, be provided to the user (e.g., by automatically filling in user interface data fields) or utilized as a basis for providing additional, customized user interface controls that are specialized for creating dots related to particular kinds of content (e.g., music, books, etc.).

FIG. 48 is an example flow diagram of an example permission manager routine provided by an example embodiment of a Social Discovery System. The illustrated routine may be provided by, for example, execution of the permissions engine 4313 of FIG. 43 to provide functionality related to permission management, such granting or denying permissions for particular users and/or groups to view, edit, or perform other operations with respect to dots and other data within the Social Discovery System, and enforcing existing permissions.

The routine begins in step 4805, where it receives an indication of an action to perform, a dot, and a user or group. The indicated data may be received from, for example, the Social Discovery System Server routine described with reference to FIG. 45 and/or the User and Group Manager routine described with reference to FIG. 46.

In step 4810, the routine determines whether the indicated action is to view the indicated dot, and, if so, continues in step 4815, else continues in step 4820. In step 4815, the routine grants access if at least one of the indicated user's groups is in the dot's group access list. In some embodiments, each user is associated with a record or other data structure (e.g., a list, a bit mask, etc.) that indicates zero or more groups to which the user belongs. A user's group membership may also be termed the user's “knowledge sharing fingerprint” or “social fingerprint.” In addition, each dot may also be associated with a group access list that specifies which groups may view, modify, and/or perform other operations upon the dot. Again, such an access list may be implemented by way of list, bit mask, or other data structure. Given the user's groups and the group access list of the dot, determining whether to grant access then becomes a matter of determining whether at least one of the user's groups is a member of the group access list of the dot. If permission is granted, then the indicated user may view the dot. Permission may be granted or denied in a number of ways, such as by message, signal, return code, exception, etc. The routine then returns.

In step 4820, the routine determines whether the indicated action is to grant permission for the indicated group to access the indicated dot, and if so, continues in step 4825, else continues in step 4830. In step 4825, the routine adds the indicated group to the group access list associated with the dot. The routine then returns.

In step 4830, the routine determines whether the indicated action is to deny or revoke permission for the indicated group to access the indicated dot, and if so, continues in step 4835, else continues in step 4840. In step 4835, the routine removes the indicated group from the group access list associated with the dot. The routine then returns.

In step 4840, the routine performs any other indicated actions as appropriate, and then returns. Other actions may include, for example, performing other, fine-grained operations with respect to permissions, such as setting particular types of accesses that are to be granted or revoked (e.g., read-only, read-write, etc.), setting timeouts related to permissions (e.g., so as to implement “expiring” permissions that allow users and/or groups to view particular dots but only for specified time periods), etc. Note also that groups need not contain multiple users. As such, permissions may be specified and enforced on a per-user basis by creating groups that include only a single user. In addition, due to the dynamic nature of the SDS in general, and its permission management system in particular, changes to permissions may be efficiently applied to previously generated content. For example, users may be granted or denied access to dots simply by adding or removing such users from a group that has been granted access to those dots.

FIG. 49 is an example flow diagram of an example dot enhancer routine provided by an example embodiment of a Social Discovery System. The illustrated routine may be provided by, for example, execution of the dot system and user system 4314 of FIG. 43 to enhance dots by performing intelligent processing of dots and their associated data (e.g., reflecting contributed knowledge and/or data, users, groups, etc.), including textual analysis, machine learning, heuristic processing, etc.

The routine begins in step 4905, where it receives an indication of a dot to process. The indicated data may be received from, for example, the Dot Generation Routine described with reference to FIG. 47. In the illustrated embodiment of an SDS, the routine is invoked on an on-demand basis, such as every time a new dot is generated. In other embodiments, the routine may be instead or additionally invoked on a periodic basis (e.g., every hour or day) to process one or more newly or previously created dots, so as to regularly update and/or improve the quality of information associated with dots in the Social Discovery System.

In step 4910, the routine obtains a list of enhancement engines that may enhance the indicated dot. Obtaining a list of enhancement engines may in some embodiments be based on particular qualities, configurations, or specialties associated with enhancement engines. Specifically, enhancement engines include intelligent engines or plug-ins that are configured to augment a dot with additional metadata or other information that is based on pre-existing information associated with the dot. Some enhancement engines may be configured or otherwise specialized to enhance particular kinds of dots, such as dots that reference known web sites (e.g., particular e-commerce sites that obtain a substantial volume of Internet traffic). Such enhancement engines may utilize domain specific information or heuristics to enhance dots. Other enhancement engines may be more general in nature, and may variously be configured to perform operations such as selecting images, determining ratings, selecting keywords or tags, determining appropriate subjects, generating quotes, selecting advertisements, obtaining related information (e.g., other Web pages), or determining categories for dots. In addition, enhancement engines may variously perform their operations quickly (e.g., synchronously) or in a more computationally intensive manner (e.g., asynchronously). Accordingly, obtaining a list of enhancement engines may include selecting enhancement engines that are specialized to the indicated type of dot, perform their enhancements efficiently, are capable of adding data that is known to be missing from the indicated dot (e.g., supplying keywords for a dot that does not have any associated keywords), etc.

In steps 4915-4930, the routine performs a loop in which it submits the dots to each of the obtained list of enhancement engines. Specifically, in step 4915, the routine determines whether there are more engines in the list of enhancement engines to process, and, if so, continues in step 4920, else returns. In step 4920, the routine gets the next enhancement engine from the obtained list of enhancement engines. In step 4925, the routine submits the dot to that enhancement engine for processing. In step 4930, the routine initiates processing of the dot by the enhancement engine. In some embodiments, enhancement engines may conditionally perform processing depending on whether or not the routine is expected to run quickly, such as when it is invoked in the context of an interactive dot authoring user interface session. Such criteria may be passed to the engine when invoked. After step 4930, the routine continues in step 4915 and continues the loop.

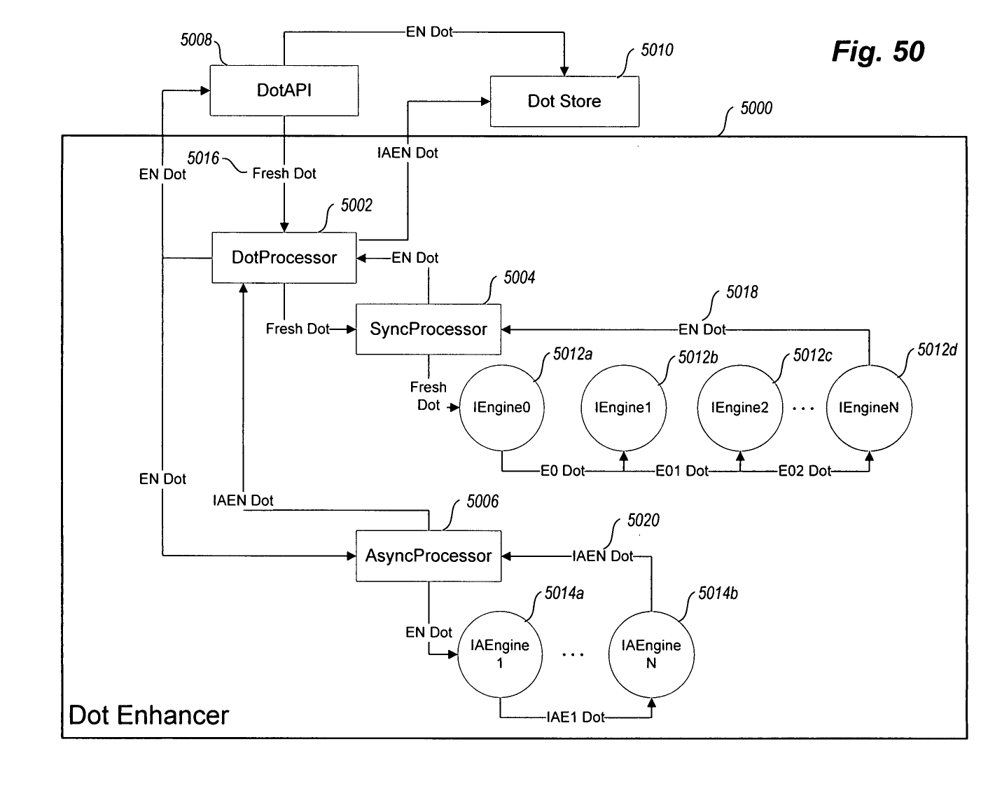

FIG. 50 is an example block diagram illustrating components and data flow within an example dot enhancer component provided by an example embodiment of a Social Discovery System. The illustrated dot enhancer component 5000 may be a subcomponent of, for example, the dot system and user system 4314 of FIG. 43. The illustrated components and data structures of the dot enhancer component 5000 may be used to implement a dot enhancer routine, similar to the one described with reference to FIG. 49.

In particular, the dot enhancer component 5000 includes a dot processor 5002, a synchronous processor 5004, and a asynchronous processor 5006. The dot enhancer component 5000 obtains input from a dot API 5008 and provides output via the dot API 5008 and a dot store 5010. The dot API 5008 and the dot store 5010 may be provided by, for example, the dot creation API 4316 and the dot and user data repository 4315 of FIG. 43, respectively.

Initially, a newly created dot (a “Fresh Dot”) 5016 is passed from the dot API 5008 to the dot processor 5002. The dot processor 5002 then passes the fresh dot along to the synchronous processor 5004, which passes the fresh dot along to a chain of synchronous intelligence engines 5012a-5012d. The synchronous intelligence engines 5012a-5012d each process the dot, incrementally improve the quality of the information associated with the dot, and pass the dot along to the next synchronous intelligence engine in the chain, illustrated by intermediate dots E0 Dot, E01 Dot, E02 Dot, respectively. Eventually, when the last of the synchronous intelligence engines 5012a-5012d has processed the dot, the dot is passed back as an enhanced dot 5018 to the synchronous processor 5004, and then to the dot processor 5002.

After synchronous processing, the enhanced dot is passed by the dot processor 5002 to the dot store 5010 via the dot API, thereby making the enhanced dot quickly available for other uses, such as by interactive user interface components. In addition, the enhanced dot is also passed along to the asynchronous processor 5006, which in turn passes the enhanced dot along to a chain of asynchronous intelligence engines 5014a-5014b. The asynchronous intelligence engines 5014a-5014b each process the dot and incrementally improve the quality of the information associated with the dot. As noted above, asynchronous processing can proceed at a slower pace, and therefore may in some cases be capable of providing more computationally intensive processing tasks. Eventually, when the last of the asynchronous intelligence engines 5014a-5014b has processed the dot, it is passed back as an additionally enhanced dot 5020 to the asynchronous processor 5006, and then to the dot processor 5002, which updates the representation of the dot in the dot store 5010 to reflect the asynchronous enhancements.

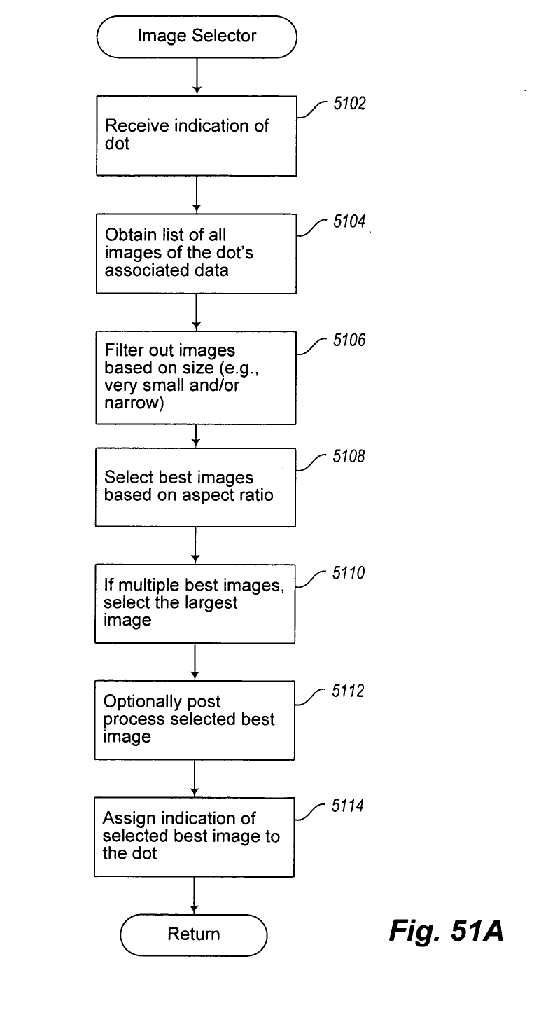

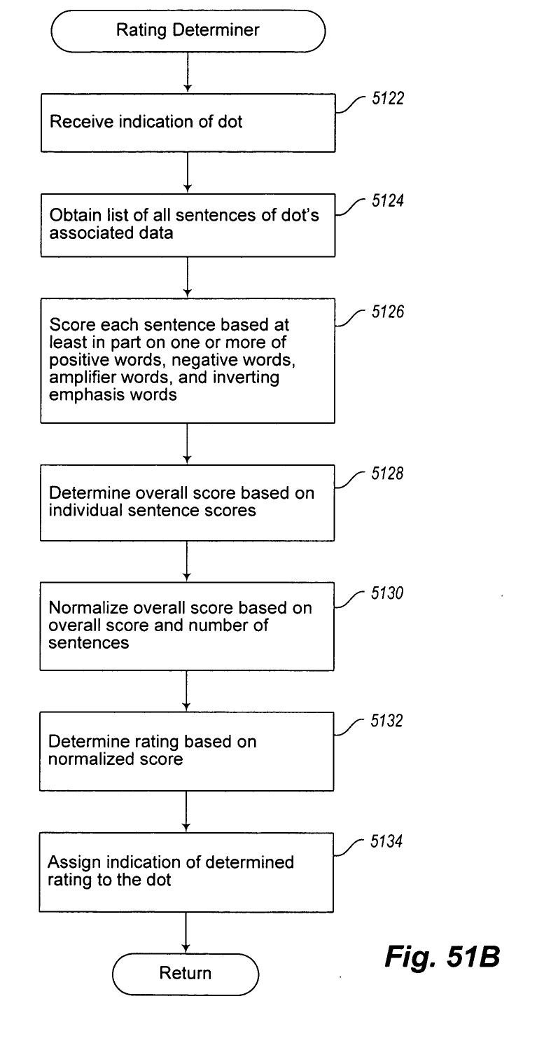

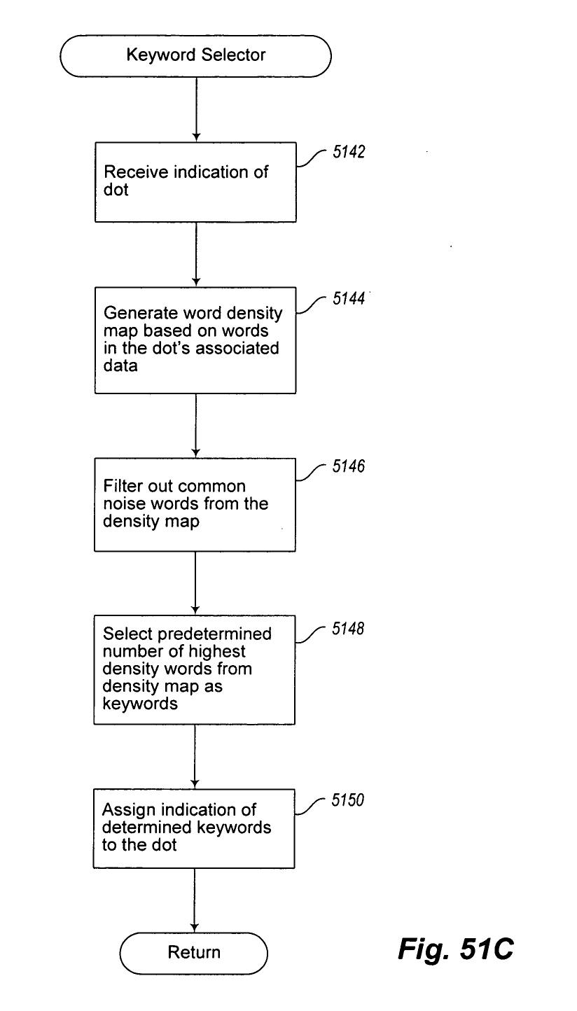

FIGS. 51A-51C are example flow diagrams of dot enhancement routines provided by dot enhancement engines within an example embodiment of a Social Discovery System. The illustrated dot enhancement routines may be provided by, for example, the synchronous intelligence engines 5012a-5012d and/or the asynchronous intelligence engines 5014a-5014b described with reference to FIG. 50. In some embodiments, dot enhancement engines may be designed and implemented by the designers, implementers, and/or operators of the Social Discovery System. In other embodiments, the Social Discovery System may allow users to create dot enhancement engines which can be submitted (e.g., plugged in) to the Social Discovery System, possibly in exchange for payment. In this manner, the community of users participating in the Social Discovery System may be leveraged to improve the quality and/or performance of the system, by developing new dot enhancement engines, or improving upon existing dot enhancement engines.

FIG. 51A is an example flow diagram of an image selector routine provided by a dot enhancement engine configured to automatically select an appropriate image to associate with a dot for display purposes. Note that other algorithms and/or priorities of selecting images may be similarly incorporated by a dot enhancement engine. The routine begins in step 5102, where it receives an indication of a dot to process. In step 5104, the routine obtains a list of all images of the dot's associated data. For example, if the indicated dot references a web page, the routine may obtain a list of all images referenced by, or displayed as part of, that web page.

In step 5106, the routine filters out images from the list based on size of the images. In particular, it may filter out images that are smaller or more narrow than a predetermined threshold. In this manner, most images used for decorative or stylistic purposes (e.g., section separators, bullets from bulleted lists, etc.) may be eliminated from consideration.

In step 5108, the routine selects the best images based on the aspect ratio (e.g., the width of the image divided by the height) of the images. In particular, images having aspect ratios closer to square (e.g., aspect ratios closer to 1.0) may be preferentially selected.

In step 5110, the routine selects the largest image, based on the area of the image, if multiple best images are selected in step 5108. In step 5112, the routine optionally post processes the selected best image, such as by producing a thumbnail version of the image, compressing the image to save storage space, etc. In step 5114, the routine assigns an indication of the selected best image to the indicated dot, and then returns.

FIG. 51B is an example flow diagram of a rating determiner routine provided by a dot enhancement engine configured to automatically determine a dot rating. For example, a dot rating may be presented as a number of stars or other indication reflecting the quality of a particular dot. The routine begins in step 5122, where it receives an indication of a dot to process. In step 5124, the routine obtains a list of all sentences of the dot's associated data. For example, if the indicated dot refers to a web page, the routine may obtain a list of all sentences of the textual content of the web page.

In step 5126, the routine scores each sentence of the associated dots based at least in part on one or more of positive words, negative words, amplifier words, and inverting emphasis words occurring within each sentence. Positive words may include those having positive emotional connotations, such as “great,” “fun,” “exciting,” “cool,” etc. Positive words in a sentence may result in a higher (e.g., more positive) score for that sentence. Negative words include those with negative emotional connotations, such as “bad,” “horrible,” “boring,” etc. Negative words in a sentence may result in a lower score (e.g. more negative) for that sentence. Amplifier words include words that emphasize associated positive or negative words, such as “very,” “more,” “totally,” etc. Amplifier words within a sentence may increase the positive or negative scoring effect of their associated positive or negative words within that sentence. Inverting emphasis words include words that negate or otherwise invert or reduce the emotional connotation of a word they proceed, such as “not” (e.g., “not cool”). Inverting emphasis words within a sentence negate or at least dampen the scoring effect of their associated positive or negative words within that sentence.

In step 5128, the routine determines an overall score based on individual sentence scores, such as by summing or otherwise combining the individual sentence scores determined in step 5126. In step 5130, the routine normalizes the overall score based on the overall score and the total number of sentences, so as to make the overall score meaningful independent of the size of the text processed. In step 5132, the routine determines a rating based on the normalized score. For example, a table lookup or other technique may be utilized to map scores, or ranges of scores, to particular ratings and/or indications of ratings. In step 5134, the routine assigns an indication of the determined rating to the dot, and then returns.

Although the above-described rating determiner routine processes text in a sentence-by-sentence manner, other embodiments may of course determine ratings by analyzing other units of text and/or language, such as paragraphs, phrases, individual words, syllables, phonemes, etc. In addition, ratings may be based on various forms of non-textual information related to the dot, such as statistics about a dot's popularity (e.g., based on a count of the number of times a dot has been accessed, referenced, or shared).

FIG. 51C is an example flow diagram of a keyword selector routine provided by a dot enhancement engine configured to automatically select appropriate keywords (e.g., to use as tags) for a given dot. The routine begins in step 5142, where it receives an indication of a dot to process. In step 5144, the routine generates a word density map based on the words in the dot's associated data. For example, if the indicated dot refers to a web page, the routine may generate a word density map of all words within the textual content of the web page. A word density map may be implemented as a table (e.g., a reverse document frequency index) that maps each word appearing in a text to a count, that reflects the number of times that word appears in the text.

In step 5146, the routine filters out common noise words from the density map. Common noise words typically include articles (e.g., “a,” “the,” etc.), pronouns (e.g., “he,” “she,” “it,” etc.) and other frequently occurring words that do not make suitable keywords.

In step 5148, the routine selects a predetermined number (e.g., three) of the highest density words (e.g., the most frequently occurring) from the density map as keywords. In step 5150, the routine assigns an indication of the determined keywords to the dot, and then returns.

The above-described dot enhancement routines of FIGS. 51A-51C are but exemplary implementations. Many enhancement functions could be additionally or alternatively performed by way of other techniques. For example, a category determiner engine may select a category for a dot in various ways, such as by classifying the text of a web page (e.g., with a Bayesian classifier) and/or by analyzing components of a URL for a web page (e.g., domain, sub-domain, directory structure, file names, etc.). In some embodiments, various meta-information (e.g., categories, keywords, images, ratings, parental control information, prices, etc.) may be associated with URLs and various components of those URLs. For example, a data store (e.g., database system) may be utilized to represent mappings between components of URLs and elements of a social taxonomy of tags, concepts, ideas, categories, and/or classes. The social taxonomy may itself be represented as a weighted, directed graph that maintains relationships between various elements of the taxonomy, such that it may be utilized to efficiently generate accurate categories or other classifications for a given URL or other item of social knowledge.

In addition, an example subject selector engine may heuristically select appropriate subjects for a dot by utilizing regular expressions to generate or improve upon a provisionally selected subject, such as the title of an HTML page (e.g., as defined by the TITLE tag included in a page of content). In many cases, a title provided by a web page includes an indication of the domain of the website that provides the page (e.g., “City Times News—Bear Climbs Tree” provided by “citytimesnews.com”). In such cases, a regular expression may be utilized to match and eliminate the portion of the title that reflects the source (e.g., the domain “citytimesnews.com”) of the information item (e.g., eliminating “City Times News” and yielding in “Bear Climbs Tree”).

An example quote selector engine may select a good quote for a dot by utilizing a layered approach. First, the quote selector may search for particular meta information associated with content associated with a dot. For example, the HTML META tag may in some cases provide an appropriate quote (e.g., the META tag with an associated “description” attribute). If no suitable meta data is located, a quote may be heuristically determined by extracting a predetermined number of sentences or other syntactic elements (e.g., phrases, clauses, etc.) from a predetermined block or paragraph (e.g., the first paragraph) of text.

In other embodiments, supervised or unsupervised machine learning techniques may be utilized by example enhancement engines. For example, one or more of the enhancement engines may include a machine learning system (e.g., a support vector machine, a Bayesian network, a neural network, a hidden Markov model, etc.) that may be trained to perform a particular function, such as selecting a category based on information associated with a dot.

FIG. 52 is an example flow diagram of an example dot provider routine provided by an example embodiment of a Social Discovery System. The illustrated routine may be provided by, for example, execution of the display engine 4311 and/or the dot retrieval API 4312 of FIG. 43 to provide dots to a user and/or other client, based on provided search criteria or other preferences and/or properties associated with the user. Dots provided by this routine may be utilized to present a dotazine, such as is described with reference to FIGS. 3, 4, and/or 14. In the illustrated embodiment, the routine is invoked in response to a request received from a user. However, in other embodiments, the routine may be invoked periodically, so as to notify users of recent events (e.g. new dots) within the Social Discovery System. In still other embodiments, the routine may be automatically invoked in response to changes in a user's context (e.g., providing a specialized view or customized set of dots in response to an indication that the user is operating a mobile device with limited display capabilities).

The routine begins in step 5205, where it receives an indication of a user and/or of search criteria. The indicated data may be received from, for example, the Dot Generation Routine described with reference to FIG. 47. In particular, search criteria may reflect explicit search criteria provided by a user, using a search language or user interface controls such as those described with reference to FIGS. 25-28. In step 5210, the routine obtains information related to the user's preferences and/or community. Such information may be obtained, for example, from the dot and user data repository 4315 of FIG. 43.

In step 5215, the routine obtains indications of dots matching at least some of the user's preferences, the user's community, and/or the indicated search criteria. In this manner, a filtered set of dots that are appropriate for the indicated user based on information about the user maintained by the Social Discovery System is obtained. For example, based on information reflecting the user's preference for viewing dots of a particular category (e.g., news items), the routine may filter out all non-news related dots. Such information may, of course, be explicitly provided (e.g., by the user updating stored preferences, or as part of a search request), or may be implicitly obtained (e.g., by tracking the user's interactions with the Social Discovery System and learning that the user most frequently views news items).

In step 5220, the routine optionally formats the obtained indications of dots for display based at least in part on the user's preferences, the user's community, and/or other information about the user. For example, if the user is using a particular type of computing device (e.g., a limited display device such as a cell phone), the obtained indications of dots may be formatted or further filtered such as to display appropriately on the user's computing device. Or, based on information reflecting the user's preferred user interface view (e.g., more text oriented than graphics oriented), the obtained indications of dots may be formatted to match such preferences.

In step 5225, the routine provides the obtained indications of dots, and then returns. In other embodiments, the routine may in addition perform other functions, such as periodically notifying (e.g., by sending an email) one or more users of recent occurrences or events within the Social Discovery System.

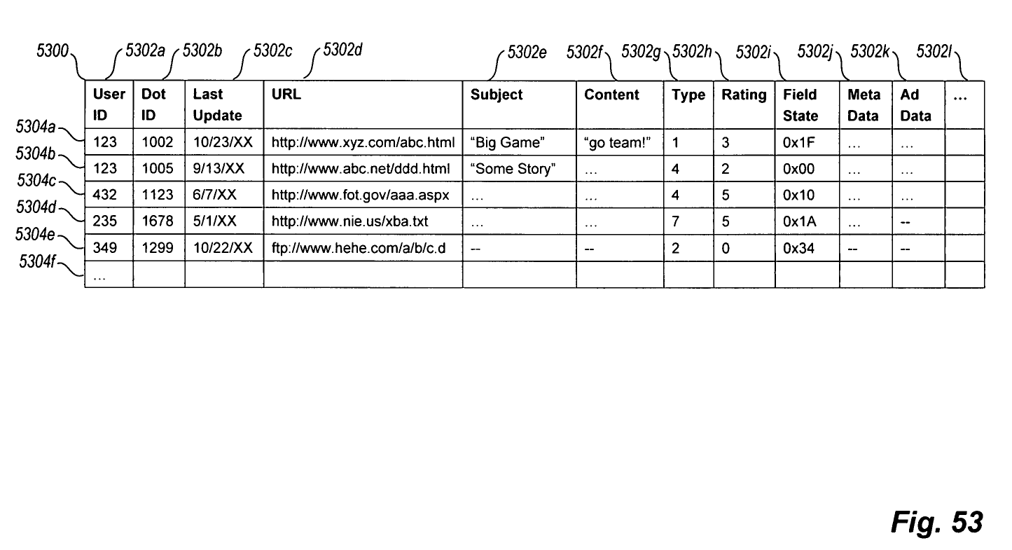

FIG. 53 is an example data structure utilized by an example embodiment of a Social Discovery System for representing one or more dots. In particular, FIG. 53 shows a table 5300 that includes multiple rows 5304a-5304f. Each of the rows 5304a-5304f includes information related to a single dot. In one embodiment, each represented dot includes a User ID (“Identifier”) field 5302a that contains an integer that uniquely identifies the user that created the represented dot; a Dot ID field 5302b that contains an integer uniquely identifies the represented dot; a Last Update field 5302c that includes date-time data that reflects the last time the represented dot was updated; a URL field 5302d that includes a Uniform Resource Locator that identifies a data item associated with the represented dot; a Subject field 5302e that contains text briefly describing the represented dot; a Content field 5302f that contains text quoted from the data item or provided by the author of the represented dot; a Type field 5302g that contains an integer that may be mapped (e.g., by way of another table) to a category for the represented dot; a Rating field 5302h that contains a user-supplied rating for the represented dot; a Field State field 5302i that includes a bit mask that may be used a machine learning system for various purposes (e.g., to distinguish training data from test data); a Meta Data field 5302j that may include various meta data, such as an image URL, image dimensions, or partner web site URLs (e.g., for tracking click-through activity); an Ad Data field 5302k that may include advertising information. In other embodiments, more or less information, or information of different kinds, may be maintained in association with each dot, as illustrated by field 53021. The ellipsis (“ . . . ”) in some fields indicates that information similar to that shown elsewhere for the field is provided, but not shown, for purposes of clarity. The dot representation data structure may be implemented using commonly known techniques for storing data, including but not limited to, arrays, hash tables, linked lists, data bases, file systems (e.g., files and/or directories), etc.

A number of example dots are illustrated in rows 5304a-5304f. For example, row 5304a contains a dot created by a user having a User ID of 123, that was last updated on 10/23/XX, and having a subject of “Big Game.” Note that not all dots have data values provided for each of their fields, as illustrated by “--” in the appropriate location. For example, the dot contained in row 5304e does not have data values for its Subject, Content, Meta Data, and Ad Data fields. This may occur when, for example, a dot is initially created and some data values have yet to be provided by the dot's author, other users, and/or the SDS itself (e.g., via automatic enhancement).

As noted above, some embodiments provide one or more Application Program Interfaces (“APIs”) that may be utilized by third parties to interface with the Social Discovery System. For example, the Dot Retrieval API 4312 may be utilized by client applications to access various functionality provided by the Social Discovery System 4310 of FIG. 43. In particular, an example dot retrieval API may provide access to at least some of the following functionality:

1. Creating dynamic community or user profiles: by obtaining a collection of dots from a user's community or the user themselves, it is possible to provide a compelling view of the books, music, movies, and other items, that a user's community and/or the user finds most relevant.

2. Information clustering: the data returned by the dot retrieval API can be sent in clusters of dots all around a single URL or other information reference. This allows a consuming application to determine which information that has the highest community density, or the highest public density of dots. Dot density around a particular information reference can be a measure of relevance or importance for the referenced information item.

3. Dot broadcasting (“dotcasting”): client applications may be built to monitor changes in a user's community. For example, when members of the user's community dot new information, a dotcasting application could notify them with an email, an instant message, or a custom message or user interface designed to enhance the experience of a community in action.

4. Providing community influenced domain views: a search may be performed that returns all of the dots in a user's community that pertain to a particular domain. Displays can then be created that show a page on a domain augmented with what a user's community communicates about items on that domain.

5. Providing community influenced domain density: in addition to a view, applications can be built to provide a user with information on what domains are most often viewed by the user's community.

6. Providing calendar based information views: searches can be date based, and a calendar application provided to allow users to see their dots and the dots of their community by the date they were created, the date they were last modified, or some other date associated with the dot (e.g., a time and day associated with a particular event, such as a movie or concert).

The following pseudo-code segment shown in Table 1 is an example query formed in an example embodiment of a dot retrieval API that provides a Web Services interface to functionality of the SDS. In particular, the code segment shows an example XML request document that includes a request for retrieving dots based on provided search criteria. In particular, the illustrated request is to search for dots at least having specified rating range (lines 21-22), having associated images (line 23), in any category (line 24), limited to particular users (line 25), and having keywords “sushi” and “Seattle” (line 26). The illustrated request document may be transmitted to a Social Discovery System in various ways, such as via HTTP.

TABLE 1

| | |
|---|---|
| 1. | <DotRequest> |

| | |
|---|---|
| 2. | <Authentication> |

| | |
|---|---|
| 3. | <username></username> |
| 4. | <password></password> |

| | |
|---|---|
| 5. | </Authentication> |
| 6. | |
| 7. | |
| 8. | <SearchCriteria> |

| | |
|---|---|
| 9. | <PageInformation> |

| | |
|---|---|
| 10. | <ResultsPerPage> 10 </ResultsPerPage> |
| 11. | <CurrentPageNumber> 1 </CurrentPageNumber> |
| 12. | <RequestedPageNumber> 1 </RequestedPageNumber> |
| 13. | <ExcludeUrls> www.x.com,www.y.com |
| | </ExcludeUrls> |

| | |
|---|---|
| 14. | </PageInformation> |
| 15. | |
| 16. | |
| 17. | <OrderBy> Time </OrderBy> |
| 18. | <Order> Ascending </Order> |
| 19. | <GroupBy> Url </GroupBy> |
| 20. | <GroupByMaxCount> 10 </GroupByMaxCount> |
| 21. | <CreatedStartDate> 6/1/2005 </CreatedStartDate> |
| 22. | <CreatedEndDate> 12/1/2005 </CreatedEndDate> |
| 23. | <LowRating> 1 </LowRating> |
| 24. | <HighRating> 3 </HighRating> |
| 25. | <ImagesOnly> true </ImagesOnly> |
| 26. | <Categories> All </Categories> |
| 27. | <Users> 1987239, 2387387, 291, 29383 </Users> |
| 28. | <Keywords> sushi,seattle </Keywords> |
| 29. | <Domains> www.x.com </Domains> |
| 30. | <Urls> www.x.com/shopping </Urls> |

</SearchCriteria>

</DotRequest>

The request document illustrated in Table 1 describes at least some of the various criteria that may be provided as part of a search for dots. For example, criteria may specify dots having particular creation dates or date ranges, dots having particular ratings or rating ranges, dots having associated images, dots from specific categories, dots authored or associated with particular users and/or groups, or dots references particular domains. In addition, the API may be utilized to specify particular orderings or groupings of returned results (e.g., by relevance, date, etc.).

When an example Social Discovery System receives a request such as the one illustrated in Table 1, it performs a search and compiles the results as directed by the request. An example response document is shown in Table 2, below:

TABLE 2

| | |
|---|---|
| 1. | <DotResponse> |
| 2. | |

| | |
|---|---|
| 3. | <DotCollection> |
| 4. | |
| 5. | |

| | |
|---|---|
| 6. | <Dot> |

| | |
|---|---|
| 7. | <id>48373</id> |
| 8. | <UidFrom>1987239</UidFrom> |
| 9. | <Subject>Foostore, Its just better!</Subject> |
| 10. | <Topic></Topic> |
| 11. | <Comment>I really like this shopping site! |
| | </Comment> |
| 12. | |
| 13. | <Url>http://www.foostore.com</Url> |
| 14. | <Category>1</Category> |
| 15. | <Created>07/09/2005 14:38:29</Created> |
| 16. | <LastUpdate>07/09/2005 14:39:00</LastUpdate> |
| 17. | <Keywords>footsore,shopping,better,seattle |
| | </Keywords> |
| 18. | <Permission>Public</Permission> |
| 19. | <Rating>1</Rating> |
| 20. | <Image>http://www.foostore.com/images/logo.gif |
| | </Image> |
| 21. | |
| 22. | <ImageHeight>110</ImageHeight> |
| 23. | <ImageWidth>276</ImageWidth> |
| 24. | <FieldSource>0</FieldSource> |
| 25. | <Excerpt>Ista all about the foo</Excerpt> |
| 26. | <ExcerptSource></ExcerptSource> |

| | |
|---|---|
| 27. | </Dot> |
| 28. | |
| 29. | |
| 30. | <Dot> |

| | |
|---|---|
| 31. | <id>23983</id> |
| 32. | <UidFrom>2387387</UidFrom> |
| 33. | <Subject>Foostore, Its just better!</Subject> |
| 34. | <Topic></Topic> |
| 35. | <Comment>I really liked it too!</Comment> |
| 36. | <Url>http://www.foostore.com</Url> |
| 37. | |
| 38. | <Category>1</Category> |
| 39. | <Created>06/09/2005 14:38:29</Created> |
| 40. | <LastUpdate>06/09/2005 14:39:00</LastUpdate> |
| 41. | <Keywords>footsore,shopping,better</Keywords> |
| 42. | <Permission>Public</Permission> |
| 43. | <Rating>1</Rating> |
| 44. | <Image>http://www.foostore.com/images/logo.gif |
| | </Image> |
| 45. | <ImageHeight>110</ImageHeight> |
| 46. | |
| 47. | <ImageWidth>276</ImageWidth> |
| 48. | <FieldSource>0</FieldSource> |
| 49. | <Excerpt>Ista all about the foo</Excerpt> |
| 50. | <ExcerptSource></ExcerptSource> |

| | |
|---|---|
| 51. | </Dot> |
| 52. | |

| | |
|---|---|
| 53. | </DotCollection> |
| 54. | |
| 55. | |

| | |
|---|---|
| 56. | <DotCollection> |
| 57. | |

| | |
|---|---|
| 58. | <Dot> |

| | |
|---|---|
| 59. | <id>98342</id> |
| 60. | <UidFrom>1987239</UidFrom> |
| 70. | <Subject>Barfun, Its more fun than a bar!</Subject> |
| 71. | |
| 72. | <Topic></Topic> |
| 73. | <Comment>I really like this shopping site! |
| | </Comment> |
| 74. | <Url>http://www.barfun.com</Url> |
| 75. | <Category>1</Category> |
| 76. | <Created>08/09/2005 17:38:29</Created> |
| 77. | <LastUpdate>08/09/2005 14:39:00</LastUpdate> |
| 78. | <Keywords>sushi,barfun,shopping,better</Keywords> |
| 79. | |
| 80. | <Permission>Public</Permission> |
| 81. | <Rating>1</Rating> |
| 82. | <Image>http://www.barfun.com/images/logo.gif |
| | </Image> |
| 83. | <ImageHeight>110</ImageHeight> |
| | <ImageWidth>276</ImageWidth> |
| | <FieldSource>0</FieldSource> |
| | <Excerpt>Ista all about the foo</Excerpt> |
| | <ExcerptSource></ExcerptSource> |

</Dot>

</DotCollection>

</DotResponse>

The illustrated response includes two dot collections (lines 3-47, and 49-81, respectively). Each dot collection includes one or more dots each referencing the same URL that match the search criteria of Table 1. The first dot collection includes two dots (lines 5-24 and 26-45, respectively). The second dot collection includes a single dot (lines 51-79).

As noted above, some embodiments of the Social Discovery System provide a search language that may be used in addition to, or instead of, a dot retrieval API, such as the one described above. One example of a search language is described below, with reference to Table 3. The example search language treats every string passed in as a keyword specification unless the string is prefixed with a special character sequence (e.g. “bd”) and is followed by a known command. The following table lists a set of example commands supported by an example search language:

TABLE 3

| Command | Semantics | Example(s) |
|---|---|---|
| bd [category] | Find dots matching the | bdmovies |
| | specified category | |
| bd [user] | Find dots authored by the | bdEdgar |
| | specified user or group | bdSoccerTeam |
| bdrating | Find dots having at least the | bdrating 3 |
| [rating] | specified rating | bdrating 1-3 |
| bdcreated | Find dots created on or | bdcreated today |
| [date] | during the specified date | bdcreated |
| | | Nov. 1, 2006-Nov. 5, 2006 |
| bdorder | Order results by the | bdorder ascend |
| [ordering] | specified ordering | bdorder descend |
| bdorderby | Order results by the | bdorderby time |
| [field] | specified field | bdorderby relevance |
| bdimage | Find dots (not) associated | bdimage true |
| [boolean] | with an image | |

The illustrated search commands can be combined in various ways to perform complex searches. For example, the search query “bdmovies bdEdgar bdrating 3-5 bdorderby rating bdorder descend” would return dots having the category “movies, authored by user “Edgar”, and having a rating in the range of three to five stars. In addition, the returned results would be ordered in decreasing order of their ratings, so as to present more highly rated movies earlier in the result set.

In addition, in some embodiments, the SDS will perform searches by utilizing a “knowledge waterfall” model, which may tend to provide more socially relevant search results by searching for and/or ordering search results containing dots in a manner influenced by a user's social network. For example, the SDS may search for, or provide, dots created by nearest friends (e.g., direct friends of a user) prior to those created by more distant friends (e.g., friends of friends of the user) prior to those created by users that are not known to the user.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/723,982 entitled “SOCIAL DISCOVERY SYSTEM,” filed Oct. 5, 2005; U.S. Provisional Patent Application No. 60/734,370 entitled “PERMISSION MANAGEMENT AND AUTHORING METHODS AND SYSTEMS FOR SOCIAL DISCOVERY,” filed Nov. 7, 2005; U.S. Provisional Patent Application No. 60/775,973 entitled “AUTHORING METHODS AND SYSTEMS FOR SOCIAL DISCOVERY,” filed Nov. 29, 2005; and U.S. Provisional Patent Application No. 60/776,010 entitled “SOCIAL DISCOVERY SYSTEM,” filed Nov. 29, 2005 are incorporated herein by reference, in their entirety.

From the foregoing it will be appreciated that, although specific embodiments of the invention have been described herein for purposes of illustration, various modifications may be made without deviating from the spirit and scope of the invention. For example, one skilled in the art will recognize that the methods and systems for performing social discovery discussed herein are applicable to other architectures and topologies other than the Internet. One skilled in the art will also recognize that the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A computer-implemented method for facilitating social discovery by a community comprising multiple users, the method comprising:
generating a representation of each of the multiple users of the community,
generating multiple items of social knowledge by, for each item,
receiving an indication of a collection of data that one user of the multiple users of the community has indicated as belonging together;
creating a dot representation by associating the representation of the one user with the indicated collection of data, such that the dot representation encodes information regarding a relationship between the user and the data; and
enhancing the dot representation by determining additional data belonging to the indicated collection of data;
identifying social aspects of each of the multiple users, the social aspects of each user including an indication of zero or more other of the multiple users that are related to the user; and
for each of at least some of the multiple users of the community,
receiving from the user a request for items of social knowledge;
determining one or more dot representations that satisfy the request, the determining based at least in part on the request and the social aspects of the user; and
forwarding an indication of the determined dot representations.

2. The method of claim 1 wherein, for each of the multiple items of social knowledge, the generating the item of social knowledge includes providing one or more user interface components based at least in part on a portion of the indicated collection of data.

3. The method of claim 1 wherein, for at least one of the at least some users of the community, the received request includes search criteria and the determining the one or more dot representations that satisfy the request includes determining one or more dot representations that match the search criteria.

4. The method of claim 1 wherein, for at least one of the multiple items of social knowledge, the indicated collection of data includes at least one of a reference to a web page, one or more tags, a subject, a quote, a category, a rating, or a comment.

5. A computer-implemented method for facilitating social discovery data by a community comprising multiple users, the method comprising:
generating multiple items of social knowledge, each item associating a representation of at least one user with a collection of data;
identifying social aspects of each of the multiple users, the social aspects of each user including an indication of zero or more other of the multiple users that are related to the user; and
receiving a request to provide an item of social knowledge; and
providing an indication of at least one of the multiple items of social knowledge, based at least in part on the received request and the social aspects of at least one of the multiple users.

6. The method of claim 5 wherein at least one of the multiple items of social knowledge is represented by a dot data structure.

7. The method of claim 5 wherein, for at least one of the multiple items of social knowledge, the associated collection of data has a relevance to the associated user, based at least in part on a relationship between the associated user and the community.

8. The method of claim 5 wherein, for at least one of the multiple items of social knowledge, the associated collection of data includes at least one of text, graphical, video, or audio data.

9. The method of claim 5 wherein, for at least one of the multiple items of social knowledge, the associated collection of data includes a reference to at least one of a web page, a blog, a news article, a movie, a movie review, a song, a book, a book review, or an event description.

10. The method of claim 5 wherein, for at least one of the multiple items of social knowledge, the associated collection of data includes at least one of a rating, a keyword, a tag, a user identifier, an access permission, a subject, a quote, an image, or an advertisement.

11. The method of claim 5 wherein the generating multiple items of social knowledge further comprises:
enhancing at least one item of social knowledge by automatically determining a portion of the associated collection of data.

12. The method of claim 11 wherein the enhancing of the at least one item of social knowledge includes augmenting the at least one item of social knowledge with at least one of one or more keywords, a subject, a quote, a category, or an image.

13. The method of claim 11 wherein the enhancing of the at least one item of social knowledge is automatically performed in response to a single input event generated by the associated user, the single input event indicating a data item of interest to the associated user.

14. The method of claim 11 wherein the automatically determined portion of the associated collection of data includes information to allow the associated user to author the item of social knowledge with a single input device selection command.

15. The method of claim 11 wherein the enhancing of the at least one item of social knowledge is based at least in part on at least one of information about the associated user, a category of the associated collection of data, or a taxonomy that includes the associated collection of data.

16. The method of claim 5, further comprising:
for at least one of the multiple items of social knowledge, providing a customized user interface component based at least in part on the associated collection of data.

17. The method of claim 5, further comprising:
modifying at least one item of social knowledge in response to a request from a user distinct from the associated user.

18. The method of claim 17 wherein the modifying the at least one item of social knowledge includes enforcing access permissions associated with the item of social knowledge.

19. The method of claim 5 wherein the request to provide the item of social knowledge is generated automatically based on one or more items of social knowledge being accessed by a user.

20. The method of claim 5 wherein the request to provide the item of social knowledge is generated automatically based on context information associated with a user, the context information including at least one of a web page being visited by the user, a geographic location of the user, a computing device being operated by the user, an activity being undertaken by the user, or a history of actions performed by the user.

21. The method of claim 5 wherein the request to provide the item of social knowledge is part of a search request, a collaborative work, a dialogue, a conversation, or a retrieval request.

22. The method of claim 5 wherein the providing the indication of the at least one of the multiple items of social knowledge includes at least one of providing a web page, sending an electronic mail message, or sending a short message service message.

23. The method of claim 5 wherein the providing the indication of the at least one of the multiple items of social knowledge includes formatting representations of the at least one of the multiple items of social knowledge based at least in part on characteristics of a display device operated by one of the multiple users.

24. The method of claim 5, further comprising:
providing a mechanism configured to automatically retrieve one or more items of social knowledge associated with at least one of the multiple users and to present the results of the automatic retrieval, such that a programmer can embed the mechanism in a web page to perform automatic retrieval and display of items of social knowledge on the web page.

25. The method of claim 5 wherein the identifying the social aspects of the multiple users includes automatically learning at least one of the identified social aspects of the multiple users based on at least one of a support vector machine, a hidden Markov model, a neural network, or a Bayesian network.

26. The method of claim 5 wherein the generating of at least one of the multiple items of social knowledge further comprises:
automatically importing a collection of data based on configuration information regarding a location and format of the collection of data; and
associating the imported collection of data with a representation of at least one user associated with the at least one item of social knowledge.

27. The method of claim 5 wherein the identifying the social aspects of each of the multiple users includes establishing a relationship between the user and one other of the multiple users by associating the user with the one other user.

28. The method of claim 5 wherein the identifying the social aspects of each of the multiple users includes receiving an indication of a group of one or more users and granting the indicated group access to at least one of the multiple items of social knowledge.

29. A computer-readable medium whose contents enable a computing device to facilitate social discovery within a community comprising multiple users, by performing a method comprising:
generating multiple items of social knowledge, each social knowledge item associating a representation of at least one user with at least one data item;
determining social aspects of each of the multiple users of the community, the social aspects of each user including an indication of zero or more other of the multiple users of the community that are related to the user; and
providing an indication of at least one of the multiple items of social knowledge, based at least in part on the social aspects of at least one of the multiple users of the community.

30. The computer-readable medium of claim 29 wherein the providing the indication of the at least one of the multiple items of social knowledge includes determining the at least some of the multiple items of social knowledge based on a request received from one of the multiple users.

31. The computer-readable medium of claim 30 wherein the received request is a search request that includes search criteria, and wherein the at least one of the multiple items of social knowledge match the search criteria.

32. The computer-readable medium of claim 29 wherein the providing the indication of the at least one of the multiple items of social knowledge is performed automatically based on a social knowledge subscription that specifies a category and/or at least one of the multiple users.

33. The computer-readable medium of claim 29 wherein the providing the indication of the at least one of the multiple items of social knowledge includes enforcing access permissions based on whether the at least one of the multiple users of the community is permitted to view the at least some items of social knowledge.

34. The computer-readable medium of claim 29 wherein the computer-readable medium is a memory of a computing device.

35. The computer-readable medium of claim 29 wherein the contents are instructions that when executed cause the computing device to perform the method.

36. The computer-readable medium of claim 29 wherein the contents include one or more data structures for use in facilitating social discovery, the data structure comprising multiple entries, each entry corresponding to one of the multiple items of social knowledge and containing information comprising an identifier of the associated at least one user of the one item of social knowledge and the associated at least one data item of the one item of social knowledge.

37. A social discovery server configured to facilitate social discovery by a community comprising multiple users, the server comprising:
a dot engine configured to generate multiple items of social knowledge, each item associating a representation of at least one user with at least one data item;
a user engine configured to identify social aspects of each of the multiple users, the social aspects of each user including an indication of zero or more other of the multiple users that are related to the user; and
a display engine configured to receive a request to provide social knowledge and to provide an indication of at least one of the multiple items of social knowledge, based at least in part on the received request and the social aspects of at least one of the multiple users.

38. The server of claim 37, further comprising:
one or more enhancement engines each configured to automatically determine one or more additional data items to associate with each of at least one of the multiple items of social knowledge based at least in part on the associated user of each of the items of social knowledge and/or the associated at least one data item of each of the items of social knowledge.

39. The server of claim 38 wherein at least one of the one or more enhancement engines is a synchronous enhancement engine configured to provide an indication of the automatically determined one or more additional data items to a user interface component being operated by one of the multiple users.

40. The server of claim 38 wherein at least one of the one or more enhancement engines is an asynchronous enhancement engine.

41. The server of claim 37 wherein the dot engine is further configured to provide one or more user interface components configured to obtain the associated at least one data item of each of at least some of the multiple items of social knowledge.

42. The server of claim 41 wherein the dot engine is further configured to provide at least one of the one or more user interface components based at least in part on the associated at least one data item of each of one or more of the at least some items of social knowledge.
